(19) United States
(12) Patent Application Publication
(10) Pub. No.: US 2026/0079957 A1
(43) Pub. Date: Mar. 19, 2026

(54) UNIFIED DATA MANAGEMENT AND ANALYTICS IN CLOUD-BASED DATA LAKE ENVIRONMENTS

(71) Applicant: SAP SE, Walldorf (DE)

(72) Inventors: Johannes Alberti, Walnut Creek, CA (US); Arthur De Bortoli, Sao Leopoldo (BR); Roberto Raquze Flores, Dois Irmaos (BR); Nagavijay Gamidi, Bangalore (IN); Rudolf Hennecke, Heidelberg (DE); Felipe Einsfeld Kersting, Rio Grande do Sul (BR); Gabriel Alexandro Pohlod Maciel, Curitiba (BR); Florian Maier, Heidelberg (DE); Klaus Nagel, Heidelberg (DE); Silvio Normey Gomez, Blumenau (BR); Sailesh Radhakrishnan, Bangalore (IN); Jens Rannacher, Heidelberg (DE); Rubens Luiz Rech, JR., Rio Grande do Sul (BR); Peter Schoenau, Untergruppenbach (DE); Michael te Uhle, Wiesloch (DE); Dylan Vollrath, Atlanta, GA (US); Daniel Ritter, Heidelberg (DE); Mihnea Andrei, Issy Les Moulineaux (FR); Amit Pathak, Pune (IN); Bjoern Friedmann, Rheinmuenster (DE)

(21) Appl. No.: 19/330,441

(22) Filed: Sep. 16, 2025

Related U.S. Application Data
(60) Provisional application No. 63/695,774, filed on Sep. 17, 2024.
(60) Provisional application No. 63/727,154, filed on Dec. 2, 2024.

(51) Int. Cl. G06F 16/25; G06F 16/22; G06F 16/2452; G06F 16/2455; G06F 16/955; H04L 9/32

(52) U.S. Cl. CPC G06F 16/254; G06F 16/2282; G06F 16/24526; G06F 16/24556; G06F 16/9566; H04L 9/3263

(57) ABSTRACT

A cloud-based data platform is disclosed, enabling storage-agnostic data management and analytics in a unified environment. The system may integrate a data lake implemented as a hyperscaler object store, a cloud-based database management system (DBMS), elastic compute resources, and analytics engines. Data may be stored in open table formats, such as Apache Parquet, Delta Lake, and Apache Iceberg, supporting ACID transactions, schema evolution, and efficient query processing. Virtual tables may map data stored in the data lake to the DBMS, enabling in-situ query processing via SQL interfaces. The platform may support advanced features, including change data capture (CDC), time travel, and lifecycle management using a SAGA pattern for atomic operations. Security may be ensured through X.509 certificates, web tokens, and role-based access controls. Elastic compute resources, such as Apache Spark, facilitate large-scale data transformations and analytics.

### CROSS-REFERENCE TO RELATED APPLICATIONS

This application claims priority to U.S. Provisional Application No. 63/695,774, filed Sep. 17, 2024, entitled “DATA PLATFORM,” and U.S. Provisional Application No. 63/727,154, filed Dec. 2, 2024, entitled “EMBEDDED DATA LAKE CAPABILITIES,” both hereby incorporated herein by reference in its entirety.

This application is also related to the following U.S. patent applications: U.S. patent application Ser. No. 19/250,722, entitled “Resharing Of Database Object Collection Shares,” filed Jun. 26, 2025; U.S. patent application Ser. No. 19/225,861, entitled “Managing Privileges For Open Format Tables”, filed Jun. 2, 2025; U.S. patent application Ser. No. 18/945,001, entitled “Direct Access Of Data Lake Files”, filed Nov. 12, 2024; U.S. patent application Ser. No. 18/944,845, entitled “Web Tokens For Authentication Of Data Lake Files”, Nov. 12, 2024; U.S. patent application Ser. No. 18/944,743, entitled “Metadata On Delta Sharing Tables”, Nov. 12, 2024; U.S. patent application Ser. No. 19/302,299 entitled “Data Ingestion In Cloud-Based Data Warehousing Environment”, filed Aug. 18, 2025; U.S. patent application Ser. No. 19/302,271 entitled “Storage-Agnostic Semantic Artifact In Cloud-Based Data Warehousing Environment”, filed Aug. 18, 2025; and U.S. patent application Ser. No. 19/302,308 entitled “Data Transformation In Cloud-Based Data Warehousing Environment.”, filed Aug. 18, 2025. Each of these applications is hereby incorporated by reference in its entirety for all purposes.

### TECHNICAL FIELD

The subject matter described herein relates generally to optimizing database operation and execution in a data lake environment.

### BACKGROUND

A data warehousing environment is a specialized system designed to store, manage, and analyze large volumes of structured and, in some cases, semi-structured data. It serves as a central repository where data from various sources is consolidated, transformed, and made available for querying and reporting. Data warehousing environments are often used for supporting business intelligence (BI), analytics, and decision-making processes within organizations. A data lake is a repository designed to store large amounts of data in its native format. A lake house environment is an architecture that combines a data warehouse and a data lake.

A database may be configured to store a plurality of electronic data records. These data records may be organized, in accordance with a database schema, into various database objects including, for example, one or more database tables. The database is coupled with a database management system (DBMS), which may be configured to support a variety of database operations for accessing the data records stored in the database. These database operations may include, for example, structured query language (SQL) queries and/or the like.

### BRIEF DESCRIPTION OF THE DRAWINGS

FIG. 1 depicts an example of a cloud-based data lake house system including a cloud-based data lake providing a cloud-based object store, in accordance with some embodiments.

FIG. 2 depicts another example of a data lake house system implementation, in accordance with some embodiments.

FIGS. 3A and 3B are block diagrams of yet another example of a data lake house system, in accordance with an example embodiment.

FIG. 4 shows the cloud-based database management system's integration with an analytics engine, such as Spark.

FIG. 5 depicts an example of the Spark controller of the DBMS coupling to the Spark Gateway, which provides the ability to support multi-tenancy.

FIG. 6 illustrates an example of a Delta table lifecycle, with Data Definition Languages (DDLs) or queries coming from clients, in accordance with an example embodiment.

FIG. 7 depicts an example of how data may be replicated from a source system to a data warehouse-owned data lake file system (DLFS) instance, in accordance with an example embodiment.

FIG. 8 illustrates a system including SQL-on-Files (SoF) functionality, in accordance with an example embodiment.

FIG. 9 illustrates an example of an optimizer and associated query planning and execution components for SQL-on-Files (SoF) processing in a cloud-based data platform, in accordance with an example embodiment.

FIG. 10 illustrates an example SoF (SQL-on-Files) execution architecture, in accordance with an example embodiment.

FIG. 11 illustrates the relationships among monitoring and statistics views for SQL-on-Files (SoF) operations in a cloud-based data platform, in accordance with an example embodiment.

FIG. 12 is a screen capture illustrating an example user interface for a transformation flow editor, in accordance with an example embodiment.

FIG. 13 depicts an example of a system comprising a data warehousing environment, in accordance with an example embodiment.

FIG. 14 is a block diagram illustrating a system for Hana Data Lake (HDL) file management, in accordance with an example embodiment.

FIG. 15 illustrates a similar system architecture, but with a different usage pattern, in accordance with an example embodiment.

FIG. 16 is a flow diagram illustrating a method for authenticating a user of a data lake, in accordance with an example embodiment.

FIG. 17 is a block diagram depicting a system for HDL file management with enhanced metadata capabilities, in accordance with an example embodiment.

FIG. 18 is a sequence diagram illustrating the binding of Core Schema Notation (CSN) models to Delta share tables, in accordance with an example embodiment.

FIG. 19 is a flow diagram illustrating a method for attaching metadata to a Delta table, in accordance with an example embodiment.

FIG. 20 is a block diagram illustrating a system for HDL file management, in accordance with an example embodiment.

FIG. 21 is a flow diagram illustrating a method for granting access to a file on a data lake, in accordance with an example embodiment.

FIG. 22 is a block diagram illustrating a system for file management and data sharing, in accordance with an example embodiment.

FIG. 23 is a sequence diagram for sharing a share in computer systems, in accordance with an example embodiment.

FIG. 24 is a flow diagram illustrating a method for sharing a share in computer systems, in accordance with an example embodiment.

FIG. 25 is a block diagram illustrating a system for coordinating transactions and privileges across relational databases and open format tables on object storage, in accordance with an example embodiment.

FIG. 26 is a flow diagram illustrating a method of coordinating transactions across databases and open format tables, in accordance with an example embodiment.

FIG. 27 is a block diagram illustrating a unified system for cloud-based data warehousing, data ingestion, and data transformation, in accordance with several example embodiments.

FIG. 28 illustrates a method for ingesting data in a cloud-based data warehousing environment, in accordance with an example embodiment.

FIG. 29 is a flow diagram illustrating a method for storing data, in accordance with an example embodiment.

FIG. 30 is a flow diagram illustrating a method for applying one or more transformations to data, in accordance with an example embodiment.

FIG. 31 is a flow diagram illustrating a method for accessing data stored in a data lake implemented as a hyperscaler object store, in accordance with an example embodiment.

FIG. 32 shows a block diagram showing one example of a software architecture for a computing device.

FIG. 33 shows a block diagram of a machine in the example form of a computer data lake house system within which instructions may be executed for causing the machine to perform any one or more of the methodologies discussed herein.

### DETAILED DESCRIPTION

The present disclosure relates to systems and methods for providing a storage-agnostic, cloud-based data warehousing and analytics environment that unifies the capabilities of data lakes and data warehouses-commonly referred to as a “lake house” architecture. Example embodiments enable organizations to efficiently store, manage, transform, and analyze large volumes of structured, semi-structured, and unstructured data using open table formats (such as Apache Parquet, Delta Lake, and Apache Iceberg) on scalable cloud object storage, while supporting advanced data management, transactional integrity, and analytics features typically associated with enterprise data warehouses.

The present disclosure describes systems and methods for providing a unified, extensible, and highly scalable data platform that integrates embedded data lake capabilities with advanced data warehousing, analytics, and lifecycle management features. Example embodiments allow organizations to efficiently ingest, store, manage, transform, and analyze large volumes of structured, semi-structured, and unstructured data in a cloud-based environment, leveraging open table formats, elastic compute, and robust metadata and security controls.

The Business Data Cloud (BDC) is a unified, cloud-based platform designed to deliver a comprehensive Software-as-a-Service (SaaS) experience for enterprise data management and analytics. BDC integrates data from SAP business applications as well as non-SAP sources, enabling organizations to efficiently ingest, store, manage, transform, and analyze large volumes of structured, semi-structured, and unstructured data. The platform is architected to harmonize and extend the capabilities of existing solutions, such as Datasphere, SAP Analytics Cloud (SAC), and HANA Cloud, while introducing new mechanisms for data integration, governance, and consumption.

The BDC architecture separates internal foundation services from customer-facing runtime components. The BDC Foundation Services are responsible for the creation, provisioning, and maintenance of curated datasets known as Data Products. These services leverage managed object storage, compute, and database resources, including HANA Data Lake Files (HDLF) for object storage, a managed Spark service for scalable compute, and HANA Cloud for database management. The Foundation Services automate the lifecycle management of Data Products, ensuring consistency, versioning, and compliance with organizational policies.

The customer-facing aspect of BDC provides user-facing analytics, modeling, and data integration capabilities. This runtime environment includes tools such as the BDC Cockpit, SAP Datasphere, and SAP Analytics Cloud, which together deliver business insights and support customer-specific extensions. Within this environment, Data Products serve as the foundation for analytics and reporting. Data Products are curated datasets with governed access, representing either primary business object data or derived analytical views. They are described using standardized metadata and are provisioned in open table formats to ensure compatibility and interoperability across the platform. Data Products can be grouped into Data Packages, which are logical collections that streamline activation, management, and consumption, and can be activated independently or as part of broader analytical solutions.

BDC also supports the deployment and consumption of Insight Applications, or Insight Apps, which are SaaS components that deliver analytical, predictive, planning, or action-oriented insights to business users. These applications are designed to work out-of-the-box with minimal configuration, while also supporting extensibility for customer-specific requirements. Insight Apps consume underlying Data Products and may be implemented using low-code or pro-code approaches, depending on the complexity and scope of the business need.

Another element of BDC's architecture is a directory for managing Data Products and establishing trust relationships among SAP business application tenants. The directory enables secure onboarding, discovery, and consumption of Data Products, supporting robust authentication and authorization mechanisms. The platform employs a multi-layered tenancy model that distinguishes between design-time and runtime environments. Design-time tenants are used for modeling and metadata management, while runtime tenants correspond to customer-specific deployments and data product instantiation. Artefact versioning is managed using semantic versioning principles, with changes tracked at the package level to ensure compatibility and operational integrity.

BDC further differentiates between design-time and runtime operations. Design-time operations encompass modeling, metadata definition, and deployment planning, while runtime operations involve execution, provisioning, and maintenance of Data Products, analytical content, and system artifacts. This separation enables efficient lifecycle management, collaborative development, and automated deployment of data integration and analytics solutions. Analytical content, including cubes, dashboards, and models, is created and managed using integrated design-time tooling and continuous integration/continuous delivery (CI/CD) pipelines, ensuring consistency, reusability, and rapid delivery of business insights.

The platform is designed for extensibility and integration with external data engineering and data science platforms to provide advanced analytics and machine learning capabilities. Data Products can be shared with external workspaces via open protocols, enabling seamless access to SAP data for data engineers and scientists. Security and governance are addressed through robust authentication and authorization, including X.509 certificates, web tokens, and role-based access controls, as well as secure data sharing protocols that do not require data movement or duplication. Lifecycle management employs a SAGA pattern to coordinate operations and ensure atomicity and consistency across distributed resources.

Operationally, BDC enables organizations to ingest data from diverse sources, store it in a unified data lake using open formats, manage and transform the data using elastic compute and advanced metadata services, and provide secure, policy-driven access for analytics, business intelligence, and machine learning. The platform harmonizes the strengths of data lakes and data warehouses, providing a comprehensive solution for modern enterprise data management and analytics, while ensuring data governance, security, and performance. By integrating advanced data governance, lifecycle management, and extensibility features, BDC enables organizations to unlock the full potential of their data, driving innovation, agility, and competitive advantage.

In one example embodiment, the system comprises a cloud-based data platform that includes a data lake implemented as a hyperscaler object store, a cloud-based database management system (DBMS), elastic compute resources, and integrated analytics engines. The data lake is configured to store data in a storage-agnostic manner, supporting a variety of formats including open table formats such as Apache Parquet, Delta Lake, and Apache Iceberg. The platform is designed to support both in-memory and disk-based storage, as well as object-based storage, allowing data to be managed and accessed regardless of the underlying storage technology.

The platform provides a unified interface for data ingestion, transformation, and analytics. Data may be ingested from a variety of source systems, including structured and unstructured data sources, using replication management services (RMS), ETL tools, or direct API integration. The system supports change data capture (CDC), schema enforcement and evolution, and time travel to historical table versions, enabling robust data governance and auditability. Ingested data is stored in the data lake in its native or transformed format and may be further curated or optimized using transformation flows and compaction operations.

One feature of the platform is its support for open table formats, which provide a metadata layer for data access and management. These formats enable Atomicity, Consistency, Isolation, and Durability (ACID)-compliant transactions, schema evolution, and efficient query processing. The metadata layer tracks which files are part of different table versions, and supports features such as streaming input/output, time travel, and data validation. The use of open formats ensures compatibility with a wide range of analytics and machine learning tools, and facilitates interoperability across cloud providers.

The DBMS component of the platform provides advanced data management and query capabilities. It supports the creation of virtual tables that map to data stored in the data lake, enabling seamless access to remote data using standard SQL interfaces. The DBMS includes an execution engine and optimizer that are extended to support SQL-on-Files (SoF) functionality, allowing direct, in-situ query processing over data stored in files. The optimizer is capable of enumerating physical operators for remote file scan operations, and can push down filters, projections, and aggregations to a file adapter for efficient execution. The file adapter reads column chunks from Parquet or other open format files, applies the requested operations, and returns results as internal tables (ITABs) for further processing by the execution engine.

The platform also integrates elastic compute resources, such as Apache Spark, for large-scale data transformation and analytics. The DBMS may include a Spark adapter and controller, enabling the federation of SQL queries to Spark and the execution of virtual procedures for data transformation, machine learning, and advanced analytics. The system supports the orchestration of Spark jobs, including DDL operations on Delta tables, and provides runtime operations for monitoring and managing Delta table storage, such as optimize and vacuum commands.

In another example embodiment, the concept of Data Products may be utilized, which are curated datasets with governed access, representing either primary business object data or derived analytical views. Data Products are described using standardized metadata and are provisioned within the platform as datasets in open table formats. Data Packages are logical groupings of Data Products, enabling streamlined activation and management. Data Products may be activated independently or as part of Data Packages, and their lifecycle is managed to ensure consistency, versioning, and compliance with organizational policies.

Lifecycle management is another aspect of the present disclosure. The platform supports the creation, modification, deletion, optimization, and recovery of data tables and other artifacts, with atomicity and consistency guarantees across distributed storage and compute domains. The system employs a variant of the SAGA pattern to coordinate lifecycle operations, using a remote-controller component in the DBMS to maintain the state of remote operations and orchestrate compensating actions in the event of rollbacks. The metadata store is updated to reflect the status of operations, and manual compensation may be performed if automatic compensation fails.

Security and multi-tenancy are addressed through robust authentication and authorization mechanisms. The platform supports X.509 certificate-based access control, role-based privileges, and policy-driven authorization for both internal and external users. Secure data sharing is enabled through protocols such as Delta Sharing, allowing access to specific datasets in the data lake without requiring data movement or duplication. The system supports the creation of recipient tokens, audience restrictions, and fine-grained entitlements, ensuring that data access is auditable and compliant with organizational policies.

Monitoring and observability are provided through integrated views and logs that track data operations, system status, and usage. The platform includes monitoring views for tracking the status of data ingestion, transformation, query execution, and lifecycle events. Operational management and troubleshooting are supported through detailed logs, execution statistics, and system health dashboards. The architecture is designed for extensibility and integration with multiple cloud providers, compute engines, and data formats. The system supports the provisioning of new storage and compute resources, the integration of external analytics engines, and the deployment of custom data processing pipelines. The platform's modular design allows organizations to tailor deployments to their specific needs, and to scale resources independently for storage and compute.

The present disclosure further contemplates the use of virtual tables and remote sources to provide transparent access to data stored in the object store, supporting both analytical and transactional workloads. The integration of Spark and other analytics engines provides scalable compute for data transformation, machine learning, and advanced analytics. The metadata management, security, and multi-tenancy features ensure robust governance, access control, and operational isolation for enterprise environments.

The platform supports the deployment and consumption of Insight Applications (“Insight Apps”), which are SaaS components delivering analytical, predictive, planning, or action-oriented insights to business users. Insight Apps may be classified by value (base or premium), functionality (analytical, predictive, planning, action), scope (product, domain, process), and implementation nature (low-code or pro-code). These applications consume underlying Data Products and may be extended or customized by customers to address specific business requirements.

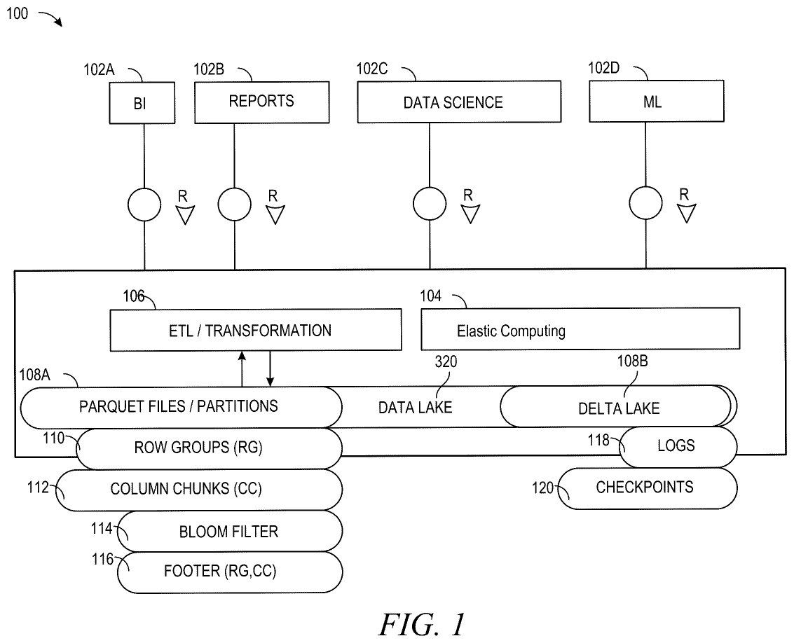

FIG. 1 depicts an example of a cloud-based data lake house system 100 including a cloud-based data lake 320 providing a cloud-based object store, in accordance with some embodiments. In the example of FIG. 1, there is provided applications or tools, such as a business intelligence (BI) 102A, report generation 102B, data science 102C, machine learning (ML) 102D, and/or other types of applications and/or tools to access the data stored in the data lake 320. In some embodiments, the cloud-based data lakehouse system 100 of FIG. 1 may be configured to include optimized access to, for example the data science 102C and machine learning 102D tools.

Moreover, there may be provided elastic computing 104 (e.g., elastic compute node(s)) to provide for example a structured query language (SQL) interface for data of the data lake 320. In addition, ETL tools 106 may be provided to extract, transform, and load (ETL) data from a data source and/or transform data into a given format for storing and/or use. The data lakehouse system 100 may provide one or more data lakes, such as a data lake 320, with data management, single table analysis, query atomicity, consistency, isolation, and durability (ACID) transactions (which is typically expected of a data warehouse) to enable analytical queries (e.g., BI) as well as ML on the stored data. With the data lake house, it can be configured with an open system configuration such that the data structures and data management are compatible (or similar) to those in, for example, a data warehouse.

In some embodiments, the cloud-based data lakehouse system 100 may be configured to consume or use data stored in column-oriented data files (e.g., using Apache Parquet 108A, which is an open source, column-oriented data file format, although other types of file formats, including row-oriented, may be used). With respect to row groups (RGs) 110, a table may be horizontally partitioned into, for example, a row group, while the tuples are stored by column inside a row group, with attributes forming a column chunk (CC) 112. A bloom filter 114 may be used to filter data to reduce resource usage during query execution. For example, a bloom filter may be used in certain database query operations, such as joins, to reduce the resources (e.g., memory, processing, etc.) associated with the join operation. To illustrate further, the entry point of each Parquet file is called a footer 116, which has a metadata-like table schema and tuple count (on the file level), but also metadata of each row group (including, for example, file offsets, bloom filters, etc.). A bloom filter is a probabilistic data structure, which helps to find out whether an element is a member of a set. Bloom filters are supported per column chunk. Moreover, the column-oriented data files may include table access semantics including metadata based on open table formats (e.g., providing file-based transaction logs 118 for ACID transactions and checkpoints 120, metadata handling, and the like, examples of which include Delta lake 108B (or Delta, for short), Apache Iceberg, and/or the like) that provide metadata layers to enable data access. The Delta may be in accordance with, for example, open source LINUX foundation (see, e.g., Delta Lake 4.0 (as well as other versions) at https://docs.Delta.io/latest/index.html).

The architecture of the data lake house system 100 is designed for extensibility and integration with multiple cloud providers, compute engines, and data formats. The system supports the provisioning of new storage and compute resources, the integration of external analytics engines, and the deployment of custom data processing pipelines. The platform's modular design allows organizations to tailor deployments to their specific needs, and to scale resources independently for storage and compute.

Operationally, the data lake house system 100 enables organizations to ingest data from diverse sources, store it in a unified data lake using open formats, manage and transform the data using elastic compute and advanced metadata services, and provide secure, policy-driven access for analytics, business intelligence, and machine learning. The platform harmonizes the strengths of data lakes and data warehouses, providing a comprehensive solution for modern enterprise data management and analytics, while ensuring data governance, security, and performance.

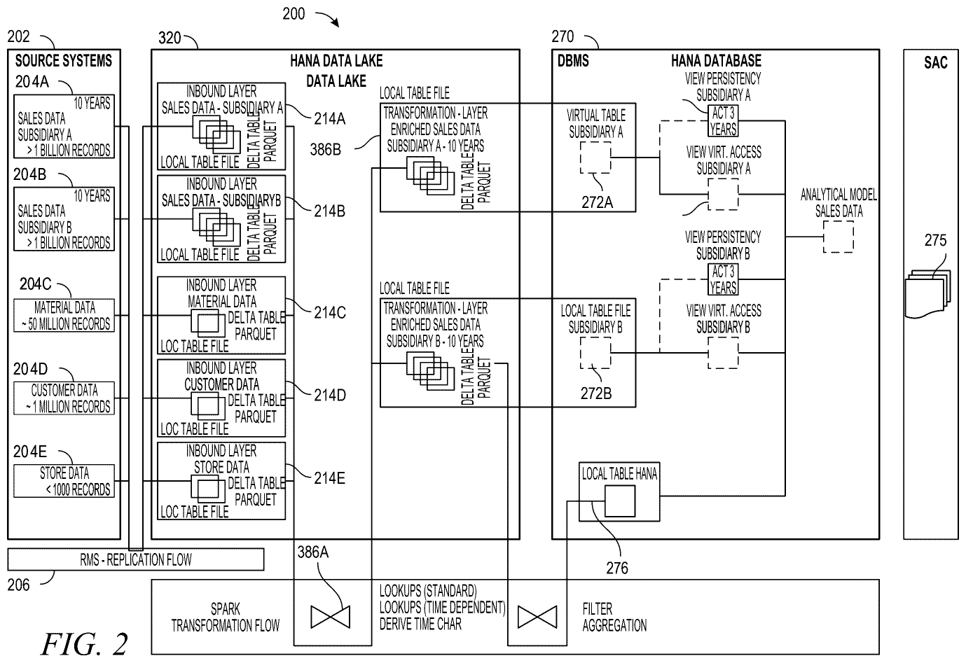

FIG. 2 depicts another example of a data lake house system 200 implementation, in accordance with some embodiments. The data lake house system 200 may include one or more source systems 202, which may include one or more data stores 204A-E, which may include structured data (e.g., in database tables) as well as unstructured or data in a native format (e.g., web pages, emails, etc). In the example of FIG. 2, a replication management system (RMS) 206 may be used to replicates some if not all of the data from the source systems 202 into the data lake 320, which provides the cloud object storage.

The data lake house system 200 further includes a database management system (DBMS) 270 (e.g., a cloud-based columnar storage and/or in-memory database, such as SAP's HANA or other type of database). To perform analytics via analytic clients 275, an analytic client may access or query the DBMS 270. Data stored in the data lake 320 may be represented in the DBMS 270 via virtual tables 272A-B. For example, the virtual table 272A is locally stored at the DBMS 270 but includes metadata (e.g., table semantics, description, metadata, etc.) describing the data, such as table 386B, stored at the object store of the data lake 320. In other words, the virtual table 272A is mapped to the table 386B, and from the perspective of the DBMS 270, the external data at table 386B appears to be internal to the DBMS 270. The DBMS may also generate views including a view (using the virtual table 272A) for the external data at table 386B.

In the example of FIG. 2, data is primarily stored in the data lake 320 through a self-managed multi-cloud access layer and moved regularly from the source systems 202 into the inbound layer while capturing the changes und updating Delta tables at 214A, 214B, 214C, 214D, 214E. Moreover, scalable data transformation (e.g., provided by the transformation flow 386A) capabilities allow for regularly transforming/curating the data in the inbound layer into the transformation layer, which denotes data that can be queried by relational compute instances of the DBMS 270 using SQL. Regular compaction/optimization may also be used to improve the data to be queried.

Furthermore, analytical and transformation capabilities may enable (for SoF-enabled relational compute for data in the transformation layer) (1) creation of data marts through filtering and aggregating data and capturing the results in local tables, such as the local table 276, and (2) direct access to the data and query processing on the data in the transformation layer via remote table access from the compute instances.

As object storage latencies are about 3-digit milliseconds per access, the “physics” of current data lakes trade high performance for lower storage costs. Overall, it is accepted that the latencies differ between in-memory databases and the data lake data processing by several orders of magnitude. Consequently, caches (e.g., DSP's view persistency) may be used to improve performance (in some implementations). Further, open table formats like Apache Parquet 108A and Delta lake 108B (e.g., an open-source table format including metadata for tables) and transformations may be created within the relational compute system instance (which provides the DBMS 270) to provide the SQL on Files (SoF). The processing of data in files in the data lakes may be observed/monitored through monitoring capabilities and/or views. In addition, certain tools may be provided to enable configuring and monitoring overall system information (e.g., from the size of data in data lakes up to processing in the relational compute instances).

Analytical and transformation capabilities enable the creation of data marts through filtering and aggregating data, capturing results in local tables, and accessing data and query processing directly in the transformation layer via remote table access from compute instances. Object storage latencies are typically higher than in-memory databases, so caches (such as DSP's view persistency) may be used to improve performance. Open table formats and transformations may be created within the relational compute system to provide SQL-on-Files (SoF) functionality. Data processing in files in the data lakes may be monitored through system monitoring capabilities and views, and tools may be provided for configuring and monitoring system information, such as data size and processing status.

The system supports regular compaction and optimization of data in the transformation layer to improve query performance. Analytical and transformation capabilities enable the creation of data marts through filtering and aggregating data, capturing results in local tables, and providing direct access to data and query processing in the transformation layer via remote table access from compute instances. Object storage latencies are typically higher than in-memory databases, so caches (such as DSP's view persistency) may be used to improve performance.

Open table formats and transformations may be created within the relational compute system to provide SoF functionality. Data processing in files in the data lakes may be monitored through system monitoring capabilities and views, and tools may be provided for configuring and monitoring system information, such as data size and processing status.

This architecture enables organizations to ingest data from diverse sources, store it in a unified data lake using open formats, manage and transform the data using elastic compute and advanced metadata services, and provide secure, policy-driven access for analytics, business intelligence, and machine learning. The platform harmonizes the strengths of data lakes and data warehouses, providing a comprehensive solution for modern enterprise data management and analytics while ensuring data governance, security, and performance.

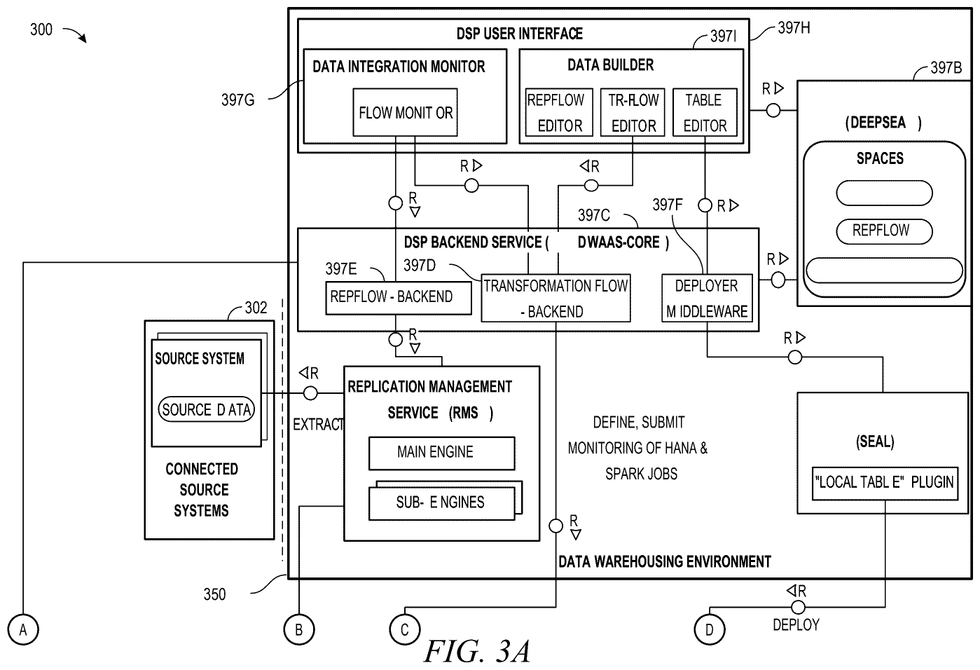

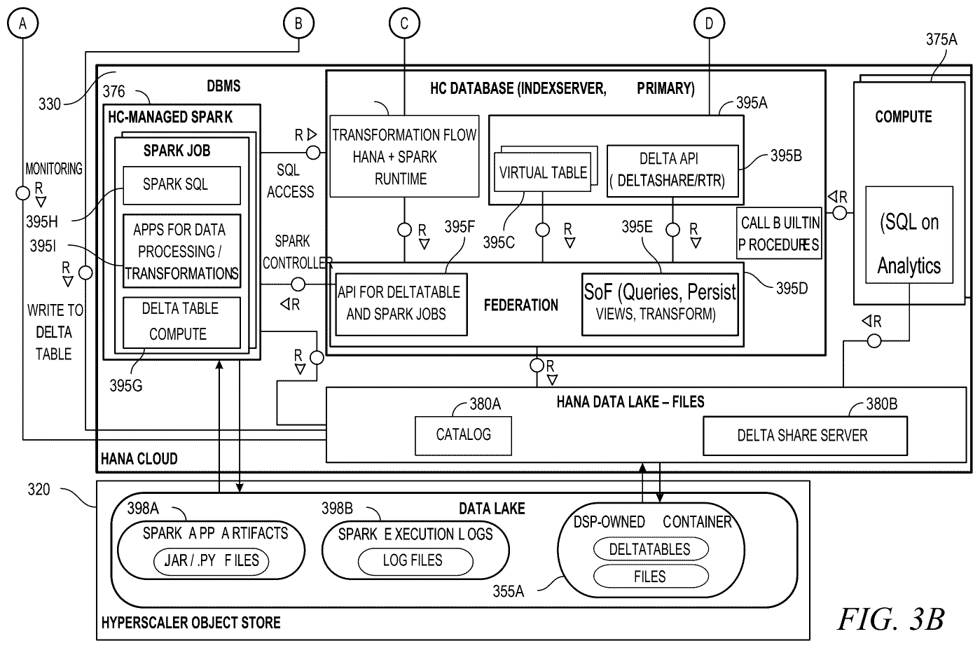

FIGS. 3A and 3B are block diagrams of yet another example of a data lake house system 300, in accordance with an example embodiment. The system 300 includes source systems 302, a DBMS 330, and a data warehousing environment 350. The DBMS 330 is coupled to the data lake 320, which is implemented as a hyperscaler object store. The data lake house system 300 supports a “large system” option in the data warehousing environment 350 by extending the stack to include the cloud DBMS 330, data lake 320, and compute 375A for transformations.

Data is stored in the data lake 320 as objects, such as files in a column-oriented format (e.g., Apache Parquet) at a container 355A. The data lake file service provides access to the stored files and includes a catalog 380A and a Delta Share Server 380B. Open-table formats (e.g., Delta Lake, Apache Iceberg) are used to add metadata on top of the data in open-table format files, and compute engines such as Apache Spark, Trino, or Google BigQuery may be used for processing.

The data lake house system 300 supports Delta Sharing, an open protocol for secure data sharing, allowing one party to share access to specific datasets stored in cloud storage without moving or duplicating the data. The Delta Share Server 380B manages access permissions and authentication. Delta shares allow for granting access permission to data consumers, and missing metadata (e.g., primary keys) may be stored in Delta shares using core data services schema notation (CSN). The metadata may also be required for remote table replication from the cloud object storage to the DBMS 330.

Compute for transformations and cloud-Spark integration is provided by Apache Spark or other analytics engines with SQL support, which may be used for large-scale data transformations and complement SoF for data preparation. The DBMS-managed Spark integrates via a Spark controller to trigger Spark jobs from the DBMS 330. The managed Spark may also be used for DDLs on Delta tables and provide runtime operations for monitoring and managing Delta table storage, such as compression (optimize) and vacuum operations.

To provide scalable data transformation capabilities for regularly transforming and/or curating data in the data lake 320 (which is created by, e.g., a computer system), the cloud-based database management system may be integrated with Spark as shown at 376 in FIG. 3B.

TABLE 1
lists some of the components of the system 300.

| Component | Description |
|---|---|
| DSP Local Tables (File) & SQL | Artifacts in cloud data base (e.g., |
| APIs 395A | HANA cloud database) managed by |
| | Data warehousing environment |
| Delta API 395B | Transformation flow in DSP, but |
| | adapted for transformations on the |
| | data lake. |
| Virtual Table 395C | HANA virtual tables |
| Federation 395D | HANA federation layer |
| SoF 395E | Novel SoF features in the HANA |
| | federation layer (including. e.g., |
| | analytical queries on the data lake) |
| API for Delta Table and Spark | Novel Delta table and Spark job API |
| Jobs 395F | in the HANA federation layer (e.g., |
| | executing transformations in Spark |
| | via Controller) |
| Delta Table Compute 395G | Compute on Delta tables running |
| | within a Spark job |
| Spark SQL 395H | Novel managed Spark with Spark |
| | SQL job execution |
| Apps for Data | Novel managed Spark with Spark |
| Processing/Transformations 395I | user-defined functions (e.g., PySpark, |
| | Scala, etc.) |
| Local Table Plug-in | DSP deployment service for artifacts |
| | in HANA adapted for virtual tables |
| | that are Delta tables |
| Repository Services 397B | DSP repository managing artifacts in |
| | HANA but also replication and |
| | transformation flows |
| Data warehouse (e.g., DSP) | Core DSP backend service for |
| backend service 397C | different middleware like replication, |
| | transformation, and artifact |
| | deployment |
| Transformation Flow Backend | DSP transformation flows (transform |
| 397D | data) |
| Replication Flow (RepFlow) 397E | DSP replication flows (data from one |
| | system to another) |
| Deployer middleware 397F | DSP HANA artifact deployer |
| | middleware using SEAL to deploy |
| | artifacts like virtual tables in HANA. |
| Data Integration Monitor 397G | DSP monitor for flow runtimes |
| Data Warehouse User Interfaces | User interfaces in DSP |
| (UIs) 397H | |
| Data Warehouse Data Builder 397I | Editors in DSP |
| Spark App Artifacts 398A | Novel Spark artifacts like java |
| | archives (JAR) or python (PY) files |
| | for virtual procedure execution |
| Spark Execution Logs 398B | Novel Spark execution logs for the |
| | DDL and virtual procedure execution. |

This architecture enables organizations to ingest data from diverse sources, store it in a unified data lake using open formats, manage and transform the data using elastic compute and advanced metadata services, and provide secure, policy-driven access for analytics, business intelligence, and machine learning. The platform harmonizes the strengths of data lakes and data warehouses, providing a comprehensive solution for modern enterprise data management and analytics while ensuring data governance, security, and performance.

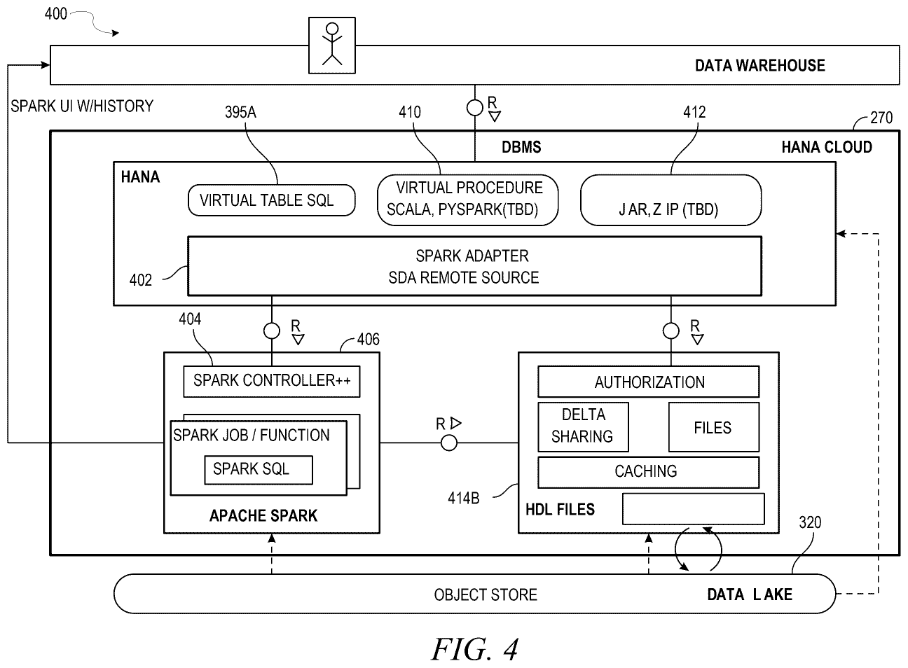

FIG. 4 shows the cloud-based database management system's integration with an analytics engine, such as Spark. The DBMS 270 includes a Spark adapter 402 that provides smart data access (SDA) (e.g., provides access to remote data as if the data were stored in local tables in the DBMS 270). Moreover, the DBMS 270 includes a Spark controller 404 on a Spark 406 and further includes a data exchange format. To leverage and modify the SDA Spark adapter 402 to connect to the Spark 406, the Spark controller 404 is used and allows for federation of SQL queries to the Spark 406, optimal data transport from the Spark 406 to HANA (and vice versa), and execution of HANA virtual procedures (including, e.g., dependencies and/or virtual packages). HDL files 414B is a component that abstracts the compute from specificities of different object storage vendor apps and provides access to the data through direct file access or Delta sharing protocol implementation. The HDL files 414B may include a storage adapter for the direct access and caching and authorization. Th HDL files 414B may be scaled and may return a pre-signed URL to the data so that any authorized compute could access the data in the object storage.

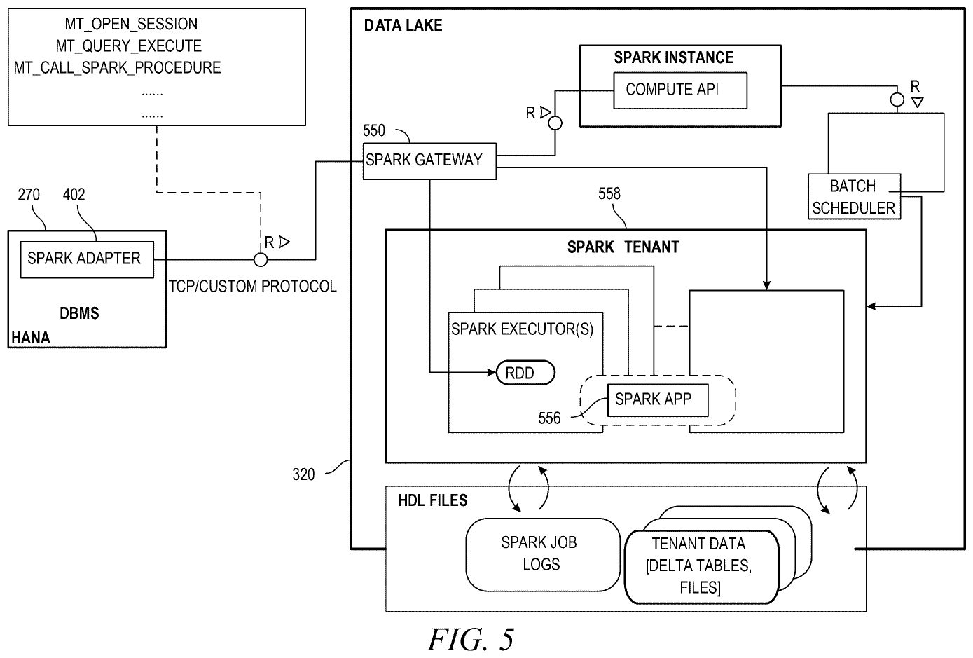

FIG. 5 depicts an example of the Spark controller 404 (see, e.g., FIG. 4) of the DBMS 270 coupling to the Spark gateway 550, which provides the ability to support multi-tenancy. In the example of FIG. 5, the cloud-based DBMS 270 (e.g., HANA) communicates with the Spark adapter 402 on the cloud-based database side and the Spark controller 404 on the Spark side dispatching tasks to Spark executors with data in RDD (resilient distributed data) and Spark instances with compute API. There is data access to HDL files for data (e.g., tenant data) but also for storing logs that are needed for the service itself. K8s (Kubernetes) integration is used to run in cloud environments. The Spark gateway includes the Spark adapter 402 and the Spark controller 404. The Spark gateway may be used to provide multi-tenancy. A Spark application 556 instance/one-runtime environment for Spark workloads/applications includes a tenant 558. From the cloud-based DBMS 270, the remote sources are created to connect to a tenant via the Spark adapter 402, such that Spark workloads on jobs can be scheduled. With respect to workload and/or execution context isolation for custom code, Spark may need to use multiple remote sources with the same Spark tenant 558. For example, different remote sources may go to different Spark applications. Even then, the two procedures may be within the same tenant and can communicate with each other. To achieve separation, multiple remote sources and Spark tenants may be required. When a single remote source is used for two procedures, both will run in the same Spark application.

Moreover, secure communication may be performed using secure and/or authenticated communications, such as using an X.509 infrastructure of, for example, digital certificates to authorize a user to a tenant. The certificates may be stored and managed by the DBMS 270 security environment. For example, one credential per remote source may be used to control access to virtual procedures and tables by granting privileges. For that, trusts, roles, and authorizations from data lake file system (e.g., a HDLFS) may be used in the Spark instances. The Spark instances may be configured by users/operators of, for example, the DBMS 270. Trusts-block may be used to configure which certificate authorities and intermediaries the Spark Instance should trust when reached by a HANA X509 identity. While a Spark gateway may accept any X509 identity within a TLS handshake, the trust of the identity may be validated for each Spark instance individually using the certificates provided in its specification. For Spark workloads to be able to read/write data from/to HDL files, the necessary authentication and authorization may be established in the HDL files.

Referring again to FIG. 4, virtual procedures 410 represent script that may be implemented using, for example, different languages such as Scala, PySpark, and/or the like. Any required dependencies may be deployed through virtual packages 412, which are compressed archives with Java archives and resource files. The data lake file system's catalog may be used to browse and manage artifacts like schemas and tables of a remote source. Execution logs can be downloaded by users of the DBMS 270 for debugging.

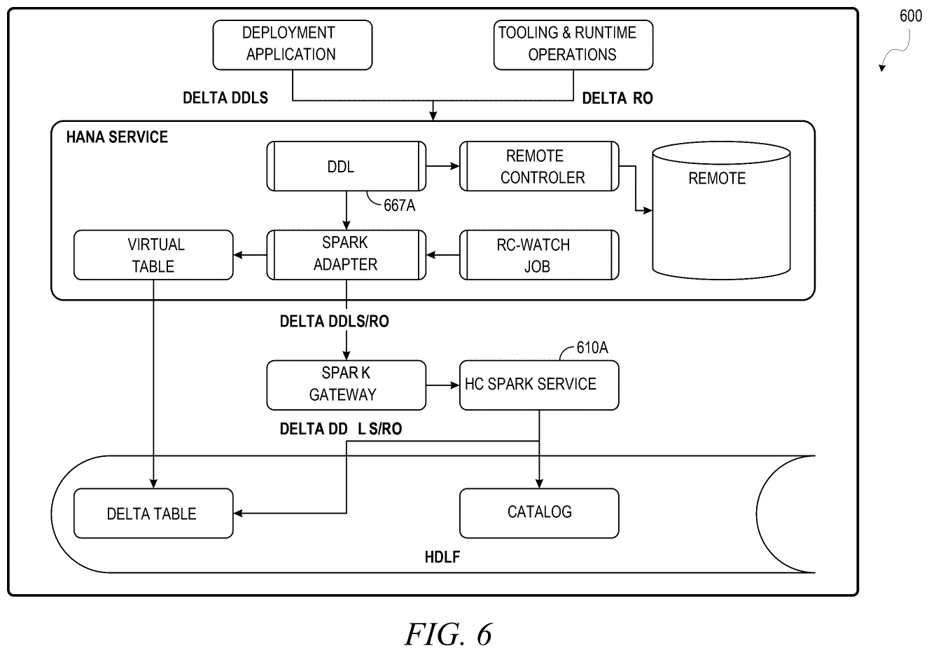

FIG. 6 illustrates an example of a Delta table lifecycle 600, with DDLs or queries coming from clients, in accordance with an example embodiment. With a Delta table supported by the DBMS 270 for querying data in the DBMS 330, interfaces may be provided to allow the management of the Delta tables lifecycle. Delta tables refer to a data table format which may be used to store objects in a data lake when the data is ingested using streaming or in batches (and, e.g., the Delta table may be used in a Delta Lake open source data framework). The lifecycle of a Delta table may correspond to defining business objects in terms of Delta tables, deploying them, modifying their schema, dropping them, performing storage re-organization, and so forth. FIG. 6 shows the components involved in supporting a Delta table lifecycle. These components include DDL interfaces, DDL Spark execution, Delta remote controller, operations, recovery, and multi-tenancy.

From the DBMS 270, there here may be provided one or more DDL (data definition language) interfaces 667A (e.g., HANA SQL, Spark SQL, Rest APIs, and/or the like). The data warehousing environment 350 (e.g., SAP Datasphere or other type of data warehouse) may deploy tables using a table deployment mechanism (e.g., SEAL) via DDL APIs to deploy database artifacts. Building up a solution which aligns with this precedence provides a convenience of consuming the APIs, so the DDL extensions are provided to perform modeling the schema of Delta tables. This functionality includes remote virtual table semantics supported by HANA, with Delta as a new table type.

Moreover, virtual tables (see, e.g., 272A-B in FIG. 2) in the DBMS 270 may be created to represent a table on a remote system. This allows performing DDL operations on the remote table using HANA DDLs (indicated by including a remote clause in the DDL syntax) and keeps the virtual table schema in sync with the performed remote DDL operation. In the case of Delta tables, the virtual table is created at a data lake file container using a remote source with an adapter type as the file. The SoF access to serve SELECT/READ queries over the Delta tables may be performed using native SoF access. The remote DDL operations are performed using an additional spark engine, and the virtual table is then kept in sync with performed DDL using file adapter mechanisms. This behavior is a peculiar to Delta tables wherein DDL and READ accesses are performed using different engines.

The table created (using, e.g., a Spark service 610A, shown in FIG. 6) may also be also published in a catalog (e.g., a spark catalog) associated with the data lake file. This means subsequent Spark jobs for transformation and the like may directly refer to the table from the catalog using the schema table identity. The Spark jobs do not need to know (e.g., map) table path and the like. The schema name and table name used in a Spark catalog matches with the Spark jobs' corresponding values for a virtual table created on a DBMS instance. Examples of DDL capabilities supported by Delta table include: CREATE TABLE, ALTER TABLE ADD COLUMN, and DROP TABLE.

The data lake file system remote source provides capabilities which allow a database execution engine (e.g., a HANA execution engine) to perform, for example, read and/or SELECT operations on the Delta tables; however, it does not provide functionality to perform DDL operations on the Delta table. As such, an additional engine may be needed to perform the DDL operations on the Delta tables. This may be achieved using the DBMS Apache Spark service accessed using the SDA Spark adapter capability.

A user of the DBMS 270 may need to provide the Spark remote source an additional compute engine to use in the Delta table DDLs. Create table syntax is extended to accept this indication as an additional parameter using the remote controller clause. The Spark remote source may then be used for subsequent DDLs on the Delta table to perform remote operations which require spark compute.

By default, for example, the DDL remote execution and corresponding DBMS virtual table refresh are uncoordinated and do not provide atomic operations. Moreover, a deployment having multiple such Delta tables and DBMS tables, view, etc., cannot be atomic. Deployment performed by the data warehouse (e.g., Datasphere/SEAL) may require the cloud object store to provide a certain degree of atomicity for deployments performed across the DBMS system and multiple Delta tables. To address the atomicity requirements for lifecycle management of Delta tables, an extension of a SAGA pattern may be used with-remote DDLs on a Delta table. For example, as a part of with-remote HANA DDL, the SAGA pattern allows remote Delta DDL to commit on its own when executed. However, if HANA DDL (transaction) rolls back for some reason (e.g., rollback, error, save point rollback, etc.), then it performs compensating actions on the remote Delta table to logically undo the execution effect of remote DDL).

In some embodiments, a new remote-controller component may be included in the cloud-based DBMS 270, wherein the remote-controller component contains system catalogs to maintain the state of the remote Delta operations performed along with corresponding HANA transaction orchestrating them. This meta store may be populated by the Delta DDL executions to register remote operations, DBMS transaction IDs, compensation actions, and/or the like. In event of a rollback of the Delta DDL operation (with remote) for example, the DBMS transaction manager callback capability may notify the remote controller component about the rollback of a specific DBMS DDL and may identify the remote operation that needs to be compensated. To perform actual remote compensation, a background job (e.g., merge may run in the background. The job then picks up the remote operations to be compensated and performs the actual compensation using the Spark remote source (virtual procedure execution). The meta store catalog is updated accordingly once the remote compensation operation is complete.

In scenarios where the remote compensation fails repeatedly due to some errors (e.g., credentials missing, Delta table moved ahead in time, etc.), a user may perform the manual compensations using a table-consistency-check interface provided by the remote controller component or can use Spark APIs or Spark virtual procedures directly. Details of failures to perform the compensations may be recorded in the meta store to help assist the root cause of compensation failures.

Once delta-formatted tables are deployed using the DBMS with remote DDLs, a user may populate them using different mechanisms, such as a Spark job or a virtual Spark procedure, to consume Delta tables in other engines, such as Apache Kafka or other type of publish and subscribe service. As table size grows, monitoring the table and performing different table maintenance operations (e.g., optimize, vacuum, etc.) may be important for optimal performance and reducing costs. To facilitate these capabilities, the DBMS 270 may provide a set of virtual Spark procedures. For example, the Spark procedures may internally use an open-source Delta library and Spark SQL APIs to perform the required runtime operations on a table. Execution of the procedure internally uses Spark remote source specified during Delta table creation. These procedures may be consumed by for example the DBMS 270 and the data warehousing environment 350 tooling so a user can easily consume them from the tooling mechanisms. Additionally, the procedures may be available to consume using an SQL interface. These procedures may be installed on a DBMS 270 using for example a plugin infrastructure with a SQL-only plugin type supported by a plugin infrastructure. To operate this, monitoring tool(s) may be used, such as a SYS_REMOTE_CONTROLLER schema. The monitoring views to observe the status of different remote Delta operations can be performed using SYS_REMOTE_CONTROLLER.OPERATIONS view or using built-in procedure, such as CHECK_OPERATIONS.

For example, the following DBMS procedures may be used to perform Delta table operations:
1. GET_REMOTE_TABLE_SCHEMA
2. GET_REMOTE_TABLE_METADATA
3. GET_REMOTE_TABLE_HISTORY
4. LIST_REMOTE_TABLE_FILES
5. RESTORE_REMOTE_TABLE
6. VACCUM_REMOTE_TABLE
7. OPTIMIZE_REMOTE_TABLE
8. TRUNCATE_REMOTE_TABLE

In some implementations, a UI may be provided to the DBMS tools to perform the above-noted lifecycle management operation on Delta tables.

The following further describes the access of data in a data lake for inbound and/or replication and data processing and/or SoF.

The meta store is populated by Delta DDL executions to register remote operations, DBMS transaction IDs, and compensating actions. In the event of a rollback, the DBMS transaction manager notifies the remote controller, which identifies the remote operation to be compensated. Compensation is performed by a background job, and the meta store is updated accordingly. Manual compensation may be performed if automatic compensation fails.

Once Delta tables are deployed, users may populate them using Spark jobs or virtual Spark procedures. As table sizes grow, monitoring and maintenance operations (e.g., optimize, vacuum) are important for performance and cost management. The DBMS provides a set of virtual Spark procedures for performing runtime operations on Delta tables, which can be consumed by the DBMS and data warehouse tooling. Monitoring views are provided to observe the status of remote Delta operations, including start time, end time, fetched record count, total file count, skipped file count, and processed file count.

Replication flows for inbound data ingestion from source systems are supported. Data in the data lake can be stored as Delta tables managed by the data lake file system. Replication flows may use the RMS as runtime and follow an architecture supporting multiple runtimes. The RMS main engine may not support writing to Delta tables directly, but only provides writing certain file types, such as Parquet files. The data warehouse merges this data into Delta tables using a merge task.

This architecture enables the system to support robust, atomic, and consistent lifecycle management of Delta tables, with integrated support for DDL operations, recovery, and multi-tenancy, and seamless integration with Spark-based compute and the broader data platform.

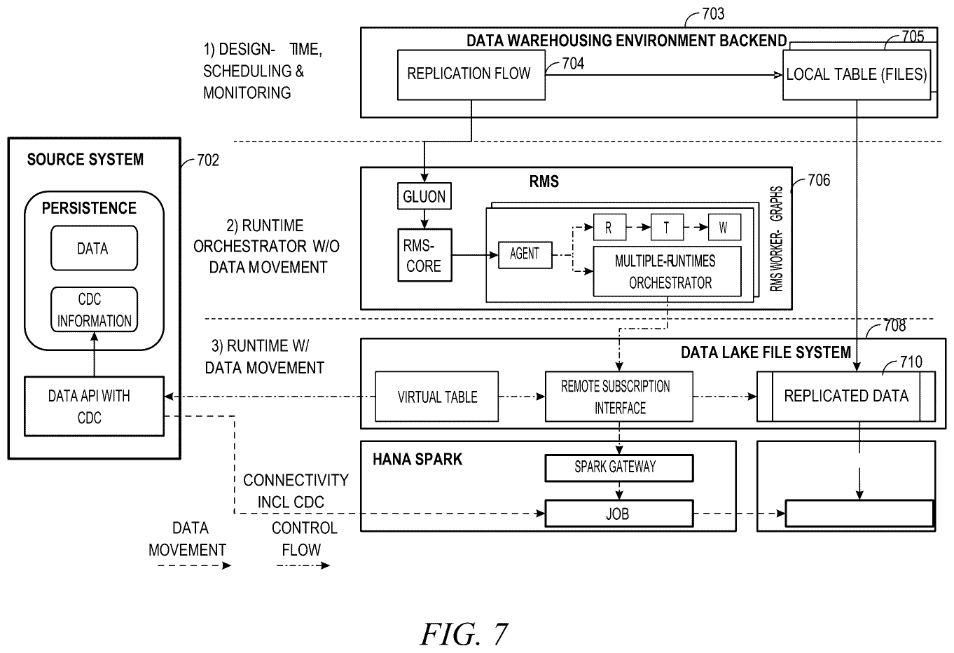

With respect to inbound replication of data from a source system, the data may be stored in the data lake by default on object stores. This also applies to high-volume data that is replicated from any kind of remote/source system (“replica”). From the perspective of a data warehouse (e.g., SAP's Datasphere or business data connectivity (BDC) runtime), FIG. 7 depicts an example of how data may be replicated from a source system to a data warehouse-owned data lake file system (DLFS) instance, in accordance with an example embodiment. The source system needs to expose its data with Change Data Capture (CDC) information, such as a change data feed used by Delta sharing. In a data warehouse (e.g., SAP Datasphere or other types of data warehouses), so-called “Replication Flows” replicate data to “Local Tables (File)”, which store data in delta tables managed by the data lake file system. Replication flows may use the Replication Management Service (RMS) at runtime, but generally follow an architecture of supporting multiple runtimes. The RMS main engine may not support writing to Delta tables directly, but only provides writing certain file types, such as Parquet files, to the data lake file system. Therefore, the data warehouse may merge this data into the Delta tables in the data lake file system (e.g., using a “Merge Task”).

Referring to FIG. 7, the Replication Management Service (RMS) 706 may use an extended version of a record to report to the sub engine, in which the RMS 706 delegates the replication to a “Remote Subscription” in the DBMS 270. The “Remote Subscription” may be technically enabled to write into the DBMS-managed Delta table. When this is the case, the DBMS 270's Spark would be used as runtime as it provides the capabilities for writing to the Delta tables.

When a source system is another Delta share provider, there may be two use cases:
1. Replicate from the remote delta share to the local share; then, column metadata (data types, primary key) may be provided through CSN.
2. “Zero-copy”: the remote Delta share may be “mounted” as a referenced share and used for downstream processing like federation or transformation (e.g., a data warehouse transformation flow) of RMS data replication into an object store:
   a. any CSN metadata written (e.g., primary keys for further replication to HANA).

SQL-on-Files (or SoF) is a feature for the data lake house system. It provides for (elastic) query processing over the data in the data lake, such as a cloud object storage, where the data is stored in file formats such as Apache Parquet with table semantics based on Apache Delta or Apache Iceberg tables. To enable these capabilities in the cloud-based DBMS (e.g., SAP HANA or other type of database), certain functions may be extended or created with respect to the optimizer, execution (e.g., database execution engine), file adapter, monitoring capabilities, and tooling.

The source system 702 exposes its data with CDC-information, such as a change data feed used by Delta sharing. In a data warehousing environment backend 703, a Replication Flow 704 replicates data to a local table (files) 705, which store the replication flow 704 data in Delta tables managed by the data lake file system 708. Replication flows 704 may use the RMS 706 as runtime, but generally follow an architecture of supporting multiple runtimes. The RMS 706 may not support writing to Delta tables directly, but only provides writing certain file types, such as Parquet files to the data lake file system 708. Therefore, the data warehousing environment backend 703 may take care of merging this data into the delta tables in the data lake file system 708 (e.g., using a merge task).

This architecture enables the system to support robust, flexible, and scalable data ingestion from a variety of source systems 702, including both structured and unstructured data sources. The RMS 706 is responsible for replicating data from these sources into the data lake file system 708, resulting in replicated data 710. Once the data is in the data lake file system 708, merge tasks are used to combine and curate the data into Delta tables, which are then available for downstream analytics, transformation, and sharing.

The use of CDC-information and Delta sharing protocols ensures that changes in the source data are efficiently captured and propagated to the data lake, supporting near real-time data integration and minimizing data movement. The architecture supports multiple runtimes for replication flows, allowing organizations to choose the most appropriate engine for their workload and operational requirements.

By decoupling the ingestion of raw data (as Parquet files) from the management and optimization of Delta tables, the system provides a flexible and extensible foundation for modern data warehousing and lake house scenarios. The data warehousing environment backend 703, in conjunction with the data lake file system 708, orchestrates the end-to-end flow of data from source ingestion to analytics-ready tables, supporting advanced features such as schema evolution, time travel, and transactional integrity.

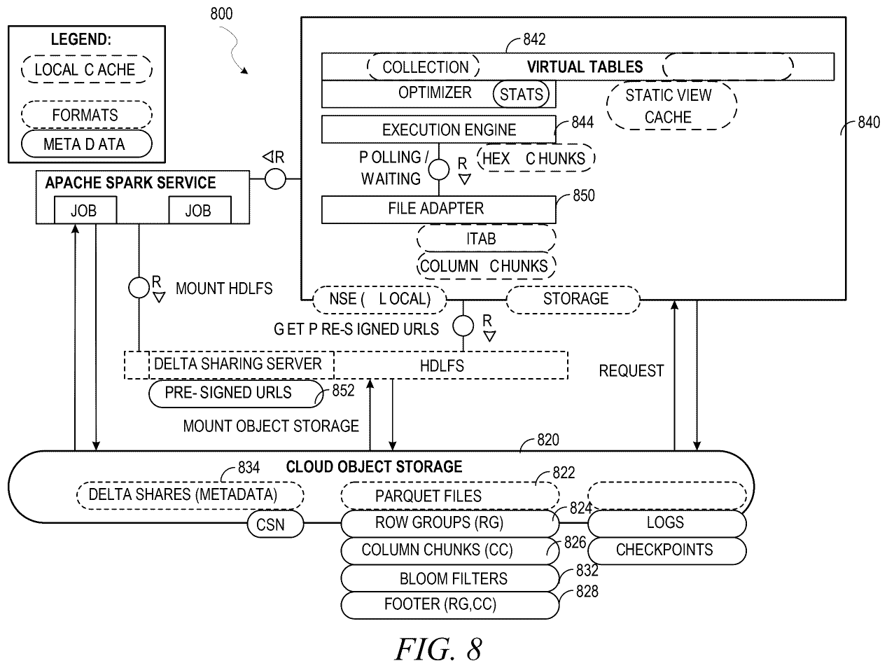

FIG. 8 illustrates a system 800 including SQL-on-Files (SoF) functionality, in accordance with an example embodiment. The system 800 includes a cloud object storage 820, which is configured to store data in a column-oriented data file format, such as Parquet files 822. The Parquet files 822 are organized into row groups 824, each of which contains a plurality of tuples. Within each row group 824, data is further organized into column chunks 826, with each column chunk 826 representing the values for a particular column across all tuples in the row group 824. Each Parquet file 822 includes a footer 828, which contains metadata describing the schema, tuple count, file offsets, and bloom filters 832 for the file 822. The bloom filters 832 are used to filter data and reduce resource usage during query execution, particularly for join operations.

The system 800 further includes Delta metadata 834, such as Apache Delta tables metadata, which is used to provide table semantics for the data stored in the object storage 820. The Delta tables metadata 834 tracks which Parquet files 822 are part of different table versions and supports features such as ACID-compliant transactions, streaming input/output, time travel, schema enforcement and evolution, and data validation.

A database management system (DBMS) 840 is provided, which creates virtual tables 842 that reference the data stored in the object storage 820. The virtual tables 842 are locally stored at the DBMS 840 but include metadata describing the data stored in the object storage 820. The DBMS 840 includes an execution engine 844, which is configured to process SQL queries over the virtual tables 842.

A file adapter 850 is provided, which is responsible for reading Parquet file data from the object storage 820 and allowing for query processing with the DBMS's execution engine 844. For each read access, the DBMS 840 may issue a pre-signed URL 852 pointing to the data in the Parquet file 822 from the Delta sharing, and may thus access the object storage 820 directly through gateway endpoints. The file adapter 850 reads the column chunks 826, applies the requested operations (such as filters and projections), and returns a resulting internal table (ITAB). The ITAB may be converted into columns and/or rows and processed by the execution engine 844.

A static view cache on virtual tables may also be included in the DBMS 840, which can improve performance for repeated queries by caching the results of previous queries on the virtual tables 842 that represent the remote data in the object storage 820.

This architecture enables the DBMS 840 to provide SoF functionality, allowing direct, in-situ query processing over data stored in files in the object storage 820. The use of pre-signed URLs 852 and file adapters 850 allows the DBMS 840 to efficiently access and process data in open formats such as Parquet, leveraging the metadata and transactional features provided by the Delta shares metadata 834. This approach eliminates the need for intermediate data movement or transformation, supporting high-performance analytics and data science workloads directly on the data lake.

The integration of SoF with the broader data platform allows organizations to seamlessly query, analyze, and transform data stored in the data lake using familiar SQL interfaces and leveraging the scalability and flexibility of cloud object storage. This figure and its associated architecture demonstrate how the platform enables efficient, scalable, and interoperable analytics on large volumes of data in a modern cloud-based environment.

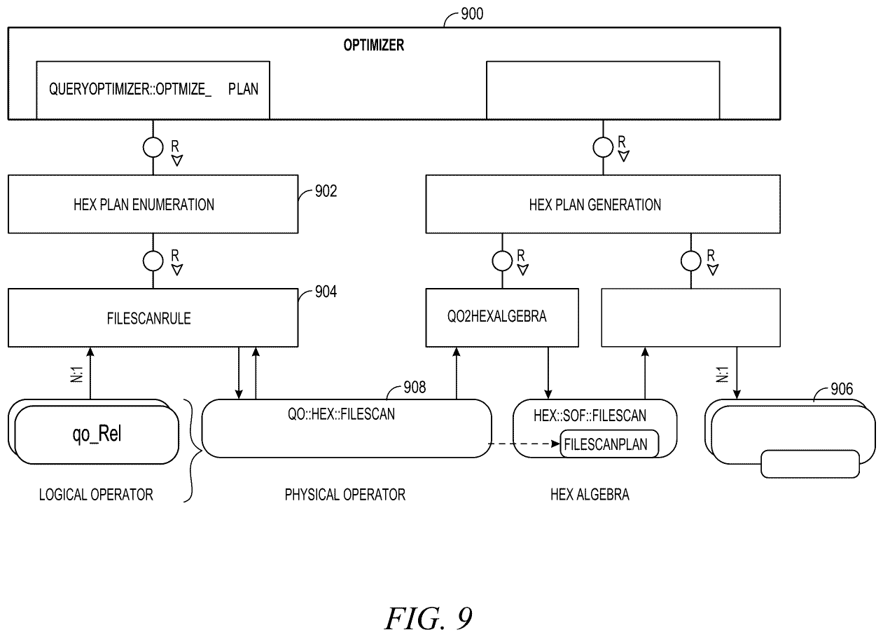

FIG. 9 illustrates an example of an optimizer 900 and associated query planning and execution components for SQL-on-Files (SoF) processing in a cloud-based data platform, in accordance with an example embodiment. The system includes a HEX plan enumeration module 902, which is responsible for generating and enumerating possible query execution plans for a given SQL query. The HEX plan enumeration module 902 evaluates different physical operator choices and plan shapes, including those specific to file-based access.

The optimizer 900 further includes a FileScanRule module 904, which is a rule or transformation within the optimizer 900 that recognizes when a portion of a query plan can be executed as a file scan operation. The FileScanRule module 904 identifies opportunities to replace logical scan operators with physical file scan operators that are capable of directly accessing data stored in files 906 in object storage.

The files 906 represent the physical data files stored in the object storage layer, which may be in open formats such as Parquet, Delta Lake, or Apache Iceberg. The FileScanRule module 904 generates a FileScan operator 908, which is a physical operator in the query plan that is responsible for reading data from the files 906. The FileScan operator 908 may be configured to push down filter predicates and projection operations to minimize the amount of data read and processed.

The output of the FileScan operator 908 is provided to downstream operators in the query execution plan, such as aggregation or join operators, as determined by the HEX plan enumeration module 902. The optimizer 900 may also include cost estimation logic (not explicitly shown in the figure) to compare the cost of different plans and select the most efficient plan for execution.

This architecture enables the system to efficiently plan and execute queries over large-scale, distributed data stored in open file formats in the data lake. By incorporating a FileScanRule module 904 and supporting the generation of FileScan operators 908, the system achieves improved performance and resource utilization for SQL-on-Files (SoF) workloads. The use of plan enumeration in the HEX plan enumeration module 902 ensures that the optimizer 900 can consider both traditional and file-based access methods, selecting the optimal plan for each query.

This figure and its associated architecture demonstrate how the platform's optimizer 900 is adapted for modern, cloud-native data lake house environments, supporting both traditional and in-situ query processing over open data formats.

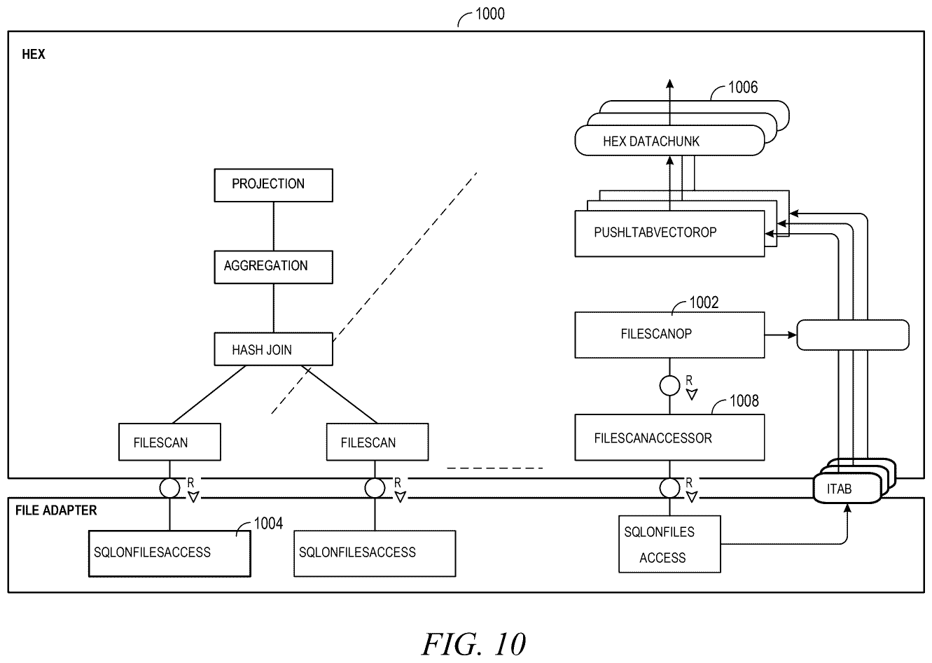

FIG. 10 illustrates an example SoF (SQL-on-Files) execution architecture 1000, in accordance with an example embodiment. The architecture 1000 is designed to enable efficient query processing over data stored in files in a cloud-based object storage environment.

The architecture 1000 includes a FileScan operator 1002, which is responsible for reading data directly from files in object storage as part of the query execution plan. The FileScan operator 1002 is invoked by the SQL-on-Files access layer 1004 (labeled as SQLONFILESACCESS in the figure), which serves as the interface between the query execution engine and the underlying file storage.

The FileScan operator 1002 produces output in the form of HEX data chunks 1006 (labeled as HEX DATACHUNK in the figure). These HEX data chunks 1006 represent the intermediate results of the file scan operation and are passed to downstream operators in the query execution pipeline for further processing, such as projection, aggregation, or join operations.

The SQLONFILESACCESS layer 1004 coordinates the execution of the FileScan operator 1002 and manages the flow of data between the file storage and the query execution engine. The SQLONFILESACCESS layer 1004 may also be responsible for applying additional query operations, such as filter predicates or limit clauses, to the data as it is read from the files.

The architecture 1000 further includes a FileScan accessor 1008 (labeled as FILESCANACCESSOR in the figure), which is a component that interfaces directly with the file storage system to retrieve the required data blocks. The FileScan accessor 1008 may support asynchronous and parallel data access, enabling the architecture 1000 to efficiently read large volumes of data from distributed storage.

The FileScan operator 1002, SQLONFILESACCESS layer 1004, HEX data chunks 1006, and FileScan accessor 1008 work together to enable high-performance, in-situ analytics on large-scale data stored in open file formats in the data lake. By supporting pushdown of operations, parallel and asynchronous data access, and direct conversion of file data into internal table and chunk formats, the architecture 1000 eliminates the need for intermediate data movement or transformation.

This figure and its associated architecture demonstrate how the DBMS execution engine and file adapter are configured to efficiently process SoF queries, supporting robust, scalable analytics in a modern cloud-native data platform.

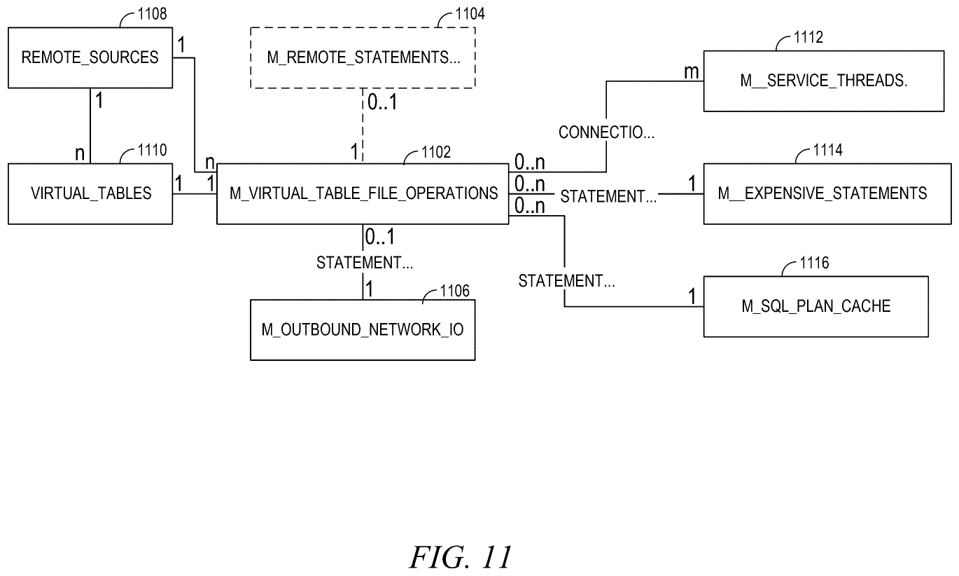

FIG. 11 illustrates the relationships among monitoring and statistics views for SQL-on-Files (SoF) operations in a cloud-based data platform, in accordance with an example embodiment.

In the architecture depicted in FIG. 11, the view M_VIRTUAL_TABLE_FILE_OPERATIONS 1102 is a primary monitoring view for file operations performed during the execution of virtual tables. The view M_REMOTE_STATEMENTS 1104 provides additional information about remote statement executions and remote query statistics, respectively. M_VIRTUAL_TABLE_FILE_OPERATIONS 1102 is linked to the view M_OUTBOUND_NETWORK_IO 1106. The linkage between these views is established through the columns STATEMENT_EXECUTION_ID and FILE_OPERATION_ID, which are present in each view. These columns serve as join keys, allowing users to correlate file operation records across the different monitoring and statistics views.

The REMOTE_SOURCES 1108 element represents the configuration and metadata for remote data sources that are accessible by the database system. The VIRTUAL_TABLES 1110 element represents the metadata and configuration for virtual tables, which are logical representations of data stored in remote sources or files.

The figure also includes M_SERVICE_THREADS 1112, which provides information about the service threads active in the database system, including their status and resource consumption. M_EXPENSIVE_STATEMENTS 1114 is a view that tracks SQL statements identified as resource-intensive or long-running, enabling administrators to identify and troubleshoot performance bottlenecks. M_SQL_PLAN_CACHE 1116 contains information about cached SQL execution plans, which can be used to analyze query optimization and plan reuse.

The relationships depicted in FIG. 11 allow users and administrators to join and correlate information across these views, providing a comprehensive picture of file scan operations, remote query execution, network I/O, service thread activity, expensive statements, and SQL plan caching. For example, a user can trace a specific file operation from M_VIRTUAL_TABLE_FILE_OPERATIONS 1102, join it to the corresponding network I/O record in M_OUTBOUND_NETWORK_IO 1106 using STATEMENT_EXECUTION_ID and FILE_OPERATION_ID, and further analyze the associated remote statement in M_REMOTE_STATEMENTS 1104, the service thread in M_SERVICE_THREADS 1112, the resource usage in M_EXPENSIVE_STATEMENTS 1114, and the execution plan in M_SQL_PLAN_CACHE 1116.

This arrangement enables comprehensive monitoring, diagnostics, and performance analysis for SQL-on-Files operations in a distributed, cloud-native data platform. The architecture shown in FIG. 11 supports robust operational management and troubleshooting by exposing detailed metrics and relationships among all relevant system components and activities.

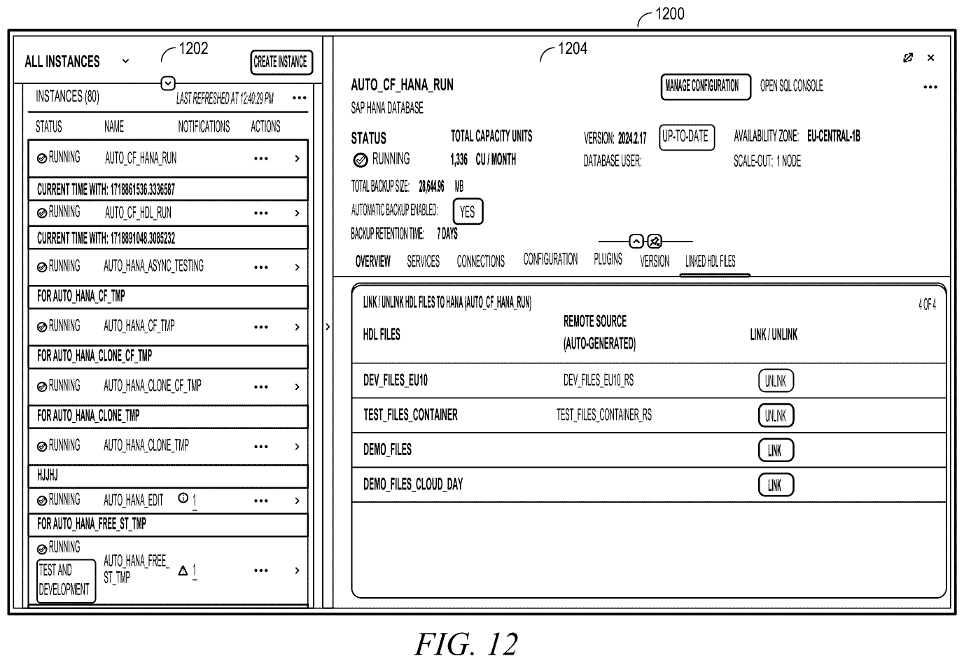

FIG. 12 is a screen capture illustrating an example user interface 1200 for a transformation flow editor, in accordance with an example embodiment. The user interface 1200 includes an instances area 1202 where instances can be viewed and selected. A configuration management area 1204 can then be used to manage the configuration of a selected instance.

A data warehousing environment may be used to provide tooling to support various kinds of data management use cases, such as classic data warehousing, business user data marts, semantic layer cases, and/or the like. The term “data warehousing environment” refers to cloud-based data warehouse that may be used to organize, transform, and/or manage data. For example, the data warehousing environment may include tooling that makes different types of data available across an enterprise, while preserving the data's context. Moreover, the data warehousing environment may support data modeling using graphical low or no code tools, allows users to integrate and harmonize data, provides a gateway to access data from a wide range of sources and formats, and/or other aspects. For example, the data warehousing environment may be provided as a unified service for data integration, cataloging, semantic modeling, data warehousing, and virtualizing workloads across a variety of data. The data warehousing environment may enable data professionals to easily distribute mission-critical data (e.g., business data) with business context and logic preserved across the enterprises data landscape.

In some embodiments, there is provided a system configured to provide a data warehousing environment. The system may include one or more services, such as data ingestion, data storage, data processing, data transformation, orchestration and monitoring, and analytics.

For example, the data ingestion service may be used to write files into a file service as optimized files in full, initial, and/or Delta mode. To illustrate further, stored files may be accessed through a data lake files service (e.g., HANA Data Lake File Service, HDLFS).

Moreover, the data warehousing environment's data storage (e.g. Local Table(s) (File)) may be stored in a Delta table format with processes executed using an analytics engine (e.g., Spark jobs) to merge files into the Delta table, optimize Delta tables for read access, and/or vacuum Delta tables by deleting unnecessary changed rows.

Additionally, or alternatively, the data warehousing environment may include a data transformation service (e.g., a transformation flow) that may be modeled (e.g., graphically and/or using a low or no code environment) as for example relational operations such as joining of tables, calculated columns, and/or the like, which are converted to jobs (e.g., Spark jobs) reading from Delta tables and writing into Delta tables.

Additionally, or alternatively, the data warehousing environment may include orchestration of some if not all jobs using, for example, one or more pipelines in for example one or more corresponding task chains. These task chains may enable monitoring of the data-relevant processes in the data warehousing environment system.

Additionally, or alternatively, the data warehousing environment may include data analytics (e.g., analytic modeling) as Delta tables are exposed as local table artifacts in the data warehousing environment's modeling tool(s) to create consumption SQL views, graphical views, analytic models, and/or the like.

An aspect of the data warehousing environment is a data lake house. The data lake house is similar in some respects to a “data lake” (which refers to a repository such as an object store that stores and manages large amounts of data in its original format), but the data lake house further provides additional data management and data warehousing tools. The data lake house may provide a data platform (e.g., a data lake such as cloud object storage), elastic computing on top of the data lake's storage (e.g., using an analytics engine (or compute engine), such as Apache Spark or the like), and integrated with a cloud-based database management system (e.g., SAP's HANA database or other types of databases) including SQL-on-Files (SoF) processing. Moreover, the data at the cloud object store (also referred to herein as a data lake) may be accessed through a file system, such as a data lake file system (DLFS) and/or a data lifecycle management system.

An aspect of a lake house is a relatively large, scalable, and cheap object store layer, which serves as an inbound, history-preserving, and fine-granularity storage. Additionally, a lake house may provide (or enables) tools to perform a wide variety of processes on top of this data to transform it into higher quality datasets using out-of-the-box and customized logic. In the case of analytic use cases, an additional storage and compute layer may be used on top of the data lake to enable read access to the data and/or serves as a “cache” layer where pre-aggregations are stored in the form of view materializations.

The following provides an example of a use case for a data lake used for cloud-based data warehousing. In today's on-premise system landscapes, a data warehouse may store different types of data. Depending on the end-user/customer's business, these data warehouses may manage relational data of up to several hundreds of terabytes (which may be uncompressed) in their primary and secondary database(s). The primary database may be, for example an in-memory, database management system (e.g., SAP's HANA cloud) that may be deployed on-premise, while the secondary persistence may be provided by either the in-memory database management system another relational database management system.

For example, the secondary persistent may be used as “nearline storage”, to which “cold” data is moved by means of data tiering. In this context, data sphere may be used as a public cloud-based system providing an integrated, scalable, and low-priced storage layer (e.g., an object store) that allows end-user customers to bring their data warehouse data including the nearline storage to the data sphere.

The data warehousing environment may include an object store with certain file formats (e.g., a column-oriented data file format, such as Apache Parquet, which is an open source, column-oriented data file format, although other types of file formats including row-oriented may be used as well) that allows the data sphere to store and manage mass data efficiently. Moreover, the object store may be used for data in nearline storage, which is a history-preserving cold store with data not often used in analytics. In addition, this may allow the data warehousing environment to use the object store as a default inbound layer for data ingestion, with the option to keep fine-granular data for a lengthy period due to the anticipated low cost for “data at rest.” The data warehousing environment's data ingestion (e.g., data ingestion replication management service) may be configure data integration into a large variety of cloud and non-cloud sources while directly writing files into the object store.

For complex data processing, the system including the data lake house and cloud data warehousing, data processing and transformation capabilities may be used for processing data through various data layers of the system. For example, usage patterns may include scripting capabilities, such as imperative programming (“pro-code”) or support several sources and targets.

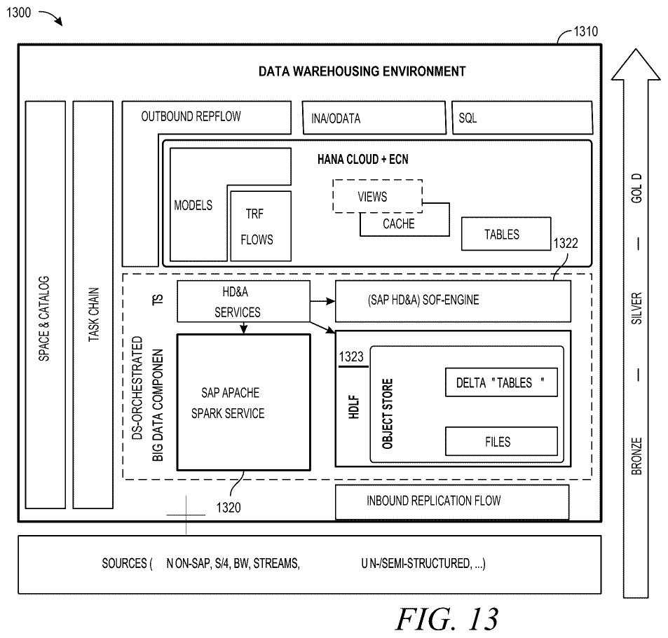

FIG. 13 depicts an example of a system 1300 comprising a data warehousing environment 1310, in accordance with an example embodiment. FIG. 13 depicts the layers including a service 1320 (labeled SAP Apache Spark Service) providing a compute service or layer, a SoF engine 1322 (e.g., SQL-on-Files (SoF) processing engine), and a data lake file service 1323 (labeled HDLF). The data lake file service 1323 provides a novel storage component as a managed object store. Moreover, the query compute engine for file-persistency may be based on native SQL-on-Files (SoF) technology. Moreover, a compute layer may be used to expand data transformation capabilities based on the Spark service, for example.

In some implementations, the HDLF and the Spark will not be provisioned to all data warehousing environment tenants by default. Instead, a new “Large Systems” option will be made available as part of space type, that includes file storage (HDLF) and compute (Spark). There will be a dependency in between file storage (e.g., HDLF) and the compute (e.g., Spark).

The object store may be implemented via the data warehousing environment and integrated into its provisioning and tenant configuration. It is used primarily as storage location for the parquet-files of the “Local Table Files”, but also for Hana Cloud Spark to store runtime logs or app-artifacts (code files).

The data warehousing environment may make use of HANA Data Lake Files.

In some embodiments, there is provided a cloud-based system including an in-memory database management system coupled to a data warehouse and to a data lake. Moreover, there may also be provided novel services such as a data lake file service (e.g., HDLFS as storage option), a compute engine (e.g., Spark Service for Compute-on-Files), and SQL on Files (SoF) for relational and analytic data-read access. Moreover, a packaged, no-code solution may be used to leverage these services for data ingestion, data storage, data processing, data transformation, orchestration and monitoring and analytics as used for example by data warehousing use-cases.

The services may include a data ingestion tool (replication flow) to write into HDLFS as optimized files in full, initial and delta mode. Alternatively, or additionally, the services may include data storage (e.g., Local Table (File)) in Delta table format with processes executed as Spark jobs to merge files into a Delta table, optimize Delta tables for read access, and/or vacuum Delta tables by deleting unnecessary changed rows.

The services may include a data transformation (e.g., transformation flow) that is graphically modeled relational operations like joining of tables, calculated columns, and/or the like that are converted to Spark jobs reading from Delta tables and writing into Delta tables.

The services may include the orchestration of jobs, which may be implemented as pipelines in task chains. These task chains allow simplified but powerful monitoring of data-relevant processes in the system.

The services may include data analytics (e.g., analytic modeling) as the Delta tables are exposed as local table artifacts in the data warehousing environment modeling tooling to create consumption SQL Views, Graphical Views, Analytic Models. SAP Analytics Cloud (SAC) can access these models; queries use HC as runtime/engine and data access in added to the Delta tables via the new SoF.

In an example embodiment, a unified, extensible, and highly scalable data platform that integrates embedded data lake capabilities, advanced data warehousing, analytics, lifecycle management, secure authentication, metadata management, direct access, flexible data sharing, and fine-grained privilege management is presented. This enables organizations to efficiently ingest, store, manage, transform, and analyze large volumes of structured, semi-structured, and unstructured data in a cloud-based environment, leveraging open table formats, elastic compute, robust metadata, and security controls.

The system is designed to support both in-memory and disk-based storage, as well as object-based storage, allowing data to be managed and accessed regardless of the underlying storage technology. The platform provides a unified interface for data ingestion, transformation, and analytics, and supports change data capture (CDC), schema enforcement and evolution, and time travel to historical table versions, enabling robust data governance and auditability. Ingested data is stored in the data lake in its native or transformed format and may be further curated or optimized using transformation flows and compaction operations.

As mentioned above, one feature of the platform is its support for open table formats, which provide a metadata layer for data access and management. These formats enable ACID-compliant transactions, schema evolution, and efficient query processing. The metadata layer tracks which files are part of different table versions, and supports features such as streaming input/output, time travel, and data validation. The use of open formats ensures compatibility with a wide range of analytics and machine learning tools and facilitates interoperability across cloud providers.

The DBMS component of the platform provides advanced data management and query capabilities. It supports the creation of virtual tables that map to data stored in the data lake, enabling seamless access to remote data using standard SQL interfaces.

The DBMS includes an execution engine and optimizer that are extended to support SQL-on-Files (SoF) functionality, allowing direct, in-situ query processing over data stored in files. The optimizer is capable of enumerating physical operators for remote file scan operations, and can push down filters, projections, and aggregations to a file adapter for efficient execution. The file adapter reads column chunks from Parquet or other open format files, applies the requested operations, and returns results as internal tables (ITABs) for further processing by the execution engine.

The platform also integrates elastic compute resources, such as Apache Spark, for large-scale data transformation and analytics. The DBMS may include a Spark adapter and controller, enabling the federation of SQL queries to Spark and the execution of virtual procedures for data transformation, machine learning, and advanced analytics. The system supports the orchestration of Spark jobs, including DDL operations on Delta tables, and provides runtime operations for monitoring and managing Delta table storage, such as optimize and vacuum commands.

The platform is designed to support onboarding of multiple lines of business (LoBs) and collaborative development across organizational boundaries. Internal teams and partner organizations may contribute data products, analytical content, and extensions, leveraging standardized interfaces and shared infrastructure to accelerate innovation and ensure interoperability.

Analytical content, including cubes, dashboards, and models, is created and managed using integrated design-time tooling and continuous integration/continuous delivery (CI/CD) pipelines. Content packages are modeled, tested, and deployed using automated workflows, ensuring consistency, reusability, and rapid delivery of business insights to end users.

In certain embodiments, the system integrates with external data engineering and data science platforms to provide advanced analytics and machine learning capabilities. Data Products may be shared via open protocols (e.g., Delta Sharing), enabling seamless access to SAP data for data engineers and scientists. The platform supports both internal managed Spark environments and customer-facing OEM workspaces, facilitating pro-code development and cross-platform interoperability.

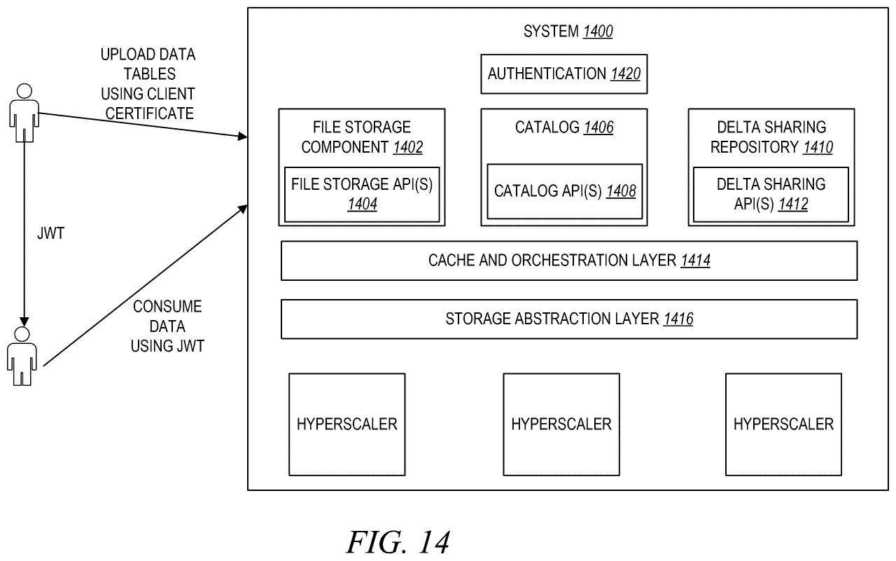

FIG. 14 is a block diagram illustrating a system 1400 for HDL file management, in accordance with an example embodiment. The system 1400 includes a file storage component 1402 that stores HDL files, which may be in the form of a WebHDFS repository or database. The file storage component 1402 exposes file storage APIs 1404 for accessing, uploading, downloading, and managing files. A catalog 1406 manages metadata relating to the HDL files, such as table definitions, schema information, and file attributes, and exposes catalog APIs 1408 for querying and managing this metadata. A Delta sharing repository 1410 stores information about Delta shares, tracking incremental changes between different versions of HDL files and exposing Delta sharing APIs 1412 for these operations. A cache and orchestration layer 1414 manages interactions with the system 1400 and the various APIs, caching frequently accessed files and metadata, and orchestrating workflows and process automation. A storage abstraction layer 1416 offers a consistent API for interacting with different types of storage systems, abstracting the details of the underlying storage technology and enabling seamless integration with external hyperscalers. An authentication component 1420 ensures that only authorized users and systems can access and modify HDL files or metadata.

In this embodiment, an admin uploads data tables to the system 1400 using file APIs, authenticating with a client certificate. The admin then generates a web token (such as a JWT) to impersonate a user and grant restricted privileges for accessing a specific share or table. The user, in possession of the JWT, can then access the Delta table with the granted privileges using their preferred tools. This architecture supports dynamic, scalable, and policy-driven authentication and authorization, with support for internal, recipient, and external JWTs, each with a defined set of claims, entitlements, and constraints. The system 1400 supports revocation of JWTs via deny policies and provides mechanisms for integrating authentication rules directly into the tokens, greatly improving scalability and flexibility.

The architecture of the system 1400 is designed to provide secure, auditable, and policy-driven access to data and metadata across distributed and federated environments. By leveraging web tokens and dynamic policies, the system 1400 can flexibly accommodate a wide range of enterprise security requirements, while also supporting fine-grained entitlements and scalable access control. The cache and orchestration layer 1414, in particular, ensures that data operations are efficient and that frequently accessed files and metadata are readily available, reducing latency and improving user experience. The storage abstraction layer 1416 further enhances the system's flexibility by allowing integration with a variety of storage backends, making the platform suitable for hybrid and multi-cloud deployments.

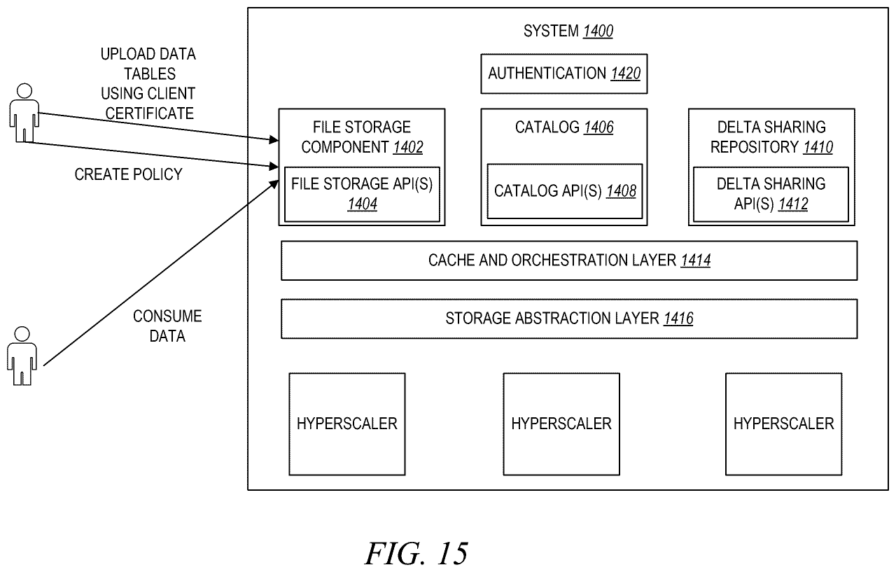

FIG. 15 illustrates a similar system architecture, but with a different usage pattern, in accordance with an example embodiment. Here, the admin or an application uploads data tables and then creates a policy in the system 1400 allowing a user to access only the uploaded Delta tables. The user authenticates using a client certificate identity and consumes the data accordingly. This approach supports both token-based and policy-based access control, enabling organizations to tailor their security models to their operational needs.

The distinction between the embodiments of FIG. 14 and FIG. 15 highlights the flexibility of the system 1400 in supporting different enterprise workflows. In FIG. 14, the use of JWTs allows for delegated and temporary access, which is particularly useful for scenarios involving external partners or short-lived data sharing. In contrast, FIG. 15 demonstrates how static policies can be used to grant ongoing access to specific users, which is more suitable for internal users or long-term access requirements. Both approaches are supported by the same underlying architecture, ensuring consistency and security across all access patterns.

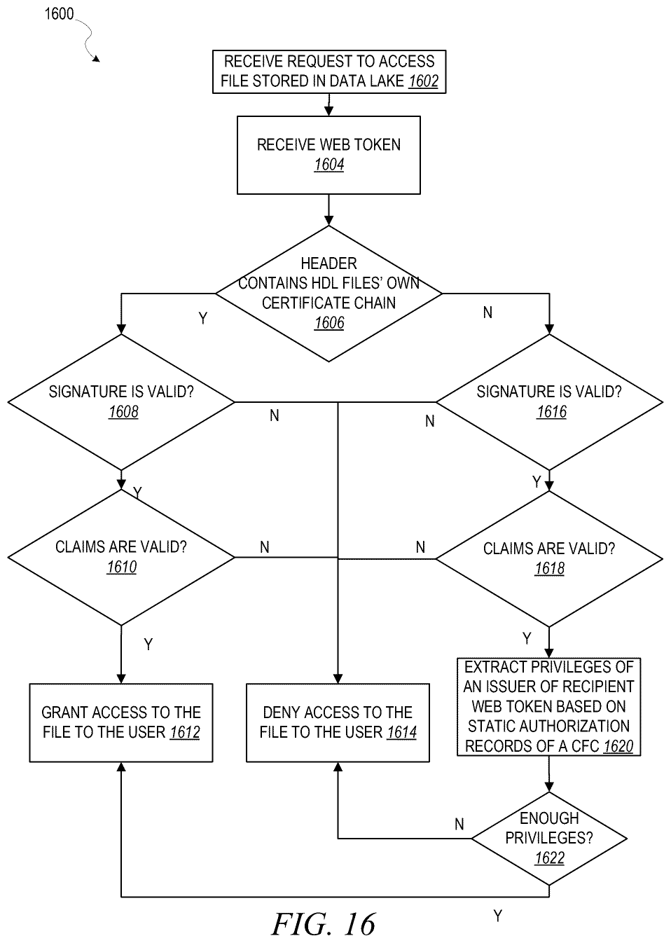

FIG. 16 is a flow diagram illustrating a method 1600 for authenticating a user of a data lake, in accordance with an example embodiment. At operation 1602, a request to access a file stored in a data lake is received. At operation 1604, a web token associated with the user is received. The web token containing a header, a signature, and one or more claims. At operation 1606, it is determined whether the header contains the certificate chain of a data lake file management software, such as HDL files. If so, then at operation 1608 it is determined whether the signature is a valid signature. If so, then at operation 1610 it is determined whether the claims are valid. If so, then at operation 1612 access is granted to the file. If either the checks at operation 1608 or operation 1610 fail, then access to the file is denied for the user at operation 1614.

If at operation 1606 it is determined that the header does not contain the certificate chain of the data lake file management software, then the web token is a recipient web token. At operation 1616, it is determined whether the signature is a valid signature. If so, then at operation 1618 it is determined whether the claims are valid. If so, then at operation 1620, privileges of an issuer of the recipient web token are extracted based on static authorization records of a CFC. At operation 1622, it is determined if the privileges of the user are enough to access the file. If not, then at operation 1614 the access is denied. Otherwise, at operation 1612 the access is granted. If either of the checks at operation 1616 or operation 1618 fail, then access to the file is denied for the user at operation 1614.

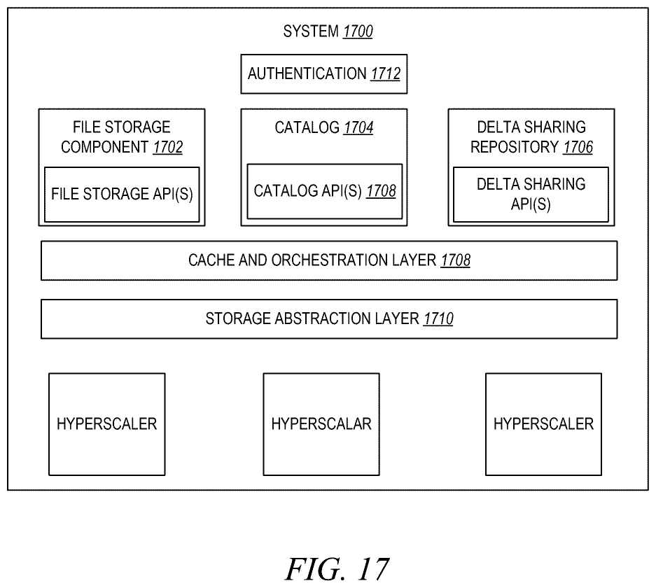

Moving to metadata management, FIG. 17 is a block diagram depicting a system 1700 for HDL file management with enhanced metadata capabilities, in accordance with an example embodiment. The system 1700 includes a file storage component 1702, a catalog 1704 for managing metadata, a Delta sharing repository 1706, a cache and orchestration layer 1708, a storage abstraction layer 1710, and an authentication component 1712, as previously described. The key innovation here is the ability to attach additional metadata to Delta tables via Delta shares, using a common schema notation (CSN) entity. CSN is a standard format for defining and documenting the structure of data models, and its use enables the system 1700 to provide strong schema definitions, primary key specifications, relationships, business semantics, and other metadata not natively supported by Delta tables.

The architecture of the system 1700 builds on the secure, extensible foundation established in the previous figures, adding a powerful layer of metadata management. By supporting the attachment of CSN entities to Delta tables, the system 1700 enables advanced data governance and semantic discovery. This is particularly important for organizations that need to manage complex data landscapes, where understanding the structure and meaning of data is critical for compliance, analytics, and machine learning.

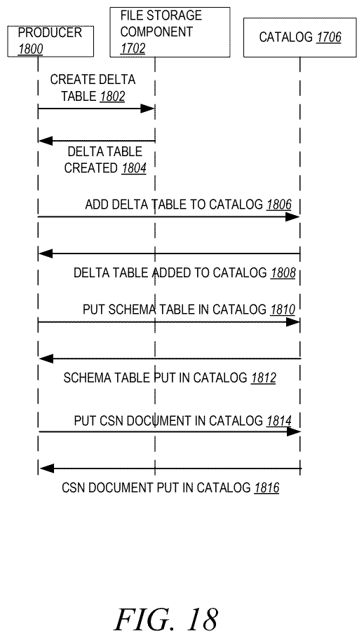

FIG. 18 is a sequence diagram illustrating the binding of CSN models to Delta share tables, in accordance with an example embodiment. Specifically, a producer 1800 creates a Delta table in the file storage component 1702 at operation 1802. At operation 1804, a notification is generated indicating that the Delta table has been created. The Delta table is then added to the catalog 1704 at operation 1806, with a notification generated at operation 1808 indicating that the Delta table has been added to the catalog 1704.

At operation 1810, the producer 1800 puts a schema table in the catalog 1704. At operation 1812 a notification is generated indicating that the schema table has been created in the catalog 1704. At operation 1814, the producer 1800 puts a CSN document into the catalog 1704. At operation 1816 a notification is generated indicating that the CSN document has been created and bound to the Delta table.

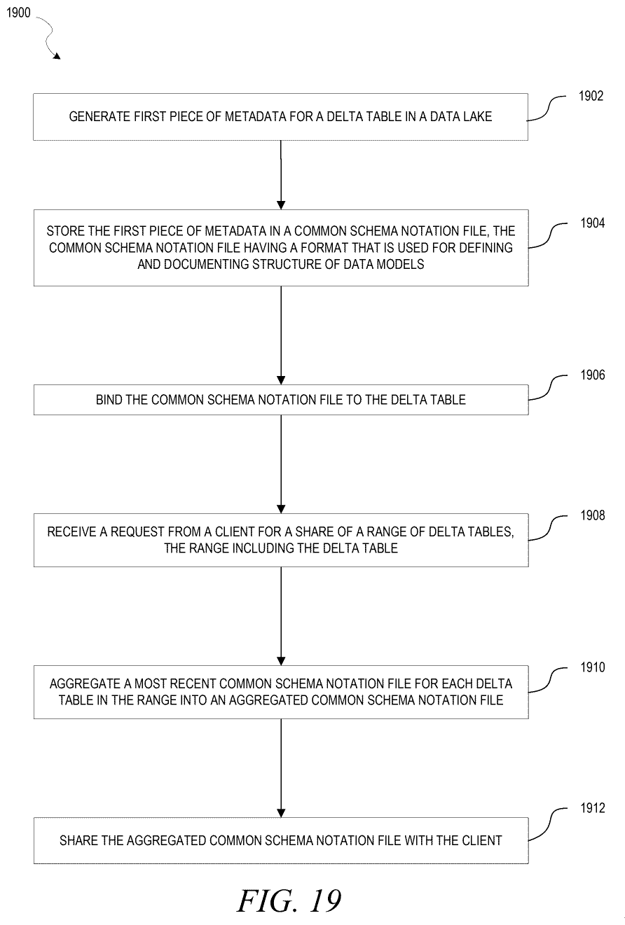

FIG. 19 is a flow diagram illustrating a method 1900 for attaching metadata to a Delta table, in accordance with an example embodiment. The method 1900 includes generating a piece of metadata at operation 1902, storing it in a CSN file at operation 1904, binding the CSN file at operation 1906 to the Delta table, receiving a request at operation 1908 for a share of Delta tables, aggregating the most recent CSN files at operation 1910, and sharing the aggregated metadata at operation 1912 with the client. This approach supports versioned, aggregated, and discoverable metadata, enabling advanced data management and interoperability in multi-tenant and multi-cloud environments.

The flow described in FIG. 19 highlights the system's support for versioned and aggregated metadata, which is essential for modern data governance. By allowing clients to request and receive the most recent metadata for a range of Delta tables, the present solution ensures that consumers always have access to up-to-date and accurate information. This functionality can be helpful in environments where data is frequently updated or shared across organizational boundaries.

The metadata management features described here are fully compatible with the data ingestion, transformation, and sharing mechanisms of the broader platform. By enabling the attachment and aggregation of rich metadata, the system supports advanced data governance, lineage, and semantic discovery, which are essential for enterprise analytics, regulatory compliance, and AI/ML workloads. The integration of metadata management with secure authentication and flexible access control ensures that only authorized users can access sensitive metadata, further enhancing the system's security and compliance capabilities.

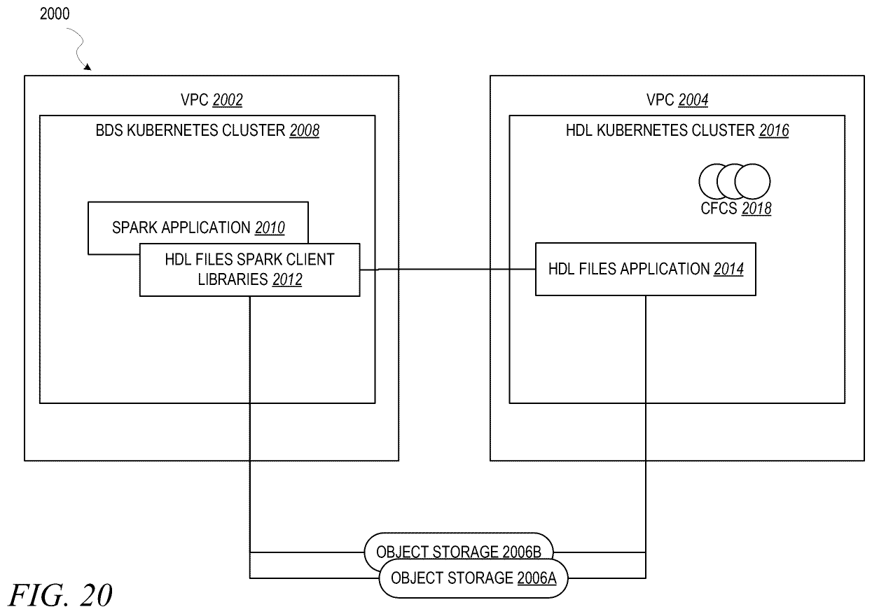

FIG. 20 is a block diagram illustrating a system 2000 for HDL file management, in accordance with an example embodiment. The system 2000 includes a first virtual private cloud (VPC) 2002 and a second VPC 2004. Also present in the system 2000 are a plurality of object storages 2006A, 2006B, each operated by a different hyperscaler.

HDL files is an existing HANA cloud service/component that is extended using the present solution. The responsibility of the HDL files component in the HANA Cloud is to provide object storage using a hyperscaler platform-agnostic Representational State Transfer (REST) API. Previously HDL files leveraged the object storages 2006A, 2006B provided by the underlying hyperscalers to store all user data. In an example embodiment, HDL files now support an alternative operation mode called “direct access,” which governs users' access to the storage, but user data is downloaded/uploaded directly from/to the hyperscaler. This design allows for the achievement of increased performance (latency, throughput, bandwidth, for example) and lowered costs. These benefits are due to the reduction in computing costs on the HDL files side caused by avoiding the transfer of data across VPC boundaries.

Note that, in this operation mode, user authentication and authorization are still provided and enforced by HDL files.

The first VPC 2002 contains a Big Data Services (BDS) Kubernetes cluster 2008. Kubernetes is a system for automating deployment, scaling, and management of containerized applications. Application containerization is a virtualization method used by operating systems to deploy and run distributed applications without launching an entire virtual machine for each application.

Inside the BDS Kubernetes cluster 2008, a spark application 2010 runs user workloads that leverage HDL files as the spark application 2010's storage. This is performed by means of HDL files Spark client libraries 2012, which implements Spark interfaces to speak with HDL file services.

HDL files Spark client libraries 2012 are libraries that allow the integration between Spark and HDL files. These libraries 2012 transfer data to HDL files using the endpoints exposed by HDL files and require no knowledge about the underlying object stores. This causes data to be transferred across VPCs, which can potentially incur additional costs. Furthermore, computing resources will be required by HDL files to process the data being transferred, incurring even more costs. In an example embodiment, the HDL files Spark client libraries 2012 now leverage the present solution, specifically direct access, to transfer the data directly to the object store, in order to achieve increased performance and reduced cost.

The HDL files application 2014 runs within an HDL Kubernetes cluster 2016 on the second VPC 2004.

The hyperscaler-specific object storages 2006A, 2006B each ultimately holds data contents of users. Each hyperscaler provides APIs to interact with the object storage, which can ordinarily be leveraged and completely abstracted by HDL files. When direct access is used, however, the user interacts directly with the hyperscaler using these APIs, which are not unified across hyperscalers. In this context, the HDL files application 2014 is still responsible to govern the transfer, and, therefore, will rely on the underlying hyperscaler capabilities to do so. This includes generating pre-signed URLs, temporary credentials or any other resources that are proven necessary, which will be analyzed and defined on a per-hyperscaler basis.

It should be noted that the HDL files application 2014 presents, to the user, credentials/resources that have minimal permissions to access the target file; thus the hyperscaler should have such capabilities as a prerequisite.

HDL files' existing APIs are unchanged, but a new optional HTTP header will be added to OPEN and CREATE operations to allow users to request the data to be transferred directly from/to the underlying object storage. The user will be able to request direct access as a hint, falling back to the default operation modes if direct access is not available, as well as request direct access as a requirement, in this case failing the request if not fulfilled.

When direct access is requested, no object content data transfer will occur through the HDL files application 2014. Instead, the HDL files application 2014 will only govern the transfer by returning a JSON response to the client containing the necessary information for the client to establish a connection with the hyperscaler and directly transfer the data.

The response from the HDL files will contain hyperscaler-specific data and it is expected that the client will be able to interpret the response and behave differently depending on the received hyperscaler type. The returned data might contain a pre-signed URL, temporary credentials, or any other data that proved necessary to be present to allow the user to perform the operation.

For example, considering an OPEN call/test?op=OPEN, the user could request direct access by setting the header X-SAP-Accept-Direct-Access to “true.” This header is interpreted as a hint by HDL files. If direct access is not enabled or supported, the header would be simply ignored. If direct access is required by the user, header “X-SAP-Expect-Direct-Access: true” would be used, in which case HDL files would respond with a failure message if direct access could not be fulfilled.

HDL files will return the response header “X-SAP-Direct-Access: true” to the client indicating that direct access is being used to allow the client to interpret the response body correctly.

Considering the underlying object store is “GCS” and direct access is fulfilled, an HDL file's response body would look like:

```
  {
    “type”: “GCS”,
    “properties”: {
  “headers”: {
        “x-goog-custom-audit-hdlf-request-id”: “r-
  BcrczRKLx1sG4InfQQJhYsiIk”
      },
      “endpoint”:
  “https://storage.googleapis.com/bucket/test?GoogleAccessId=<iam-uuid
      “method”: “GET”
    }
}
```

Note that the response indicates the underlying storage type as well as hyperscaler-specific properties, such that the client can parse it and handle it properly. One such property is the presence of header entries. Whatever entries are provided by the response should be used as headers in a request against the provided endpoint. In this example, HDL files generate a pre-signed Uniform Resource Locator (URL) that allows the reading of the file directly from the hyperscaler via HTTPS. Note that hyperscaler-specific information is also present in the URL itself, such as the bucket name and IAM user. This information will refer to resources that were provisioned solely for the cluster file container (CFC) 2018 to be accessed. Also, note that the URL is pre-signed with a key that is managed by HDL files, so it is impossible for the user to alter the path being accessed or the expiration time.

Furthermore, HDL files' OPEN call allows the user to specify the read range via offset and length query parameters. These parameters will also be supported when direct access is used. However, they will most likely not be directly enforced by the returned pre-signed URL, given that most hyperscalers do not support that. Instead, the offset and range will be injected by the user on the request to the hyperscaler. Note that this is not an issue given that HDL files do not support unauthorizing a user to read specific parts of a file.

The CREATE operation will work similarly to the OPEN operation. However, HDL files should allow the user to fully leverage the hyperscaler upload capabilities, such as multipart-upload or resumable-upload, when and where available. For that, more information than a simple pre-signed URL might need to be returned to the user, such as temporary credentials.

The client/user is then delegated the job of performing the request to the specified hyperscaler with the information returned from HDL files. Clients will be provided with proper documentation stating the format of HDL files response, as well as how to interpret the data and call the APIs properly. In the Apache Spark scenario, the job of consuming these APIs and interacting with the hyperscalers is delegated to our Spark libraries.

As for security, even though the data transfer will not go through HDL files, HDL files will still govern the transfer and enforce user authentication and authorization. Users may request direct access if they have permission to do so, based on the trusted authorities configured in the cluster file container being accessed, as well as the roles and access policies assigned to the user. Once the user performs the request and obtains a JSON response from HDL files, the user is considered authorized, and anyone in possession of the JSON response will be able to interact with the hyperscaler.

The user will not have permission to operate on any other files outside of the target prefix. Files that are within the target prefix might also be available for reading/writing. In this context, special care must be taken from HDL files to never allow direct access on a prefix that might violate user-defined access policies.

HDL files will ultimately leverage the security concepts offered by the underlying hyperscaler to enforce a communication with minimal permissions between user and hyperscaler. Hyperscalers can allow the creation of pre-signed URLs that target a specific file, as well as the generation of temporary credentials with limited access, leveraging IAM users with permissions to access specific paths within a bucket. The exact approach to be used will depend on the

Furthermore, the response returned by HDL files will always grant temporary permissions to the user, and the permissions should always expire after a short period. This will also be enforced by leveraging hyperscaler available capabilities, such as temporary pre-signed URLs and temporary credentials. If a user becomes unauthorized to a given file in HDL files after they own direct access temporary permissions, the temporary permissions might remain valid until their expiration time, which is a reasonable compromise given the system's eventual consistency nature.

In order to minimize the risk of unauthorized personnel accessing a given CFC (if they get hold of temporary permissions), some restrictions can be enforced. Object storage will be configured with policies that will allow access only from private IP addresses, which will enforce that the access is being performed by a user from within the same hyperscaler network and region. By enforcing that the object storage itself is only accessible from a certain IP range, resources such as pre-signed URLs and temporary credentials will be automatically restricted as well. This concept can be extended, if necessary, to allow the user to specify an IP range to be allowed.

As to user handling, new options may be added to the CREATE and OPEN operations to allow users to request direct access. When direct access is provided, HDL files will return a well-documented response in JSON format, which must be parsed and interpreted by the clients. Clients that want to leveragedirect access will be required to implement dedicated logic to interact with each hyperscaler of interest.

Thus, a mechanism is created in a control plane to allow an application to get authorized and express desire for certain resources, and the control plane generates a URL to allow applications to go directly to an endpoint. This works across multiple hyperscalers, as the correct URL can be acquired in a hyperscale-agnostic way. If there are multiple locations of a hyperscaler, the URL can be directed to the location that is closest to the user.

In some example embodiments, a JSON Web Token (JWT) can be included as a URL parameter to provide additional authentication capabilities. Additionally, in some instances traceability of use of URL can be helpful, such as when a URL is used and how often can be tracked.

Furthermore, the header of the request can also influence which URL is generated. For example, the request parameters could include a read range or specific columns. Access to individual columns could even be independently authorized.

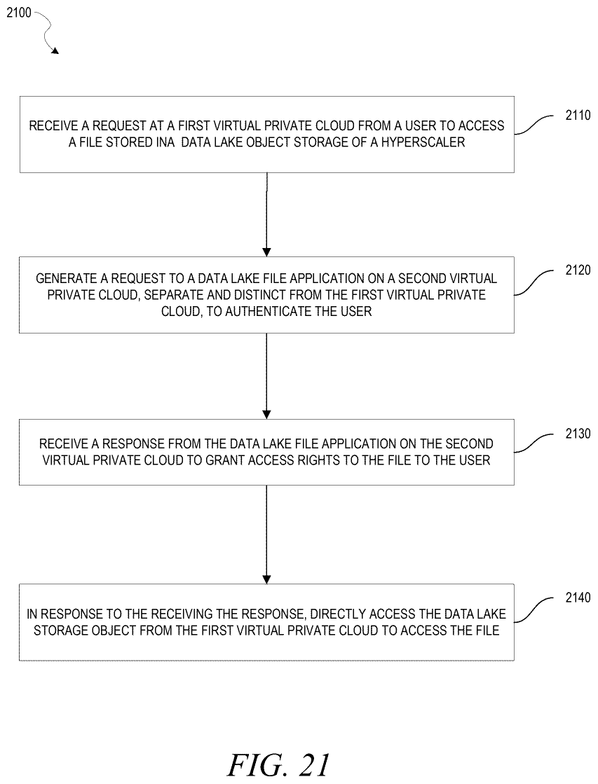

FIG. 21 is a flow diagram illustrating a method 2100 for granting access to a file on a data lake, in accordance with an example embodiment. At operation 2110, a request is received, at a first virtual private cloud, from a user, to access a file stored in a data lake object storage of a hyperscaler separate and distinct from the first virtual private cloud.

At operation 2120, a request to a data lake file application on a second virtual private cloud, separate and distinct from the first virtual private cloud, to authenticate the user, is generated.

At operation 2130, a response is received from the data lake file application on the second virtual private cloud to grant access rights to the file to the user.

At operation 2140, in response to the receiving the response, the data lake storage object is directly accessed from the first virtual private cloud to access the file.

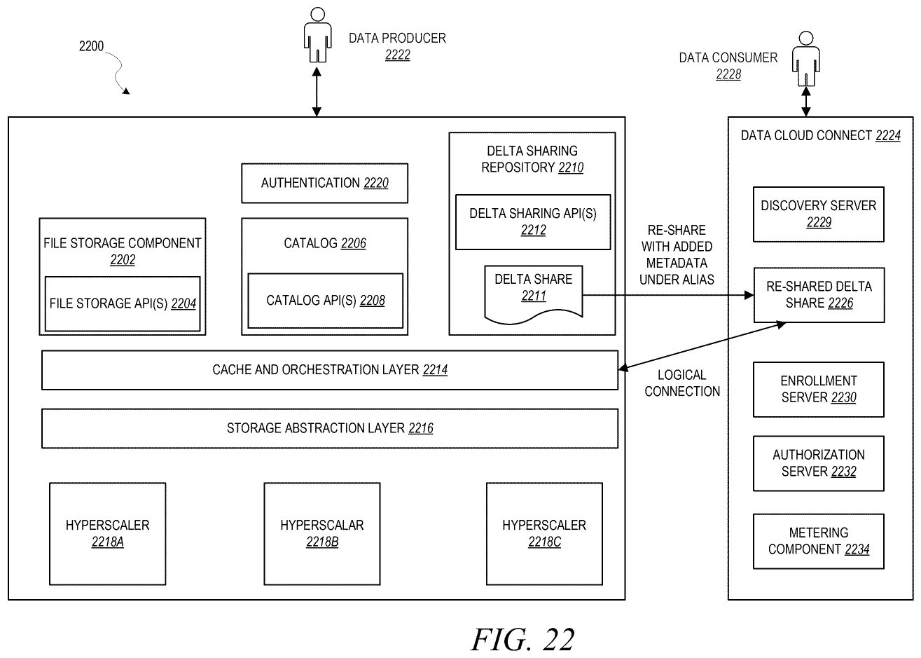

FIG. 22 is a block diagram illustrating a system 2200 for file management and data sharing, in accordance with an example embodiment. A file storage component 2202 stores the HDL files themselves. The file storage component 2202 may be in the form of, for example, a Web Hadoop Distributed File System (WebHDFS) repository or database. WebHDFS is a Representational State Transfer (REST) application program interface (API) for accessing HDFS files. It provides a web-based interface to interact with HDFS, allowing for file storage and retrieval operations over Hypertext Transfer Protocol (HTTP). The file storage component 2202 may therefore have one or more file storage APIs 2204, such as a WebHDFS, that can be used to access, upload, download, and manage the files stored in the file storage component 2202.

A catalog 2206 manages metadata relating to the HDL files, such as table definitions, schema information, and file attributes. This helps in organizing and querying metadata efficiently. The catalog 2206 includes tables that describe the structure, relationships, and attributes of the HDL files. Querying and management of this metadata can be performed using one or more catalog APIs 2208.

A Delta sharing repository 2210 stores information about Delta shares, such as a Delta share 2211. Delta sharing involves sharing incremental changes (Deltas) between different versions of Delta tables in HDL files. The Delta sharing repository 2210 tracks these changes and facilitates efficient sharing. This may involve storing Delta files or logs that capture modifications, additions, or deletions occurring between different versions of HDL files. The Delta sharing repository 2210 has one or more Delta sharing APIs 2212 to perform these tasks.

A cache and orchestration layer 2214 manages interactions with the system 2200 and the one or more file storage APIs 2204, the one or more catalog APIs 2208, and the one or more Delta sharing APIs 2212. More specifically it can cache frequently accessed HDL files, metadata, and Delta tables and handles workflows, process automation, and ensures that data flows smoothly between the file storage component 2202, the catalog 2206, and the Delta sharing repository 2210.

A storage abstraction layer 2216 offers a consistent API for interacting with different types of storage systems and hides the details of where and how the data is stored, allowing applications to interact with data in a uniform way regardless of the underlying storage technology. Thus, for example, external hyperscalers 2218A, 2218B, 2218C can interact with the file storage component 2202, the catalog 2206, and the Delta sharing repository 2210 without knowing the details of how those components operate. The storage abstraction layer 2216 abstracts the one or more file storage APIs 2204, the one or more catalog APIs 2208, and the one or more Delta sharing APIs 2212.

An authentication component 2220 ensures that only authorized users and systems can access and modify the HDL files or metadata.

A data producer 2222, which can also be known as a customer of the cloud-based data processing platform, can be the one initiating the initial Delta share 2211 but then later can opt to reshare the Delta share 2211 to the Data Cloud Connect 2224. The data producer 2222 may provide additional metadata in the form of ORD metadata that describes the underlying data and the access rules and functionalities associated with the underlying data. This forms a re-shared Delta share 2226 in Data Cloud Connect 2224. This, and other re-shared Delta shares, can be aggregated and discovered by data consumers, such as a data consumer 2228. The data consumer 2228 is able to discover, for example, the ORD metadata that is part of the re-shared Delta share 2226. Assuming the data consumer 2228 wishes then to access the underlying data, a logical connection is then formed from the re-shared Delta share 2226 to the cache and orchestration layer 2214 to facilitate the access to the underlying data and APIs in the cloud-based data processing platform via the Data Cloud Connect 2224.

The discovery of the re-shared Delta share 2226 may be performed via a discovery server 2229 on the Data Cloud Connect 2224. The discovery server 2229 essentially acts as a “marketplace” for data. An enrollment server 2230 facilitates the onboarding of a data producer 2222 to bring their data assets into that marketplace, where data consumers like data consumer 2228 can access them. An authorization server 2232 is used to authorize data consumers like the data consumer 2228. A metering component 2234 may be used to meter usage of the underlying data. For example, one of the parts of the ORD metadata may be a description of how much data can be used for what price. Thus, for example, a data producer 2222 may specify that each gigabyte of access to the data in the Delta share 2211 will cost one dollar. The metering component 2234 tracks this usage so it may be billed accordingly. Of course, other types of metering is possible too, including throttling or otherwise limiting access to data once a preset limit is reached (e.g., thirty gigabytes of data per month).

The ORD metadata may be provided in the form of an ORD document. Supported resource types that can be described in ORD include APIs, events, and data products. The first level structure of an ORD document may look like the following:

```
{
  “openResourceDiscovery”: “1.9”,
  “description”: “This is an example ORD document”,
  “describedSystemInstance”: {
    “baseUrl”: “https://ord-reference-
application.cfapps.sap.hana.ondemand.com”
  },
  “products”: [ ... ],
  “packages”: [ ... ],
  “consumptionBundles”: [ ... ],
  “apiResources”: [ ... ],
  “eventResources”: [ ... ],
  “entityTypes”: [ ... ]
}
```

A data product is a data set intended for consumption outside of the boundaries of the producing application via APIs and described by metadata. Here, Delta shares are represented as ORD data products. In order to achieve this, the data product object will contain information that is generated by the system of the data producer 2222 as well as information that is provided by the data producer 2222 that is publishing the Delta share as a data product.

The ORD metadata may include items such as a title (e.g., “customer order”), a short description (e.g., “offering access to all online and offline orders submitted by customers”), and a longer description (e.g., “The data product Customer Order offers access to all online and offline orders submitted by customers. It provides a customer view on the orders. For fulfillment-specific aspects please refer to the data product Fulfillment Order.”). Other types of information may also be provided in the ORD metadata.

An ORD API resource provides a high-level description of an exposed API. In the context of the representation of Delta shares as data products, an API resource may be linked as an output port of each data product and may describe the endpoint for consumption of the share via Delta sharing protocol.

Every resource may be linked to a package. In order to avoid the need for the user to provide metadata for the package object, in addition to the data product metadata, all data products and API resources may be bound to a single package that is automatically generated by the system of the data producer 2222. Thus, in the context of the cloud-based data processing platform, there will be a single package grouping all Delta sharing resources that could look, for example, like the following:

```
{
    “ordId”: “customer.ext:package:Default:v1”,
  “title”: “Open Resource Discovery Delta Sharing resources”,
  “shortDescription”: “This package contains all ORD Data Products
  and ORD
API Resources based on Del
    “description”: “...”,
    “version”: “1.0.0”,
  “vendor”: “sap:vendor:SAP:”
}
```

When a data producer 2222 wishes to publish one of their Delta shares as an ORD data product (i.e., “re-share” it), they can leverage a Create or Update Share API and provide the additional ORD metadata under a new property to be included in the request payload, such as in accordance with the following example:

```
{
  “type”: “REMOTE_SHARE”,
  “provider”: {
    “type”: “FEDERATION”,
    “name”: “cloud-based data processing platform”
  },
  “@openResourceDiscoveryV1”: {
    // Required fields
    “title”: “<string>”,
    “shortDescription”: “<string>”,
    “description”: “<string>”,
    // Optional fields
    “name”: “<string len < 255 chars>”,
    “<data-product-field-name>”: <data-product-field-value>,
    “apiResource”: {
      “name”: “<string len < 255 chars>”,
      “<api-resource-field-name>”: <api-resource-field-value>
    }
  }
}
```

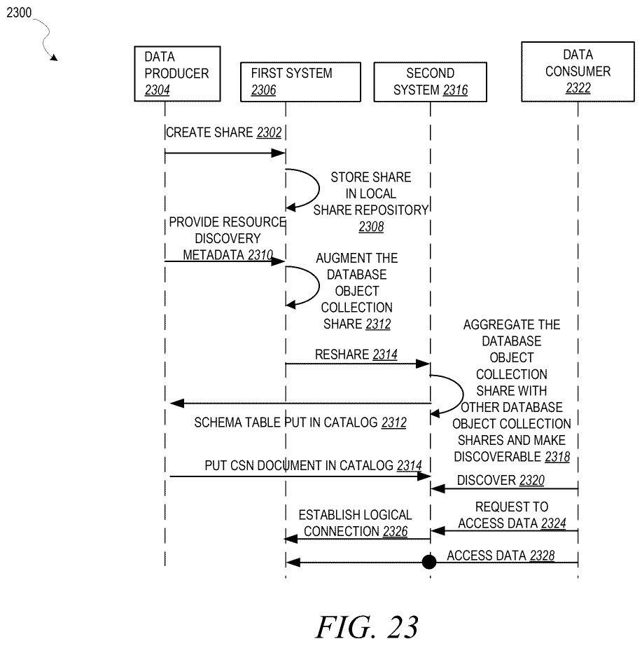

FIG. 23 is a sequence diagram 2300 for sharing a share in computer systems, in accordance with an example embodiment. At operation 2302, a data producer 2304 creates a database object collection share in a first system 2306. The database object collection share comprises an indication of data produced by the data producer 2304 that is sharable with users outside of an organization of the data producer 2304. At operation 2308, the first system 2306 stores the database object collection share in a local share repository.

At operation 2310, the data producer 2304 provides resource discovery (e.g., ORD) metadata containing underlying data and the access rules regarding the database object collection share. At operation 2312, the first system 2306 augments the database object collection share in the share repository with the resource discovery metadata. At operation 2314, the first system 2306 reshares the augmented database object collection share with a second system 2316.

At operation 2318, the second system 2316 aggregates the augmented database object collection share with other augmented database object collection shares and makes them discoverable via a discovery server. At operation 2320, a data consumer 2322 discovers the reshared augmented database object collection share via the discovery server in the second system 2316.

At operation 2324, the data consumer 2322 sends a request to the second system 2316 to access data in the reshared augmented database object collection share. At operation 2326, the second system 2316 establishes a logical connection with the first system 2306. At operation 2328, the data consumer 2322 accesses the data in the database object collection share in the first system 2306 via the logical connection, using the access rules described in the reshared augmented database object collection share.

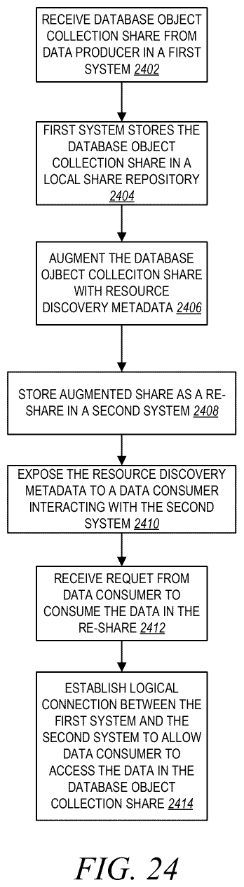

FIG. 24 is a flow diagram illustrating a method for 2400 sharing a share in computer systems, in accordance with an example embodiment. Although the example method depicted in FIG. 24 shows a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At operation 2402, a database object collection share is received in a first system from a data producer. The database object collection share comprises an indication of data produced by the data producer that is sharable with users outside of an organization of the data producer. At operation 2404, the first system stores the database object collection share in a local share repository.

At operation 2406, the database object collection share is augmented with resource discovery metadata obtained from the data producer. The resource discovery metadata describes access functionality for the data produced by the data producer. At operation 2408, the augmented share is stored as a re-shared share in a second system.

At operation 2410, the resource discovery metadata is exposed to a data consumer interacting with the second system. At operation 2412, a request is received at the second system from the data consumer to consume the data produced by the data producer. At operation 2414, a logical connection is established between the first system and the second system to allow the data consumer to access the data produced by the data producer via the access functionality in the resource discovery metadata.

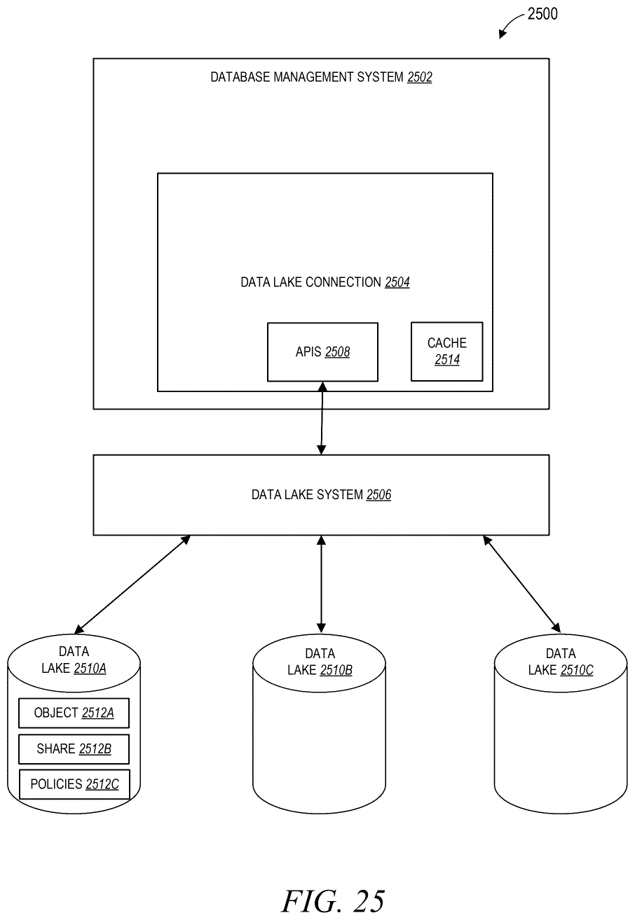

FIG. 25 is a block diagram illustrating a system 2500 for coordinating transactions and privileges across relational databases and open format tables on object storage, in accordance with an example embodiment. A database management system 2502 provides a data lake connection 2504 to a data lake system 2506. In an example embodiment, the database management system 2502 may be HANA. HANA is an in-memory database. An in-memory database (also known as an in-memory database management system) is a type of database management system that primarily relies on main memory for computer data storage. It is contrasted with database management systems that employ a disk storage mechanism. In-memory databases are traditionally faster than disk storage databases because disk access is slower than memory access.

The data lake connection 2504 may be, for example, an HDL files connection and the data lake system 2506 may be HDL.

The data lake connection 2504 may include one or more APIs 2508 for performing various actions in the data lake system 2506. The data lake system 2506 manages one or more data lakes, such as data lake 2510A, data lake 2510B, and data lake 2510C. Each of these data lakes stores data in its native format without structuring. This may include objects, such as object 2512A, and shares, such as share 2512B.

In an example embodiment, the one or more APIs 2508 include one or more new APIs to manage policies stored in the data lakes, such as policies 2512C. While the policies, such as policies 2512C, are stored in the data lakes, they are managed and executed at the database management system 2502. Specifically, when a user wishes to access a resource stored on a data lake, such as object 2512A or share 2512B, the data lake connection 2504 is used to retrieve corresponding policies 2512C and store them in a cache 2514. The one or more APIs 2508 then manage access to the resources using those policies 2512C stored in the cache 2514.

As mentioned earlier, the one or more APIs 2508 are designed to allow policies to be applied not just to objects, such as object 2512A, but also to other types of resources, such as share 2512B. Indeed, the one or more APIs 2508 are designed to allow for policies to be extensible to any type of resource.

The policy rules in the policies 2512C may be specified in an extensible format, such as a JavaScript Object Notation (JSON) file. The following is an example of a policy rule in accordance with an example embodiment:

```
{
  “createdAt”: 1475877193,
  “resources”: [
    “share:bobshare”
  ],
  “subjects”: [
    “user:bob”
  ],
  “privileges”: [
    “browse”,
    “open”
  ]
}
```

Here a policy rule is provided that gives user “bob” the privileges “BROWSE” and “OPEN” when accessing the specific share “bobshare”.

The “Created at” field indicates the last modification time of the policy. As will be seen later, this modification time is important in the case of overlapping or conflicting policies.

The privileges field defines a list of privileges that will be granted to the user. Example privileges and their corresponding meanings include browse (list resources), open (read the content of resources), create (create resources), delete (delete resources), append (append to resources), rename (rename resources), restore (restore resources), authorize (authorize other users), and impersonate (impersonate another user).

The subjects field defines the list of subjects of the policies. These subjects may include users (e.g., user: bob), roles (e.g., role: marketing), and x509 (e.g., x509: CN=bob). The x509: subject allows for the definition of policies that are activated based on the subject-distinguished name of the client certificate provided by the user in the request. Therefore, this subject type is only activated when the request identity is established from an x509 client certificate, without impersonation. The subject-distinguished name is resolved based on Lightweight Directory Access Protocol (LDAP). The subject “user: *” can also be supported to indicate a policy that is applied to all users. Additionally, dynamic users and roles are supported, through using “% USER %” and “% ROLE %”, which will evaluate to the user and role(s), respectively, of the identity currently using the system.

The resources field defines a list of resources to which the policies can be applied. This may include, for example, a file or prefix reference (path: [prefix/file-name]), schema definition within a catalog (catalog: schema: [schema-name]), table definition within a catalog (catalog: schema: [schema-name]: table: [table-name]), share definition within a catalog (catalog: share: [share-name]), a share's schema definition within a catalog (catalog: share: [share-name]: schema: [schema-name]), a share's table definition within a catalog (catalog: share: [share-name]: schema: [schema-name]: table: [table-schema]), a share accessed through the sharing endpoint (share: [share-name]), a share's schema accessed through the sharing endpoint (share: myshare: schema: myschema), a share's table accessed through the sharing endpoint (share: myshare: schema: myschema: table: mytable), or the collection of all resources (*). Note that defining the collection of a specific resource is also supported.

The “path:” resource namespace represents files that are accessed through the HDL files API. The “catalog:” and “share:” namespaces have no influence over requests that directly access files through the API. The only resource namespace of the new policies API that control the access is the “path:” namespace. However, legacy file-policies can still be accounted for if they are defined. A legacy policy is a policy defined using an existing endpoint that does not implement the techniques described herein. Specifically, a legacy policy may be defined using a WebHDFS endpoint.

The following table summarizes mapping between privileges of resource type “path:” to corresponding WebHDFS operations:

| Operation | Path: |
|---|---|
| APPEND | APPEND |
| CHECKACCESS | — |
| COPY | OPEN |
| CREATE | CREATE |
| MERGE | CREATE |
| DELETE | DELETE |
| DELETE_BATCH | DELETE |
| GETACCESSPOLICY | AUTHORIZE, IMPERSONATE |
| GETFILESTATUS | BROWSE |
| GETOPERATIONSTATUS | — |
| GETRESTORESNAPSHOTSTATUS | RESTORE |
| LISTSTATUS | BROWSE |
| LISTSTATUS_BATCH | BROWSE |
| LISTSTATUS_RECURSIVE | BROWSE |
| OPEN | OPEN |
| REMOVEACCESSPOLICY | AUTHORIZE, IMPERSONATE |
| RENAME | RENAME |
| RESTORESNAPSHOT | RESTORE |
| SETACCESSPOLICY | AUTHORIZE, IMPERSONATE |
| WHOAMI | — |

The following set of rules may be enforced:

A policy applied to a prefix will act on an object whose key matches the prefix. For example, policy path:/my/object will be applied to object/my/object.

A policy applied to a prefix will act on all objects created inside the prefix. For example, policy path:/my/prefix will be applied to object/my/prefix/object1 and/my/prefix/inner/object2.

An end-slash in the policy prefix is irrelevant. For example, policy path:/my/prefix is the same as path:/my/prefix/. This means that policy path:/my/object/will act on object/my/object.

Additionally, operations like COPY, MERGE deal with additional files that are received as query parameters or in the request body. These files will also be protected based on the most fitting privilege for each case.

The catalog: schema: resource namespace represents schemas and tables that are stored in the catalog and accessed through the API. These resources are stored in the catalog as metadata files.

The table below summarizes the mapping between privileges of resource types to schemas and related operations:

| Operation | catalog: schema |
|---|---|
| Get Server Info | — |
| Create Schema | CREATE |
| Get Schemas | OPEN |
| Create or Update Schema | CREATE, APPEND |
| Get Schema | OPEN |
| Delete Schema | DELETE |
| Create Table | CREATE |
| Get Tables | OPEN |
| Create or Update Table | CREATE, APPEND |
| Get Table | OPEN |
| Delete Table | DELETE |
| Get Datasources | OPEN |
| Add Datasource | CREATE, APPEND |
| Get Datasource | OPEN |
| Delete Datasource | DELETE |
| Get Table Properties | OPEN |
| Set Table Properties | CREATE |
| Get Table Info | OPEN |
| Replace Files | CREATE, DELETE, OPEN |
| Get Table Files | OPEN |
| Add Statistics | CREATE, DELETE, OPEN |

The catalog: schema: resource namespace comprises also catalog: schema: [*]: table:. These namespaces allow the definition of policies for specific tables within a share. Also note that users can create policies for all schemas using catalog: schema: *. Similarly, catalog: schema: bobschema: table: * is supported to specify all tables.

The catalog: share: resource namespace represents shares that are stored in the catalog and accessed through API. Practically speaking, this API is intended to be used for share management and not for share consumption by recipients.

The table below summarizes the mapping between privileges of resource types to the API:

| Operation | catalog: share |
|---|---|
| Create Share | CREATE |
| Create Or Update Share Table | CREATE, APPEND |
| Delete Share | DELETE |
| Delete Share Table | DELETE |
| Get Share | OPEN |
| Get Share Table | OPEN |
| List Share Schemas | BROWSE |
| List Shares | BROWSE |
| List Share Tables | BROWSE |

The catalog: share resource namespace comprises also catalog: share: [*]: schema; and

catalog: share [*]: schema: [*]: table:. These namespaces allow the definition of policies for specific schemas within a share and specific tables within a share schema, respectively. Also note that users can create policies for all shares using catalog: share: *. Similarly, catalog: share: bobshare: schema: * and catalog: share: bobshare: schema: bobschema: table: * are supported to specify all schemas and all tables, respectively.

The share: resource namespace represents shares that are accessed through the API. The Sharing API follows the Delta Sharing Protocol and is intended to be used by users that want to retrieve tables and work with the data, usually named recipients.

Even though share: is an independent resource namespace, the shares that recipients consume are the same ones stored in the catalog and mentioned in Catalog Shares. When shares are accessed through the sharing API, the content of the underlying tables might be read and revealed to the user. For this reason, path: resource namespace will also be considered when accessing shares through the Sharing API.

The table below summarizes the mapping between privileges of resource types to operations:

| Operation | Share: | Path: |
|---|---|---|
| Get Share | BROWSE | — |
| List all Tables in a Share | BROWSE | — |
| List Shares | BROWSE | — |
| List Schemas in a Share | BROWSE | — |
| List Tables in a Schema | BROWSE | — |
| Query Table Metadata | BROWSE | OPEN |
| Query Table Version | BROWSE | OPEN |
| Read Change Data Feed | OPEN | OPEN |
| From Table | | |
| Read Data From Table | OPEN | OPEN |

Path: policies are evaluated considering the underlying files that are referred by the share. Share: policies have priority over path: policies. Additionally, legacy file-policies are still taken into consideration, with same priority as path: policies.

As an example, consider that user bob is trying to access data in share bobshare (via Read Data From Table operation), and the data is in prefix/users/alice/cars. In this case:
1. If no policies are in place, bob is only able to access the data if he has the OPEN privilege according to his roles.
2. If there is a path: policy that revokes bob's OPEN privilege to access the prefix/users/alice/cars, then bob will not be able to access the data, even if his roles grant him the OPEN privilege. An example of such policy is:

```
{
  “createdAt”: 1475877193,
  “resources”: [
    “path:/users/alice/cars”
  ],
  subjects”: [
    “user:bob”
  ],
  “privileges”: [ ]
}
```

Similarly, if there is a legacy file-policy that revokes bob's permission to read prefix/user/alice/cars, then bob will also not be able to access the data, even if his roles grant him the OPEN privilege. An example of such policy is:

```
{
  “path”: “/users/alice/cars”,
  “entries”: [“user:bob:---”]
}
```

If there is a share: policy that grants bob the OPEN privilege to access share bobshare, then bob will have permissions to see the data even if his roles do not grant him the OPEN privilege and even if there is a path: policy in place revoking his OPEN privilege for this prefix (or a legacy file-policy revoking read access to the prefix). An example of such policy is:

```
{
  “createdAt”: 1475877193.
  “resources”: [
    “share:bobshare”
  ],
  “subjects”: [
    “user:bob”
  ],
  “privileges”: [
    “browse”,
  “open”
  ]
}
```

The share: resource namespace comprises also share: [*]: schema; and share [*]: schema: [*]: table:. These namespaces allow the definition of policies for specific schemas within a share and specific tables within a share schema, respectively.

Also note that users can create policies for all shares using share: *. Similarly, share: bobshare: schema: * and share: bobshare: schema: bobschema: table: * are supported to specify all schemas and all tables, respectively.

Note that share: policies allow the definition of external recipients. For example:
1. An external recipient for share sharebob can be defined by creating a share: policy that allows user bob to access sharebob with privileges BROWSE and OPEN.
2. If bob is a user that does not have any static privilege, bob does not have access to the files API.
3. However, bob would have access to the sharing endpoint to interact solely with share bobshare.
4. User bob would only see bobshare when listing his shares.
5. User bob would be able to access the underlying tables of bobshare because an explicit share: policy exists.

Policies 2512C can also support a special array field named constraints. Constraints may follow a generic format and they will allow the imposition of certain restrictions that must be complied for the policy to be activated.

Each constraint will contain the following fields:

| Key | Type | Description |
|---|---|---|
| Context | String | Specifies on what |
| | | information a |
| | | restriction is placed. |
| Op | String | Operation used to for |
| | | evaluating the |
| | | restriction. |
| literal.value | String | A literal value of |
| | | arbitrary type. |
| literal.valueType | String | The type of the literal. |
| notEmpty | Boolean | An indication of |
| | | whether the constraint |
| | | is empty or not |

The list of supported operations (ops) vary according to each corresponding valueType. For example, the operations may include:

| valueType | ops |
|---|---|
| String | equals, notEquals, match, notEmpty |
| Number | equals, notEquals, greaterThan, |
| | smallerThan |

Additionally, the constraint “jwt: iat” may be defined. A policy rule with this constraint is only activated if the user is connecting to the system using a JavaScript Object Notation Web Tokens (JWT) token. This constraint imposes a restriction on the issue time (iat) claim of the JWT. The literal will have a number value that corresponds to an epoch timestamp. For example:

```
{
  “context”: “jwt:iat”,
  “op”: “greaterThan”,
  “literal”: {
    “value”: “1689555045”,
    “valueType”: “number”
  }
}
```

Furthermore, the constraint: “jwt:iss” may be defined. A policy rule with this constraint is only activated if the user is connecting to the system using a JWT token. This constraint imposes a restriction on the iss claim of the JWT. The literal will always have a string value. For example:

```
{
  “context”: “jwt:iss”,
  “op”: “equals”,
  “literal”: {
    “value”: “CN=bob,O=SAP”,
    “valueType”: “string”
  }
}
```

Furthermore, the constraint: “x509: subject” may be defined. A policy rule with this constraint is only activated if the user is connecting to the system providing a x509 identity. This constraint imposes a restriction on the subject of user's client certificate. The literal may have a string value. For example:

```
{
  “context”: “x509:subject”,
  “op”: “equals”,
  “literal”: {
    “value”: “CN=hdl-sof-worker,O=hdl.demo-hc-3-hdl-hc-dev.dev-
aws.hanacloud.ondemand.com”,
    “valueType”: “string”
  }
}
and
{
  “context”: “x509:subject”,
  “op”: “match”,
  “literal”: {
    “value”: “\hat{ }CN =.*,L-fce090a6-330b-454f-92a3-
ceb9556bd999\\.ingress\\.bds\\.demo-gcp-bds-hc-dev\\.dev-
gcp\\.hanacloud\\.ondemand\\.com$”,
    “valueType”: “string”
  }
}
```

Additionally, the constraint: “x509: trustBinding” may be defined. A policy rule with this constraint is only activated if the user is connecting to the system providing a x509 identity. This constraint imposes a restriction on the trust binding name bound to the user's client certificate.

Trust binding is a logic concept presented in the definition of a CFC. It allows an authorization record to be bound to a certificate trust, meaning that the authorization record will only be activated if the request presents a leaf certificate which is anchored in the given trust-alias certificate.

The x509 trust binding refers to the set of trusts. For example, a client presenting a x509 cert with subject “CN=system1” is only fully qualified by also providing a constraint that refers to the specific trust-binding, unless the trust-binding can be derived from the subject.

The literal may have a string value. For example:

```
{
  “context”: “x509:trustBinding”,
  “op”: “equals”,
  “literal”: {
    “value”: “trustAlias1”,
    “valueType”: “string”
  }
}
```

Up to this point, the concept of policies was discussed in the sense of, when activated, a specific set of privileges is set to the user. These policies may be called “allow policies.”

A different policy type, named “deny policies,” may also be supported. Such policies are used to explicitly revoke privileges from users.

Policies of type deny also expect a list of subjects, resources, privileges and constraints. Just like allow policies, a deny policy is activated when the user identity matches the policy subjects, the resource the user is accessing matches the policy resources, and if all constraints are respected. When a deny policy is activated, the privileges array define a set of privileges that are always revoked from the user.

To differentiate between allow policies and deny policies, the field type will be introduced in the policy definition, with possible values being allow or deny.

For deny policies, the privileges array may be omitted. In this case, all privileges are revoked.

As explained in more detail below with respect to conflicts and ambiguity, deny policies follow a different conflict resolution rule than allow policies. Specifically, while in the case of allow policies the most priority policy dictates the user's final set of privileges, for deny policies the privileges of all activated policies are aggregated together and revoked. This enables support for scenarios such as token revocation.

When a user accesses the system, a policy is activated only if the user identity matches the policy subjects, if the resource the user is accessing matches the policy resources and if all constraints are respected. However, if multiple policies are activated and they define different privileges, they are conflicting. When this happens, a pre-established set of rules is used to derive the effective set of privileges to be considered.

In the case of allow policies, the rule may indicate that it will only consider the privileges defined by the policy with highest priority, while the privileges defined by the other conflicting policies will be simply ignored. The policy priority for privileges is defined based on the following set of ordered rules: The policy with the most specific resource namespace is used, and the others are ignored.
1. If the policy has resource type path, the policy with the largest common prefix will be used and the others ignored.
2. If the policy has a subject with format x509: [x509-subject], it is used, and the others are ignored.
3. If the policy has a subject with format user: [user-name], it is used, and the others are ignored.
4. If the policy has a subject with format role: [role-name], it is used, and the others are ignored.
5. Server policies have preference over JWT policies (check HDL files JWTs).
6. Otherwise, the privileges defined by all remaining policies are merged together.

### EXAMPLES

1. share: bobshare: schema: bobschema has priority over share: bobshare.
2. path:/foo/bar has priority over path:/foo.
3. x509: CN=bob has priority over user: bob.
4. user: bob has priority over role: marketing and user: *.
5. role: marketing has priority over user: *.
6. If two policies declare the exact same resource and subject, but grant conflicting privileges, then if one is a static policy, whereas the other is a dynamic policy declared in a JWT, the static policy has preference and the JWT policy is ignored.
7. Consider: policy 1 with resource: “share: bobshare”, subject: “user: bob”, privileges:
[“browse”] and policy 2 with resource: “share: bobshare”, subject: “user: bob”, privileges: [“open”]. Both policies have the exact same priority, so they will be merged into policy resource: “share: bobshare”, subject: “user: bob”, privileges: [“browse”, “open”].

An example of allow policies resolution:

```
Server Policy 1:
{
  “createdAt”: 1475877193,
    “resources”: [“share:myshare”],
    “subjects”: [“user:*”],
    ‘privileges”: [ ]
}
Server Policy 2:
{
    “createdAt”: 1475877193,
    “resources”: [“share:myshare”],
    “subjects”: [“role:marketing”],
    “privileges”: [“browse”]
}
JWT Policy 1:
{
    “sub”: “bob”,
    “roles”: [“marketing”],
    “com.sap.bds/entitlements”: [
      {
        “resource”: [“share:myshare”],
        “privileges”: [“open”]
      }
    ]
}
```

Consider a user bob with role marketing accessing resource share: myshare via JWT. Note that, in this case, all policies will be activated.
Server policy 2 has priority over server policy 1 because of rule 5 (role: marketing is more specific than user: *). However, JWT policy 1 has priority over server policy 2 because of rule 4 (user: bob is more specific than role: marketing). Therefore, JWT policy 1 wins and the effective privileges of user bob will be open.

In the case of deny policies, policies have the same priority. Conflicts are resolved by aggregating the privileges of all policies that were activated. An example of deny policies resolution:

```
Server Policy 1:
{
  “type”: “deny”,
  “createdAt”: 1475877193,
  “resources”: [“share:myshare”],
  “subjects”: [“user:*”],
  “privileges”: [“browse”, “open”]
}
Server Policy 2:
{
  “type”: “deny”,
  “createdAt”: 1475877193,
  “resources”: [“share:myshare”],
  “subjects”: [“role:marketing”],
  “privileges”: [“open”, “create”]
}
{
  “type”: “deny”,
  “createdAt”: 1475877193,
  “resources”: [“share:myshare”],
  “subjects”: [“user:bob”],
  “privileges”: [“append”]
}
```

Consider a user bob with role marketing accessing resource share: myshare. Note that, in this case, all policies will be activated.

Since all privileges are aggregated, the final set of privileges will be [“browse”, “open”, “create”, “append”]. Therefore, all of these privileges will be revoked from the user.

The new policies design presented herein may be exposed via a new prefix in HDL files. Users will be able to create policy rules via regular Representational State Transfer (REST) APIs. Each policy rule will receive a unique name and will be stored as a separate file in the HDL files regional/landscape-wide metadata storage.

```
Example of a policy rule file:
{
  “name”: “alicepolicy”,
  “createdAt”: 1475877193,
  “resources”: [
    “share:bobshare”
  ],
  “subjects”: [
    “user:bob”
  ]
  “privileges”: [ “browse”, “open” ]
}
Example response body:
{
  “policies”: [
    {
      “name”: “policy1”,
      “createdAt”: 1475877193,
      “resources”: [
        “share:*”
      ],
      “subjects”: [
        “user:bob”
      ],
      “privileges”: [ ]
    },
    {
      “name”: “policy2”,
      “createdAt”: 1475877193,
      “resources”: [
        “share:bobshare”
      ],
      “subjects”: [
        “user:alice”
      ],
      “privileges”: [ “browse”, “open” ]
    }
  ]
}
Example response body:
{
  “name”: “policy3”,
  “createdAt”: 1475877193,
  “resources”: [
    “share:*”
  ],
  “subjects”: [
    “user:alice”
  ],
  “privileges”: [ ]
}
Example request body:
{
  “resources”: [
    “share:bobshare”
  ],
  “subjects”: [
    “user:frank”
  ],
  “privileges”: [ ]
}
```

When policy rules are created, HDL files checks the request body format and accepts the request if it is valid. More specifically, a custom resource in Kubernetes may be used to generate a provisioning event to process the policy changes. The policy document will be kept in memory to allow fast access during runtime. For this reason, there may be an upper limit on the number of policy rules to a maximum.

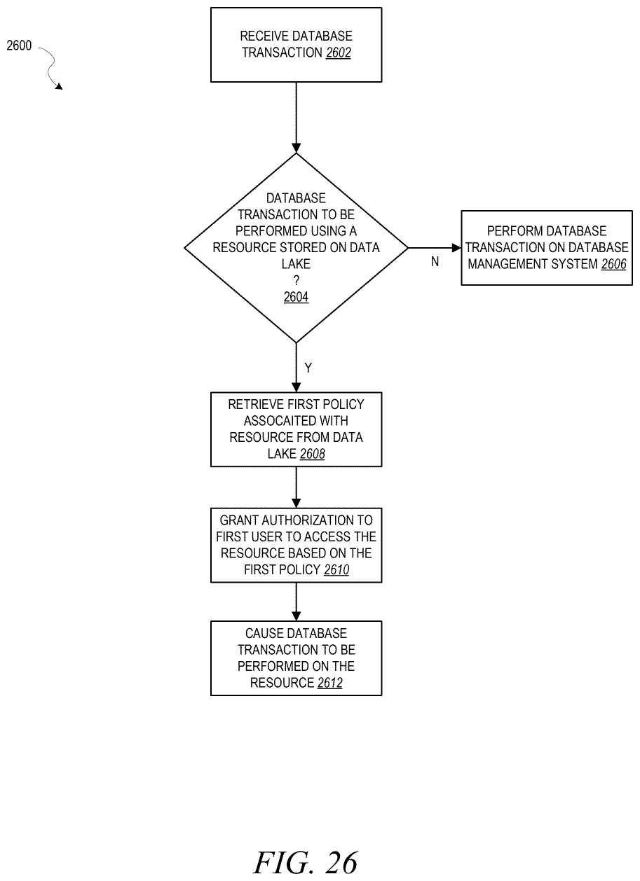

FIG. 26 is a flow diagram illustrating a method 2600 of coordinating transactions across databases and open format tables, in accordance with an example embodiment. Although the example method depicted in FIG. 26 shows a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At operation 2602, the method 2600 begins with receiving a database transaction at a database management system. The data used in this operation includes transaction details such as the type of transaction, the user initiating the transaction, and any associated metadata.

At operation 2604, the method 2600 involves determining whether the database transaction is to be performed using a resource stored on a data lake separate and distinct from the database management system. If not, then at operation 2606 the database transaction is processed by the database management system.

If so, then at operation 2608, the method 2600 proceeds to retrieve a first policy associated with the resource from the data lake. This may be performed over the data lake connection. The first policy may contain a section in which the resource types (from a plurality of different resource types) to which the policy applies are listed.

At operation 2610, the method 2600 involves granting authorization to the first user to access the resource based on the first policy.

At operation 2612, the method 2600 proceeds to cause the database transaction to be performed on the resource.

The privilege management features described here are fully integrated with the authentication, metadata, and sharing mechanisms of the platform. By supporting extensible, policy-driven access control across all resources, the system enables organizations to enforce security, compliance, and operational policies in a unified manner, regardless of storage format, location, or access method.

All of these aspects are designed to interoperate within the broader data platform and lake house architecture. Secure authentication and authorization mechanisms ensure that only authorized users and systems can access and manipulate data, whether through mediated, federated, or direct access. Rich metadata management enables advanced data governance, discovery, and interoperability, supporting analytics, machine learning, and regulatory compliance. Direct access capabilities provide flexibility for high-performance and cost-sensitive workloads, while virtualized and federated access support seamless integration with existing tools and workflows. Flexible sharing and resharing mechanisms enable organizations to build and participate in data ecosystems and marketplaces, while fine-grained privilege management ensures that all data operations are secure, auditable, and compliant.

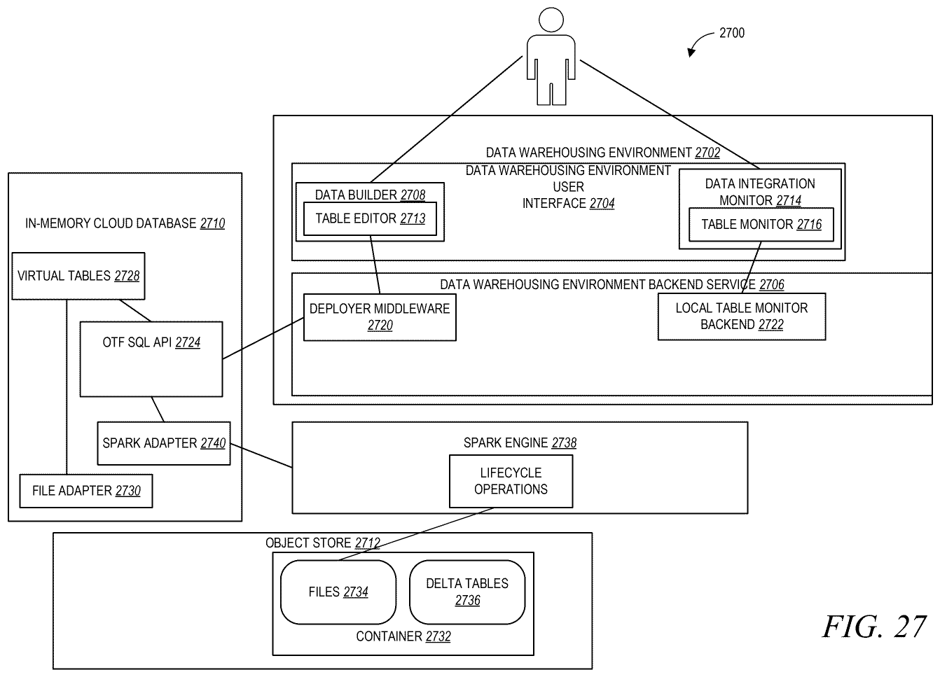

FIG. 27 is a block diagram illustrating a unified system 2700 for cloud-based data warehousing, data ingestion, and data transformation, in accordance with several example embodiments. The system 2700 includes a “data warehousing environment” 2702, which comprises a data warehousing environment user interface 2704 and a data warehousing environment backend service 2706. The data warehousing environment user interface 2704 includes a data builder 2708 having a table editor 2713 and a data integration monitor 2714 having a table monitor 2716. The data warehousing environment backend service 2706 includes a deployer middleware 2720 and a local table monitor backend 2722.

The data builder 2708 is designed to help users model, transform, and prepare data for analytics and reporting. It provides an intuitive interface that allows users to create and manage data models, define relationships between datasets, and perform data transformations. The data builder 2708 supports both graphical and scripting-based approaches, bridging the gap between technical users (such as data engineers) and business users (such as analysts). Users can design data models that define how data is structured and related, supporting schemas optimized for analytics. The data builder 2708 also allows for the transformation of raw data into meaningful datasets by applying business logic, performing calculations, and cleaning or enriching data. These transformations can be carried out using either graphical tools or scripting languages like SQL or Python Script, making the tool accessible to a wide range of users. The data builder 2708 integrates seamlessly with various data sources, including cloud platforms and on-premise databases.

The data builder 2708 supports the creation of virtual tables and views, enabling users to access and work with data without physically moving it. Additionally, it works with both the in-memory cloud database 2710 (such as HANA) and the object store 2712 (such as HANA Data Lake Files), providing flexibility and cost efficiency in data management. For datasets that support change data capture, the data builder 2708 incorporates incremental updates, allowing users to track and manage changes to data over time. The tool also supports collaborative workflows, enabling multiple users to work on data models and transformations while ensuring consistency and reusability across projects.

The table editor 2713 is a tool that allows users to create, modify, and manage tables as part of their data modeling and transformation workflows. It provides an interface for defining the structure and properties of tables, enabling users to configure how data is stored, accessed, and processed. Using the table editor 2713, users can define the schema of a table, including its columns, data types, and primary keys. It allows for the specification of additional table properties, such as partitioning configurations, which can optimize query performance and data organization. The tool also supports the creation of tables that leverage different storage types, such as in-memory storage or object store, providing flexibility in how data is managed. The table editor 2713 provides options for managing table lifecycle operations, such as deploying, modifying, or deleting tables. It ensures that changes to table structures are implemented in a controlled and consistent manner, even when data is already stored in the table. For example, it allows users to add new columns to a table with existing data while enforcing restrictions on operations that could compromise data integrity, such as dropping primary key columns.

The data integration monitor 2714 is a tool designed to provide visibility and control over data integration processes. It enables users to monitor, manage, and troubleshoot data flows and transformations as they occur within the platform. By offering real-time insights into the status and performance of data integration activities, the data integration monitor 2714 ensures that users can maintain the reliability and efficiency of their data pipelines. This tool allows users to track the progress of data replication, transformation, and ingestion workflows. It provides detailed information about the execution of these processes, including their current status, completion times, and any errors or warnings encountered. This visibility helps users identify and resolve issues quickly, minimizing disruptions to data operations. The data integration monitor 2714 also supports the management of scheduled and on-demand data integration tasks. Users can view and control the execution of these tasks, such as starting, stopping, or rescheduling them as needed. This flexibility ensures that data integration processes align with organizational requirements and priorities. In addition to monitoring individual tasks, the data integration monitor 2714 provides aggregated views of data integration activities across the platform. This allows users to analyze trends, identify bottlenecks, and optimize the performance of their data workflows. The tool also integrates with other components of the data warehousing environment 2702, enabling users to drill down into specific data flows or transformations for further analysis.

The table monitor 2716 is a specialized tool that provides users with detailed insights into the status and performance of table-related operations. It is designed to help users track, manage, and troubleshoot activities associated with tables, such as data ingestion, replication, and transformation, ensuring that table operations are executed efficiently and reliably. The table monitor 2716 allows users to view the current state of tables, including their data ingestion status, update frequency, and any associated transformation workflows. It provides real-time information about the progress of data being written to or read from tables, enabling users to monitor the flow of data into and out of the system. This is particularly useful for ensuring that data pipelines are functioning as expected and that tables are being populated with accurate and up-to-date information.

In addition to tracking data ingestion, the table monitor 2716 provides visibility into table-specific operations, such as merge tasks, optimization processes, and change data capture (CDC) activities. For example, it can display the status of merge tasks that consolidate data from an inbound buffer into a target table or show the results of optimization tasks that improve query performance by compacting small files or reorganizing data partitions. The tool also highlights any errors or warnings encountered during table operations, allowing users to quickly identify and address issues. For instance, if a data ingestion task fails due to schema mismatches or connectivity problems, the table monitor 2716 provides diagnostic information to help users resolve the problem. This ensures that table-related workflows remain consistent and reliable.

The table monitor 2716 integrates seamlessly with other components of the data integration monitor 2714, enabling users to drill down into specific table operations or link them to broader data integration workflows. It also supports lifecycle management tasks, such as monitoring the deployment of new tables, tracking schema changes, or managing table deletions. By providing a centralized view of table activities, the table monitor 2716 helps users maintain control over their data assets and ensures that tables are functioning as intended within the overall data landscape.

The deployer middleware 2720 in the data warehousing environment backend service 2706 is responsible for orchestrating the deployment and management of data models, transformations, and other artifacts within the data warehousing environment 2702. It acts as an intermediary layer that ensures the seamless execution of deployment tasks, maintaining consistency and reliability across the platform's data management and integration processes. The deployer middleware 2720 facilitates the deployment of data models, such as tables, views, and transformation flows, by translating high-level design specifications into executable instructions for the underlying infrastructure. It ensures that these deployments are carried out in a controlled and consistent manner, adhering to the defined configurations and dependencies. This includes managing the creation, modification, and deletion of database artifacts, such as virtual tables, Delta tables, and associated metadata.

One of the key functions of the deployer middleware 2720 is to handle transactional deployment operations. It ensures that deployment tasks are executed atomically, meaning that either all changes are successfully applied, or none are applied in the event of an error. This guarantees the integrity of the deployed artifacts and prevents partial or inconsistent states. For example, when deploying a Local Table (File), which means storing the data on a hyperscaler, with change data capture (CDC) capabilities, the middleware 2720 coordinates the creation of both the virtual table in the in-memory cloud database 2710 and the Delta table in the object store 2712, ensuring that all components are properly aligned.

The middleware 2720 also manages dependencies between different artifacts, ensuring that deployment sequences are executed in the correct order. For instance, it ensures that a Delta table is created in the object store 2712 before its corresponding virtual table is deployed in the in-memory cloud database 2710. This dependency management is crucial for maintaining the logical consistency of the data landscape. In addition to deployment, the deployer middleware 2720 supports lifecycle management tasks, such as updating existing artifacts to reflect schema changes or reconfigurations. It enforces rules to ensure that changes are applied safely, such as restricting operations that could compromise data integrity, like dropping primary key columns. The deployer middleware 2720 also handles cleanup operations, such as rolling back changes or removing artifacts during undeployment, to maintain a clean and consistent environment.

The local table monitor backend 2722 provides the backend functionality for the table monitor 2716. It is responsible for managing and monitoring operations related to local tables, particularly those stored in the object store 2712 or the cloud database 2710. It provides the necessary infrastructure to track, execute, and manage tasks associated with local tables, ensuring their efficient operation and integration within the broader Data warehousing environment.

In addition to monitoring, the backend service supports lifecycle management tasks for local tables. This includes handling operations such as table creation, modification, and deletion. It ensures that these tasks are executed in a controlled and consistent manner, adhering to the rules and constraints defined for local tables. For instance, it enforces restrictions on schema changes for tables with existing data to maintain data integrity. The backend service also facilitates the execution of maintenance tasks, such as vacuuming and optimization, which are essential for managing the performance and storage efficiency of local tables. These tasks are triggered and managed through the local table monitor backend 2722, ensuring that they are executed reliably and without disrupting other operations. By integrating with other components of the data warehousing environment 2702 backend service, such as the deployer middleware 2720 and the data integration monitor 2714, the local table monitor backend 2722 ensures that local tables are seamlessly integrated into the overall data workflows. It provides the necessary backend support to enable users to monitor and manage their tables effectively, whether they are stored in the cloud database or the object store.

The in-memory cloud database 2710 is where the database artifacts are stored, regardless of whether the underlying data is stored in the in-memory cloud database 2710 or the object store 2712. More particularly, an Open Table Format Structured Query Language Application Program Interface (OTF SQL API) 2724 stores data definition language (DDL) objects and procedures for managing one or more virtual tables 2728. The virtual tables 2728 represent the database artifacts for data stored in either the in-memory cloud database 2710 or the object store 2712. A file adapter 2730 connects the virtual tables 2728 to the object store 2712. The object store 2712 may contain a container 2732 comprising files 2734 and Delta tables 2736. The files 2734 and Delta tables 2736 work in tandem to provide a robust and scalable storage solution for managing large volumes of data. The files 2734 serve as the foundational storage units, capable of holding structured, semi-structured, and unstructured data in formats such as Apache Parquet. These formats are optimized for analytics and allow for efficient querying and processing of data, even at large scales.

The files 2734 are organized within a container 2732, which acts as a logical grouping of related data assets, and they can be accessed through APIs or integrated with other components of the data warehousing environment 2702. Delta tables 2736, on the other hand, are built on top of a Delta Lake storage framework and provide advanced features such as ACID transactions, schema enforcement, time travel, and change data capture (CDC). These tables are stored as a collection of files, such as Parquet files, along with a transaction log that tracks all changes made to the table.

The transaction log ensures that modifications, including inserts, updates, and deletes, are applied atomically and consistently. This enables features like querying the table as it existed at a specific point in time and tracking incremental changes to the data. The files 2734 and Delta tables 2736 work together seamlessly. When data is written to a Delta table, such as one of the Delta tables 2736, it is stored as Parquet files within the container 2732, and the transaction log is updated to reflect these changes. The Delta table provides a structured interface for querying the data stored in the underlying files 2734, ensuring that queries return results consistent with the latest state of the table.

Data ingestion into the object store 2712 can occur through various mechanisms, such as replication flows, transformation flows, or direct API calls, with the ingested data being written as new Parquet files and logged in the transaction log. Delta tables 2736 also support change data capture by recording changes at the record level in the transaction log. This allows users to extract incremental updates efficiently, enabling synchronization of data across systems. Over time, maintenance tasks such as vacuuming, which removes old versions of data, and compaction, which merges smaller files into larger ones, are performed to optimize storage and query performance. These tasks ensure that the Delta tables 2736 remain efficient and scalable. The integration of the Delta tables 2736 with the data warehousing environment 2702 allows users to create, manage, and query these tables through the Data warehousing environment interface.

Virtual tables 2728 in the in-memory cloud database 2710 provide seamless access to the Delta tables 2736, enabling users to leverage in-memory computing for analytics while storing data cost-effectively in the object store 2712. This integration ensures that users can benefit from the scalability of object store 2712 while maintaining the advanced capabilities of Delta Lake for structured data management.

The spark engine 2738 may be accessed through a Spark adapter 2740 on the in-memory cloud database 2710 and may be managed by the in-memory cloud database 2710. Lifecycle management and data processing of local table (file) may be orchestrated via the Spark engine 2738. In an example embodiment, maintenance may be performed every so often on the Delta tables 2736.

The Delta table keeps historical versions of data for ACID transactions, such as if there is a need to perform roll-back or other “time travel” operations on the data. Over time, this can lead to a large amount of stale data being stored. Thus, a periodic vacuum command may be performed to remove old versions of data and free up storage space. Additionally, if there is no need to query old versions, then it is best to clean up the old versions using the vacuum command to remove them. Furthermore, Delta tables can store data in many small files, especially after multiple merge or update operations. This can cause performance issues because each file needs to be read and written during queries.

An optimize command may be used to compact small files into large ones, which improves read and write performance by reducing file fragmentation. Additionally, if the Delta table is partitioned, then over time there may be a need for partition management, especially in cases where partitions have grown large or too many partitions exist.

The data warehousing environment 2702 uses a concept called “spaces” for secure isolation of data and for isolation of workloads. Spaces can either be configured as in-memory database spaces or file spaces. In-memory database spaces are stored and computed in the in-memory cloud database 2710, whereas file spaces are stored in the object store 2712 and computation on them is performed in the Spark engine 2738. The provisioning of each file space involves a provisioning of both an object store 2712 instance and a Spark engine 2738 instance. Each local table (file) comprises a virtual table in the in-memory cloud database 2710 and a Delta table in the object store 2712. The deployment of a local table (file) involves creating and managing the necessary database artifacts to enable the table's functionality within the system.

This process ensures that the table is properly configured to store, access, and process data, whether it is stored in the object store 2712 or the in-memory cloud database 2710. The deployment process is designed to maintain consistency, support advanced features like CDC, and integrate seamlessly with the broader systems. When deploying a local table (file), the system creates two primary entities: one for active records and another for handling Delta records if the “Change Data Feed” feature is enabled. For tables with “Change Data Feed,” the deployment process involves creating a virtual table in the cloud database to access the active records stored in the Delta table in the object store. Additionally, a “Delta history” table is created in the cloud database to temporarily store change data captured from the Delta table. This change data may have been obtained from the underlying data source (e.g., a data lake). A dedicated procedure is also deployed to populate the Delta history table with change data, and an extraction view is created to query the Delta history table based on parameters such as timestamps and subscriber IDs. For Local Tables (File) without “Change Data Feed,” only the virtual table is deployed.

The deployment process begins with the creation of the Delta table in the object store. This table is configured to store data in an open format, such as Apache Parquet, and is managed using the Delta Lake framework. The Delta Table supports advanced features like ACID transactions, schema enforcement, and time travel, which are critical for ensuring data consistency and reliability. The Delta table is created with the necessary schema, including columns, data types, and partitioning configurations if applicable. Once the Delta Table is created, the system proceeds to create the virtual table in the cloud database. The virtual table acts as a logical representation of the Delta table, allowing users to query and interact with the data stored in the object store using standard SQL commands. The virtual table is created in the corresponding schema of the cloud tenant database and is linked to the Delta table through a remote source connection. This connection enables seamless access to the data stored in the object store while leveraging the in-memory computing capabilities of HANA for analytics and processing.

If the local table (file) includes “Change Data Feed,” additional artifacts are deployed to support change data capture. The “Delta history” table is created in the cloud database to store the results of the change data feed procedure. This table includes all the fields of the local table (file) along with metadata columns for change type, commit version, and commit timestamp. The procedure for populating the Delta history table is also deployed, enabling the system to extract incremental changes from the Delta table and store them in the Delta history table. An extraction view is created to provide a user-friendly interface for querying the Delta history table based on specific parameters.

Modeling with Local Tables (File) involves defining and managing the structure, relationships, and behavior of tables that leverage the object store as their underlying storage. This process integrates seamlessly into the broader modeling framework of the data warehousing environment, allowing users to create and manage Local Tables (File) while taking advantage of the scalability and cost-efficiency of the object store. The modeling process ensures that Local Tables (File) are optimized for analytics, support advanced features like CDC, and integrate seamlessly with other components of the platform.

The modeling process begins with the creation of a Local Table (File) in the data builder 2708. Users define the schema of the table, including columns, data types, and primary keys, to structure the data appropriately for their use case. The schema definition also includes additional properties, such as partitioning configurations, which can improve query performance and data organization. Partitioning is particularly useful for large datasets, as it allows for efficient data retrieval by segmenting the data based on specific columns.

Local Tables (File) are modeled to support two key entities: active records and Delta capture. The active records entity represents the current state of the data stored in the Delta Table within the object store. This entity is linked to a virtual table in the cloud database, which provides a logical interface for querying the data using SQL. The Delta capture entity, on the other hand, is used to track and manage changes to the data over time. This entity leverages the “Change Data Feed” feature of Delta tables, which records metadata such as change type, commit version, and commit timestamp. These two entities are defined during the modeling process to ensure that the Local Table (File) supports both real-time and historical data analysis.

The CSN of a Local Table (File) may have the following annotations to define the Delta behavior and the related Active Records View:

### Active Entity:

“@DataWarehouse.persistence.hdlf.tableFormat”: { “#”:
“DELTA_LAKE” },
“@DataWarehouse.delta”: {
“type”: { “#”: “ACTIVE” },
“deltaFromEntities”: [“MyTable_Delta”]
},
Delta entity (for Change Data Capture feature):
“@DataWarehouse.persistence.hdlf.tableFormat”: { “#”:
“DELTA_LAKE” },
“@DataWarehouse.delta”: {
“type”: { “#”: “UPSERT” },
“dateTimeElement”: { “=”: “CHANGE_DATE” },
“modeElement”: { “=”: “CHANGE_TYPE” }
},
“@DataWarehouse.enclosingObject”: “MyTable”
Additional annotations may be used to represent the Delta view that needs
parameters at Delta extractions:
“params”: {
“EXTRACTION_MODE”: {
“@EndUserText.label”: “Extraction Mode”,
“type”: “cds.String”,
“length”: 10,
“default”: “FULL”,
“@DataWarehouse.bw.extractionMode”: true
},
“FROM_CHANGE_TIME”: {
“@EndUserText.label”: “From Change Time”,
“type”: “cds.Timestamp”,
“default”: “0001-01-01 00:00:00”
},
“TILL_CHANGE_TIME”: {
“@EndUserText.label”: “Till Change Time”,
“type”: “cds.Timestamp”,
“default”: “9999-12-31 23:59:59”
}
},
“@cds.persistence.udf”: true,
“@Semantics.interval”: [
{
“qualifier”: “changeTime”,
“lowerBoundaryParameter”: { “=”: FROM_CHANGE_TIME” },
“lowerBoundaryIncluded”: false,
“upperBoundaryParameter”: { “=”: “TILL_CHANGE_TIME” },
“upperBoundaryIncluded”: true
}
],

Upon deployment, a virtual table is created in the corresponding schema of the cloud tenant database. After creation of the database artifacts, the tables may be filled with data by executing a replication flow and the MERGE Task. As long as no data is stored in the virtual table, any change can be done to the table model. Deployment implements the changes with a DROP/CREATE command sequence if the virtual table is empty.

When data is found in the virtual table, the only available change allowed is to add columns. It is then not possible to drop columns, change columns that represent the primary key for the data, or change data types, including Null/NotNull, default value specifications, and shortening of lengths. Adding columns is an available option when the Local Table (File) has data. The cloud database may provide dedicated DDL commands to create Local Table (File) where the HDLF remote source (=File Adapter adapter) is mentioned as the Spark remote source. The following is an example of how a Local Table (File) is generated in the cloud database:

CREATE VIRTUAL TABLE “<SCHEMA_NAME>”.“LTF_DEMO” (
“ID” INT,
“COUNTRY” NVARCHAR(256),
“POPULATION” INT,
PRIMARY KEY(“ID”)
) AT
“<SCHEMA_NAME>.LS_SM_HDLF”.“/dsp/<SCHEMA_NAME>/objects/LTF_D
EMO” -- HDLF
remote source + location
AS DELTA
PARTITION BY (“COUNTRY”) -- partitioning configuration
REMOTE PROPERTY
‘delta_lake_table_properties’=‘{“delta.enableChangeDataFeed”:“true”}’ --
change date feed enablement
WITH REMOTE CONTROLLER “<SCHEMA_NAME>.LS_SM_SPARK”; --
SPARK remote source
If the Delta changes need to be extracted into a SQL Table, SAP HANA provides
two procedures to collect information over change data feed and retrieval of change
data.
DELTA_LAKE_TABLE_VERSION: returns latest remote Delta table version.
DELTA_LAKE_TABLE_CHANGES: stores CDC records in given min-max range
into result table.
IN VIRTUAL_TABLE_SCHEMA_NAME NVARCHAR(256),
IN VIRTUAL_TABLE_NAME NVARCHAR(256),
IN RESULT_SCHEMA_NAME NVARCHAR(256),
IN RESULT_TABLE_NAME NVARCHAR(256),
IN MIN_VERSION BIGINT DEFAULT NULL,
IN MAX_VERSION BIGINT DEFAULT NULL)
PROCEDURE SYS.DELTA_LAKE_TABLE_VERSION (
IN VIRTUAL_TABLE_SCHEMA_NAME NVARCHAR(256),
IN VIRTUAL_TABLE_NAME NVARCHAR(256),
OUT EXTERNAL_VERSION_ID BIGINT
)

The following database artifacts are deployed for handling Delta capture records:
1. The “Delta history” table ($CDC Table) that is used as a “temporary” storage containing result of the procedure “DELTA_LAKE_TABLE_CHANGES”. The table comprises the list of fields present in the Local Table (File), plus 3 extra fields relevant to Change Data Feed (_change_type, _commit-version, _commit-_timestamp).

### Example

CREATE COLUMN TABLE
“<SCHEMA_NAME>”.“LTF_DEMO$CDC” (
“ID” BIGINT NOT NULL,
“COUNTRY” NVARCHAR(100),
“POPULATION” INTEGER,
“_CHANGE_TYPE” NVARCHAR(16) NOT NULL,
“_COMMIT_VERSION” BIGINT NOT NULL,
“_COMMIT_TIMESTAMP” LONGDATE NOT NULL )
PARTITION BY HASH (“_COMMIT_VERSION”) PARTITIONS 5;

2. A SQL procedure is deployed for fetching the change data feed into the “Delta History Table”. It is called when a Delta consumer (such as a HANA Transformation Flow) requests the next Delta records.
3. A SQL view returns either the active records or the Delta records based on a parameter to define the extraction mode (FULL, DELTA_AI). For active records, the view refers to the virtual table and for the Delta records to the Delta log table ($CDC).

This view is deployed as a SQL view with: Delta type “UPSERT” (same primary key as active records)
2 additional CDC columns: modeElement (change type) and datetimeElement (change time)
3 parameters: Extraction Mode (FULL, DELTA_AI), From and Till dates (timestamps).

Additionally, the modeling process also includes the integration of Local Tables (File) with other components of SAP Data warehousing environment, such as replication flows and transformation flows. Users can define Local Tables (File) as target tables in replication flows, enabling data to be ingested directly into the table from various sources. Similarly, Local Tables (File) can be used as source or target tables in transformation flows, allowing users to apply business logic, perform calculations, and transform data as part of their workflows.

Annotations are used in the design-time representation of Local Tables (File) to define their behavior and properties. For example, annotations specify whether the table supports Delta capture and identify the related active records and Delta capture entities. These annotations ensure that the table's behavior aligns with the requirements of the use case and that it integrates seamlessly with the broader Data warehousing environment ecosystem.

Once the Local Table (File) is modeled, it is deployed to the system. During deployment, the Delta Table is created in HDLF, and the virtual table is created in SAP HANA. If the table includes Delta capture, additional artifacts such as the Delta history table, change data feed procedure, and extraction view are also deployed. These artifacts enable the table to support advanced features like incremental updates and historical data analysis.

Modeling with Local Tables (File) also supports lifecycle management tasks, such as schema evolution and partitioning. For example, users can add new columns to the table schema or define partitioning configurations to optimize data storage and retrieval. However, certain changes, such as dropping columns or modifying primary keys, are restricted to maintain data integrity.

The deployment process ensures transactional consistency by using a SAGA pattern to encapsulate individual operations. This means that if any step in the deployment process fails, the system can roll back the changes to maintain a consistent state. For example, if the creation of the virtual table in SAP HANA fails, the system can clean up the Delta table in HDLF to ensure that no orphaned artifacts remain.

Once the deployment is complete, the Local Table (File) is ready for use. Data can be ingested into the table using replication flows, transformation flows, or direct API calls. The system supports lifecycle management operations, such as modifying the table schema or deleting the table, while ensuring that these changes are applied in a controlled and consistent manner. Maintenance tasks, such as vacuuming and optimization, can also be performed to manage storage efficiency and query performance.

The local table monitor backend 2722 in the data warehousing environment 2702 is a backend service component responsible for managing and monitoring operations related to local tables, particularly those stored in the object store or the cloud database.

By integrating with other components of the data warehousing environment backend service 2706, such as the deployer middleware 2720 and the data integration monitor 2714, the local table monitor backend 2722 ensures that local tables are seamlessly integrated into the overall data workflows. It provides the necessary backend support to enable users to monitor and manage their tables effectively, whether they are stored in the cloud database or the object store.

This architecture, as depicted in FIG. 27, enables organizations to efficiently manage the full lifecycle of data tables in a cloud-based, storage-agnostic environment, supporting advanced analytics, robust governance, and operational efficiency.

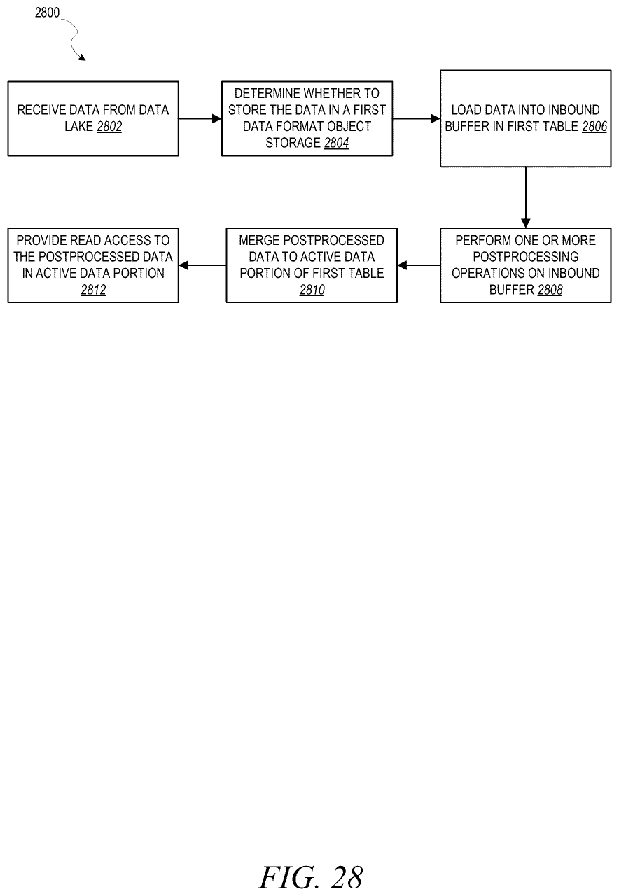

FIG. 28 illustrates a method 2800 for ingesting data in a cloud-based data warehousing environment, in accordance with an example embodiment. The method comprises a series of operations denoted by reference numbers, each describing a specific technical function within the data management process.

At operation 2802, the method 2800 begins by receiving data in a first software framework from a data lake. The data lake stores the data in a raw data storage format, which may include structured, semi-structured, or unstructured data. In some examples, the data may be ingested from external systems or other data sources, and the raw data is transferred into the software framework for further processing.

At operation 2804, the method 2800 determines whether the received data should be stored in a first format object storage. If the determination is affirmative, the method proceeds to operation 2806. If not, then the method 2800 ends as the received data can just be stored normally. In some examples, the first format object storage may be implemented as an open data format object storage.

At operation 2806, the data is loaded into an inbound buffer within a first table in the open data format object storage. The inbound buffer serves as a temporary storage location for incoming data before further processing. In some examples, the inbound buffer may be implemented as Parquet files or append-only Delta tables.

At operation 2808, one or more postprocessing operations are performed on the data stored in the inbound buffer. These postprocessing operations may include deduplication, optimization, and delta merging. The postprocessing operations ensure that the data is prepared for transfer into the active data portion of the table.

At operation 2810, the postprocessed data is merged into the active data portion of the first table. The active data portion represents the finalized state of the data within the table, where it is stored in a format optimized for querying and analytics.

At operation 2812, read access to the postprocessed data in the active data portion of the table is provided to one or more processes of the first software framework. Write access to the active data portion is restricted to ensure data consistency and integrity.

In some examples, the method may further include transferring the postprocessed data to a second table. The second table may provide both read and write access to the data for additional processing or transformation tasks.

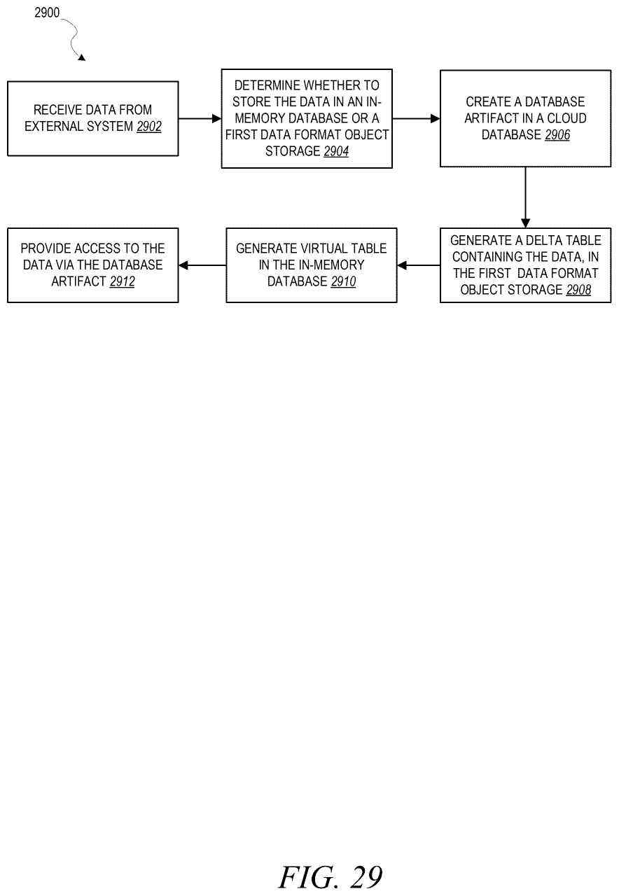

FIG. 29 is a flow diagram illustrating a method 2900 for storing data, in accordance with an example embodiment. The flowchart described in the figure illustrates a method for executing a series of operations related to data management in a cloud-based data warehousing environment. While the operations in the flowchart are presented sequentially, one of ordinary skill in the art will appreciate that some or all of the operations may be executed in a different order, combined or omitted, or executed in parallel.

At operation 2902, the method 2900 begins by receiving data from an external system, such as a data lake. The data lake stores the data in a raw data storage format, which may include structured, semi-structured, or unstructured data. In some examples, the data may be ingested from external systems, such as enterprise resource planning (ERP) systems, customer relationship management (CRM) systems, or other third-party platforms. The data is extracted using APIs or replication flows, which write the data into an inbound buffer associated with the data lake. The data may be received from a data ingestion process or any external system that “pushes” data.

At operation 2904, the system determines whether to store the data in an in-memory database or first data format object storage. This determination may be based on predefined rules, user configurations, or system parameters. In some examples, the decision may depend on factors such as the frequency of data access, the size of the dataset, or the cost-efficiency of storage options. The system evaluates these criteria and selects the appropriate storage type. In some embodiments, the first data format object storage may be implemented as an open data format object storage.

At operation 2906, a database artifact is created in a cloud database. The database artifact contains information about the data but is stored in a format that is agnostic to whether the data is stored in the in-memory database or the first format object storage. In some examples, the database artifact may include metadata, schema definitions, and references to the underlying storage location. The artifact serves as a logical representation of the data, enabling users to query and interact with the data without being constrained by the physical storage type.

At operation 2908, assuming the system determines that the data will be stored in the first format object storage, the system generates a Delta Table containing the data in the first format object storage. The Delta Table is configured to store data in formats such as Apache Parquet and is managed using the Delta Lake framework. In some examples, the Delta Table supports features such as ACID transactions, schema enforcement, and time travel. The system creates the Delta Table with the necessary schema, including columns, data types, and partitioning configurations.

At operation 2910, a virtual table is generated in the in-memory database. The virtual table is dependent upon the Delta Table and acts as a logical representation of the data stored in the object storage. In some examples, the virtual table is created in the corresponding schema of the cloud tenant database and is linked to the Delta Table through a remote source connection. This connection enables seamless access to the data stored in the object storage while leveraging the in-memory computing capabilities of the database for analytics and processing.

At operation 2912, access to the data is provided via the database artifact. The database artifact allows users to query and interact with the data using standard SQL commands. In some examples, the artifact may include views, procedures, or APIs that abstract the underlying storage details, enabling users to focus on their analytical tasks.

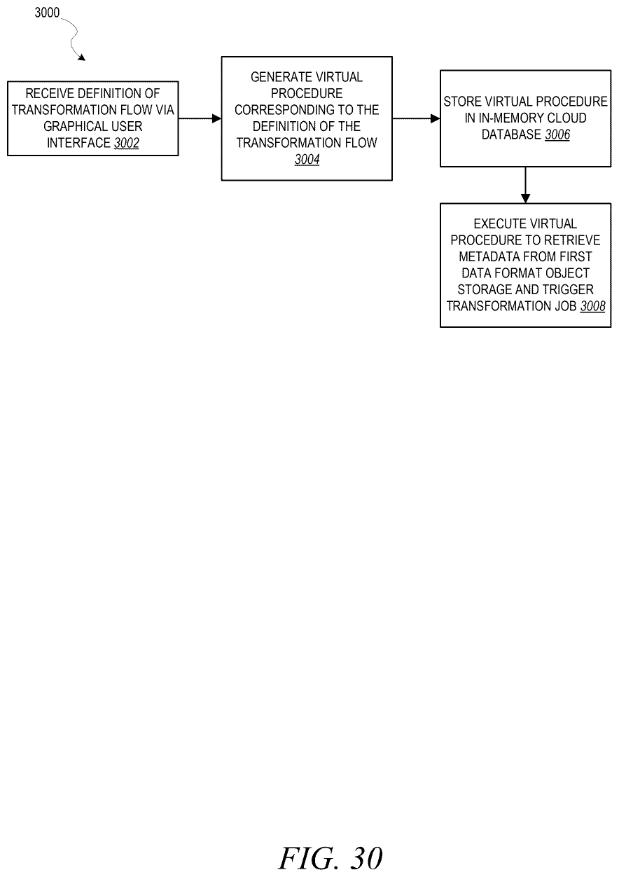

FIG. 30 is a flow diagram illustrating a method 3000 for applying one or more transformations to data, in accordance with an example embodiment. The method comprises a series of operations denoted by reference numbers. While the various operations in this flowchart are presented and described sequentially, one of ordinary skill in the art will appreciate that some or all of the operations may be executed in a different order, be combined or omitted, or be executed in parallel.

At operation 3002, the method 3000 includes receiving, via a graphical user interface, a definition of a transformation flow. The transformation flow specifies operations to transform source data into target data, where the source data and target data are stored in a first format object storage within a data lake. The graphical user interface may allow users to define the transformation flow by specifying the source and target data, as well as the transformation operations to be applied. In some implementations, the first format object storage may be implemented as an open data format object storage.

At operation 3004, the method 3000 involves generating a virtual procedure corresponding to the definition of the transformation flow. The virtual procedure includes logic to execute the transformation flow and is configured to operate in a runtime environment. The virtual procedure may include instructions for initializing source data, applying transformation logic, and writing the results to the target data.

At operation 3006, the virtual procedure is stored in an in-memory cloud database. The in-memory cloud database provides a centralized location for managing the virtual procedure, ensuring it is accessible for execution. The virtual procedure may be stored with a naming convention that facilitates traceability and consistency across deployments.

At operation 3008, the virtual procedure is executed. The execution causes retrieval of metadata from the first format object storage and triggers a transformation job on a computing cluster. The transformation job reads the source data from the first format object storage, applies one or more transformations specified in the definition of the transformation flow, and writes the results to the target data in the first format object storage.

The method 3000 concludes with the transformed target data being stored in the open data format object storage, ready for further use or analysis. The described operations provide a structured approach to transforming and managing data.

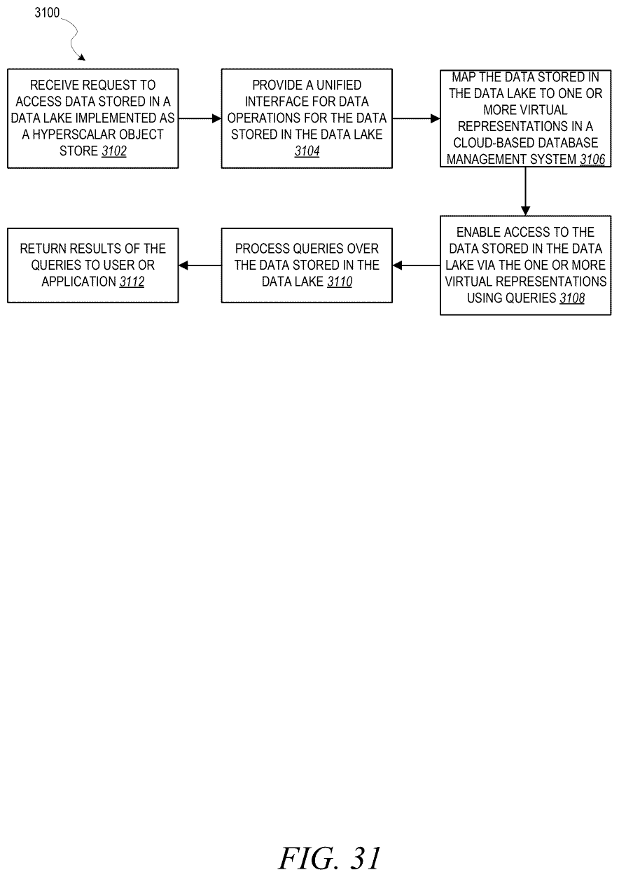

FIG. 31 is a flow diagram illustrating a method 3100 for accessing data stored in a data lake implemented as a hyperscaler object store, in accordance with an example embodiment. In operation 3102, a request is received at a cloud-based data platform to access data stored in a data lake implemented as a hyperscaler object store, where the data is stored in a first table format. The first table format may include open table formats such as Apache Parquet, Delta Lake, or Apache Iceberg, enabling compatibility with a wide range of analytics and machine learning tools. The request may originate from a user, application, or external system seeking to perform analytics, reporting, or data science operations on the stored data.

In operation 3104, the cloud-based data platform provides a unified interface for data operations for the data stored in the data lake. This unified interface abstracts the underlying storage technology and exposes standardized APIs or query endpoints, such as SQL interfaces, to facilitate seamless data access and management. The interface may support direct, in-situ query processing over files in the data lake without requiring intermediate data movement, thereby improving performance and reducing latency.

In operation 3106, the data stored in the data lake is mapped to one or more virtual representations in a cloud-based database management system. This mapping is accomplished by creating virtual tables in the database management system that reference the first table format files via a remote source connection. The virtual tables include metadata describing the structure and semantics of the underlying data, enabling users to interact with the data as if it were stored natively within the database system. The mapping process may also support schema enforcement, schema evolution, and time travel to historical table versions, ensuring robust data governance and auditability.

In operation 3108, access to the data stored in the data lake is enabled via the one or more virtual representations using queries. Users or applications can submit queries, such as SQL statements, against the virtual tables, which are then translated into operations on the underlying data files. The system may authenticate the received request using X.509 certificates or web tokens before providing access, ensuring secure and policy-driven data access. Fine-grained access control and role-based privileges may be enforced to comply with organizational security requirements.

In operation 3110, a processing engine processes the queries over the data stored in the data lake, including generating a logical plan and a physical plan that support in-situ processing over files in the data lake. The processing engine may include an optimizer capable of enumerating physical operators for remote file scan operations and pushing down filter, projection, and aggregation operators to a file adapter for efficient execution on column chunks of the first table format files. The file adapter reads the relevant data from the object store, applies the requested operations, and returns results as internal tables or data chunks for further processing by the execution engine. The system may also federate SQL queries to an external analytics engine, such as Apache Spark, via a Spark adapter to perform large-scale data transformations or advanced analytics.

In operation 3112, results of the queries are returned to a user or application. The results may be delivered through the unified interface, allowing users to consume analytics, business intelligence, or machine learning outputs without concern for the underlying storage or compute infrastructure. In some embodiments, the system may generate pre-signed URLs to enable direct access to the hyperscaler object store for data retrieval, further optimizing data access and reducing operational overhead. The platform may also provide monitoring, observability, and lifecycle management features to ensure consistent, secure, and high-performance data operations across distributed resources.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one hardware processor; and a computer-readable medium storing instructions that, when executed by the at least one hardware processor, cause the at least one hardware processor to perform operations comprising: receiving, at a cloud-based data platform, a request to access data stored in a data lake implemented as a hyperscaler object store, the data being stored in a first table format; providing, by the cloud-based data platform, a unified interface for data operations for the data stored in the data lake; mapping the data stored in the data lake to one or more virtual representations in a cloud-based database management system; enabling access to the data stored in the data lake via the one or more virtual representations using queries; processing, by a processing engine, the queries over the data stored in the data lake, comprising generating a logical plan and a physical plan that support in-situ processing over files in the data lake; and returning results of the queries to a user or application.

In Example 2, the subject matter of Example 1 comprises, wherein the first table format comprises at least one of Apache Parquet, Delta Lake, or Apache Iceberg.

In Example 3, the subject matter of Examples 1-2 comprises, wherein the instructions further cause the at least one hardware processor to perform operations comprising: pushing down filter, projection, and aggregation operators to a file adapter for execution on column chunks of first table format files.

In Example 4, the subject matter of Examples 1-3 comprises, wherein the unified interface performs direct, in-situ query processing over files in the data lake without intermediate data movement.

In Example 5, the subject matter of Examples 1-4 comprises, wherein mapping the data stored in the data lake to the one or more virtual representations comprises: creating virtual tables in the cloud-based database management system that reference first table format files via a remote source connection.

In Example 6, the subject matter of Examples 1-5 comprises, wherein the instructions further cause the at least one hardware processor to perform operations comprising: federating Structured Query Language (SQL) queries to an external analytics engine via a Spark adapter to perform large-scale data transformations on the data stored in the data lake.

In Example 7, the subject matter of Examples 1-6 comprises, wherein the instructions further cause the at least one hardware processor to perform operations comprising: authenticating the received request using X.509 certificates or web tokens before providing access to the data stored in the data lake.

In Example 8, the subject matter of Examples 1-7 comprises, wherein the instructions further cause the at least one hardware processor to perform operations comprising: generating pre-signed URLs to enable direct access to the hyperscaler object store for data retrieval.

Example 9 is a method comprising: receiving, at a cloud-based data platform, a request to access data stored in a data lake implemented as a hyperscaler object store, the data being stored in a first table format; providing, by the cloud-based data platform, a unified interface for data operations for the data stored in the data lake; mapping the data stored in the data lake to one or more virtual representations in a cloud-based database management system; enabling access to the data stored in the data lake via the one or more virtual representations using queries; processing, by a processing engine, the queries over the data stored in the data lake, comprising generating a logical plan and a physical plan that support in-situ processing over files in the data lake; and returning results of the queries to a user or application.

In Example 10, the subject matter of Example 9 comprises, wherein the first table format comprises at least one of Apache Parquet, Delta Lake, or Apache Iceberg.

In Example 11, the subject matter of Examples 9-10 comprises, pushing down filter, projection, and aggregation operators to a file adapter for execution on column chunks of first table format files.

In Example 12, the subject matter of Examples 9-11 comprises, wherein the unified interface performs direct, in-situ query processing over files in the data lake without intermediate data movement.

In Example 13, the subject matter of Examples 9-12 comprises, wherein mapping the data stored in the data lake to the one or more virtual representations comprises: creating virtual tables in the cloud-based database management system that reference first table format files via a remote source connection.

In Example 14, the subject matter of Examples 9-13 comprises, federating Structured Query Language (SQL) queries to an external analytics engine via a Spark adapter to perform large-scale data transformations on the data stored in the data lake.

In Example 15, the subject matter of Examples 9-14 comprises, authenticating the received request using X.509 certificates or web tokens before providing access to the data stored in the data lake.

In Example 16, the subject matter of Examples 9-15 comprises, generating pre-signed URLs to enable direct access to the hyperscaler object store for data retrieval.

Example 17 is a non-transitory machine-readable medium storing instructions which, when executed by one or more processors, cause the one or more processors to perform operations comprising: receiving, at a cloud-based data platform, a request to access data stored in a data lake implemented as a hyperscaler object store, the data being stored in a first table format; providing, by the cloud-based data platform, a unified interface for data operations for the data stored in the data lake; mapping the data stored in the data lake to one or more virtual representations in a cloud-based database management system; enabling access to the data stored in the data lake via the one or more virtual representations using queries; processing, by a processing engine, the queries over the data stored in the data lake, comprising generating a logical plan and a physical plan that support in-situ processing over files in the data lake; and returning results of the queries to a user or application.

In Example 18, the subject matter of Example 17 comprises, wherein the first table format comprises at least one of Apache Parquet, Delta Lake, or Apache Iceberg.

In Example 19, the subject matter of Examples 17-18 comprises, pushing down filter, projection, and aggregation operators to a file adapter for execution on column chunks of first table format files.

In Example 20, the subject matter of Examples 17-19 comprises, wherein the unified interface performs direct, in-situ query processing over files in the data lake without intermediate data movement.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

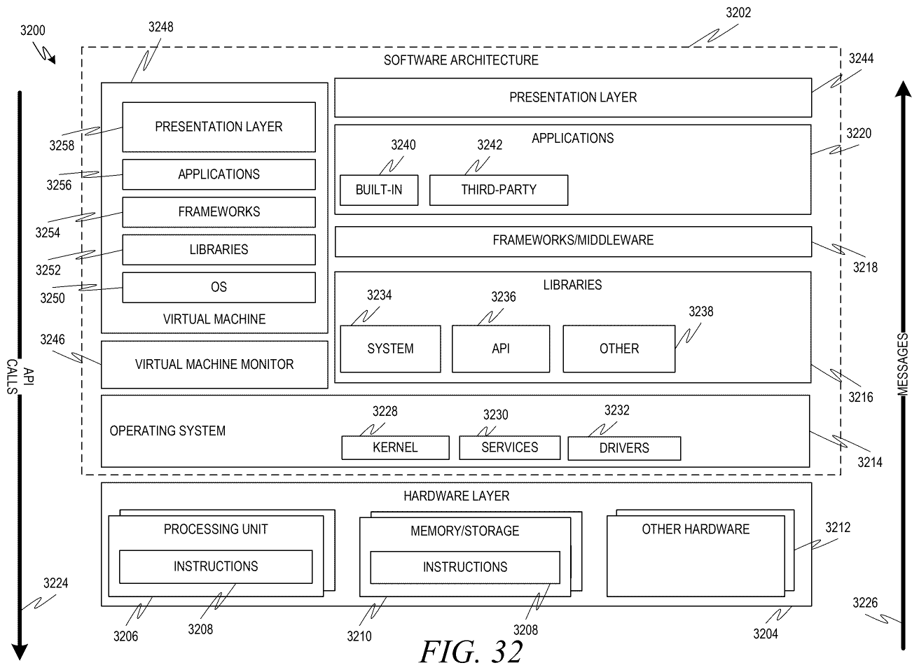

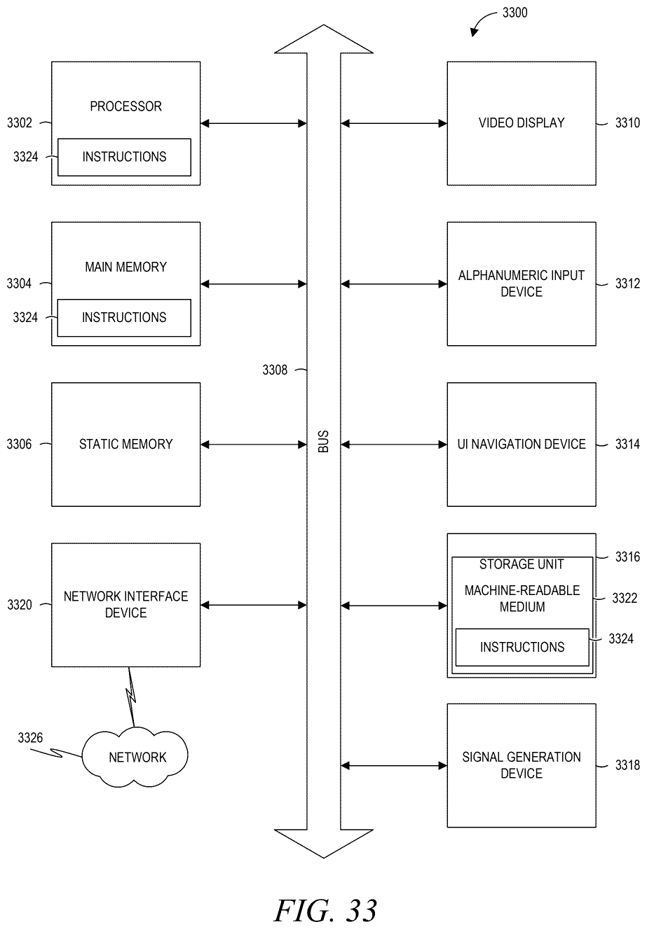

FIG. 32 shows a block diagram 3200 showing one example of a software architecture 3202 for a computing device. The software architecture 3202 may be used in conjunction with various hardware architectures, for example, as described herein. FIG. 32 is merely a non-limiting example of a software architecture, and many other architectures may be implemented to facilitate the functionality described herein. A representative hardware layer 3204 is illustrated and can represent, for example, any of the above referenced computing devices. In some examples, the hardware layer 3204 may be implemented according to the architecture of the computer system of FIG. 33.

The representative hardware layer 3204 comprises one or more processing units 3206 having associated executable instructions 3208. Executable instructions 3208 represent the executable instructions of the software architecture 3202, including implementation of the methods, modules, subsystems, and components, and so forth described herein and may also include memory and/or storage modules 3210, which also have executable instructions 3208. The hardware layer 3204 may also comprise other hardware 3212 which represents any other hardware of the hardware layer 3204. Examples of the other hardware 3212 include the hardware components shown in FIG. 33.

In the example architecture of FIG. 32, the software architecture 3202 may be conceptualized as a stack of layers where each layer provides particular functionality. For example, the software architecture 3202 may include layers such as an operating system 3214, libraries 3216, frameworks/middleware 3218, applications 3220, and presentation layer 3244. Operationally, the applications 3220 and/or other components within the layers may invoke API calls 3224 through the software stack and access a response, returned values, and so forth illustrated as messages 3226 in response to the API calls 3224. The layers illustrated are representative in nature and not all software architectures have all layers. For example, some mobile or special purpose operating systems may not provide a frameworks/middleware 3218 layer, while others may provide such a layer. Other software architectures may include additional or different layers.

The operating system 3214 may manage hardware resources and provide common services. The operating system 3214 may include, for example, a kernel 3228, services 3230, and drivers 3232. The kernel 3228 may act as an abstraction layer between the hardware and the other software layers. For example, the kernel 3228 may be responsible for memory management, processor management (e.g., scheduling), component management, networking, security settings, and so on. The services 3230 may provide other common services for the other software layers. In some examples, the services 3230 include an interrupt service. The interrupt service may detect the receipt of an interrupt and, in response, cause the software architecture 3202 to pause its current processing and execute an interrupt service routine (ISR) when an interrupt is accessed.

The drivers 3232 may be responsible for controlling or interfacing with the underlying hardware. For instance, the drivers 3232 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 3216 may provide a common infrastructure that may be utilized by the applications 3220 and/or other components and/or layers. The libraries 3216 typically provide functionality that allows other software modules to perform tasks in an easier fashion than to interface directly with the underlying operating system 3214 functionality (e.g., kernel 3228, services 3230 and/or drivers 3232). The libraries 3216 may include system libraries 3234 (e.g., C standard library) that may provide functions such as memory allocation functions, string manipulation functions, mathematic functions, and the like. In addition, the libraries 3216 may include API libraries 3236 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 3216 may also include a wide variety of other libraries 3238 to provide many other APIs to the applications 3220 and other software components/modules.

The frameworks/middleware 3218 may provide a higher-level common infrastructure that may be utilized by the applications 3220 and/or other software components/modules. For example, the frameworks/middleware 3218 may provide various graphic user interface (GUI) functions, high-level resource management, high-level location services, and so forth. The frameworks/middleware 3218 may provide a broad spectrum of other APIs that may be utilized by the applications 3220 and/or other software components/modules, some of which may be specific to a particular operating system or platform.

The applications 3220 include built-in applications 3240 and/or third-party applications 3242. Examples of representative built-in applications 3240 may include, but are not limited to, a contacts application, a browser application, a book reader application, a location application, a media application, a messaging application, and/or a game application. Third-party applications 3242 may include any of the built-in applications 3240 as well as a broad assortment of other applications. In a specific example, the third-party application 3242 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 3242 may invoke the API calls 3224 provided by the mobile operating system such as operating system 3214 to facilitate functionality described herein.

The applications 3220 may utilize built-in operating system functions (e.g., kernel 3228, services 3230 and/or drivers 3232), libraries (e.g., system libraries 3234, API libraries 3236, and other libraries 3238), and frameworks/middleware 3218 to create user interfaces to interact with users of the system. Alternatively, or additionally, in some systems, interactions with a user may occur through a presentation layer, such as presentation layer 3244. In these systems, the application/module “logic” can be separated from the aspects of the application/module that interact with a user.

Some software architectures utilize virtual machines. In the example of FIG. 32, this is illustrated by a virtual machine 3248. A virtual machine creates a software environment where applications/modules can execute as if they were executing on a hardware computing device. The virtual machine 3248 is hosted by a host operating system (operating system 3214) and typically, although not always, has a virtual machine monitor 3246, which manages the operation of the virtual machine 3248 as well as the interface with the host operating system (i.e., operating system 3214). A software architecture executes within the virtual machine 3248 such as an operating system 3250, libraries 3252, frameworks/middleware 3254, applications 3256 and/or presentation layer 3258. These layers of software architecture executing within the virtual machine 3248 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 33 shows a block diagram of a machine in the example form of a computer data lake house system 3300 within which instructions 3324 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer data lake house system 3300 includes a processor 3302 (e.g., a central processing unit (CPU), a graphics processing unit (GPU), or both), a main memory 3304, and a static memory 3306, which communicate with each other via a bus 3308. The computer data lake house system 3300 may further include a video display unit 3310 (e.g., a liquid crystal display (LCD) or a cathode ray tube [CRT]). The computer data lake house system 3300 also includes an alphanumeric input device 3312 (e.g., a keyboard or a touch-sensitive display screen), a user interface (UI) navigation (or cursor control) device 3314 (e.g., a mouse), a storage unit 3316, a signal generation device 3318 (e.g., a speaker), and a network interface device 3320.

### Machine-Readable Medium

The storage unit 3316 includes a machine-readable medium 3322 on which is stored one or more sets of data structures and instructions 3324 (e.g., software) embodying or utilized by any one or more of the methodologies or functions described herein. The instructions 3324 may also reside, completely or at least partially, within the main memory 3304 and/or within the processor 3302 during execution thereof by the computer data lake house system 3300, with the main memory 3304 and the processor 3302 also constituting a machine-readable medium 3322.

While the machine-readable medium 3322 is shown in FIG. 33 to be a single medium, the term “machine-readable medium” may include a single medium or multiple media (e.g., a centralized or distributed database, and/or associated caches and servers) that store the one or more instructions 3324 or data structures. The term “machine-readable medium” shall also be taken to include any tangible medium that is capable of storing, encoding, or carrying instructions 3324 for execution by the machine and that cause the machine to perform any one or more of the methodologies of the present disclosure, or that is capable of storing, encoding, or carrying data structures utilized by or associated with the instructions 3324. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 3324 may further be transmitted or received over a communications network 3326 using a transmission medium. The instructions 3324 may be transmitted using the network interface device 3320 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 3324 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
at least one hardware processor; and
a computer-readable medium storing instructions that, when executed by the at least one hardware processor, cause the at least one hardware processor to perform operations comprising:
receiving, at a cloud-based data platform, a request to access data stored in a data lake implemented as a hyperscaler object store, the data being stored in a first table format;
providing, by the cloud-based data platform, a unified interface for data operations for the data stored in the data lake;
mapping the data stored in the data lake to one or more virtual representations in a cloud-based database management system;
enabling access to the data stored in the data lake via the one or more virtual representations using queries;
processing, by a processing engine, the queries over the data stored in the data lake, including generating a logical plan and a physical plan that support in-situ processing over files in the data lake; and
returning results of the queries to a user or application.

2. The system of claim 1, wherein the first table format comprises at least one of Apache Parquet, Delta Lake, or Apache Iceberg.

3. The system of claim 1, wherein the instructions further cause the at least one hardware processor to perform operations comprising:
pushing down filter, projection, and aggregation operators to a file adapter for execution on column chunks of first table format files.

4. The system of claim 1, wherein the unified interface performs direct, in-situ query processing over files in the data lake without intermediate data movement.

5. The system of claim 1, wherein mapping the data stored in the data lake to the one or more virtual representations comprises:
creating virtual tables in the cloud-based database management system that reference first table format files via a remote source connection.

6. The system of claim 1, wherein the instructions further cause the at least one hardware processor to perform operations comprising:
federating Structured Query Language (SQL) queries to an external analytics engine via a Spark adapter to perform large-scale data transformations on the data stored in the data lake.

7. The system of claim 1, wherein the instructions further cause the at least one hardware processor to perform operations comprising:
authenticating the received request using X.509 certificates or web tokens before providing access to the data stored in the data lake.

8. The system of claim 1, wherein the instructions further cause the at least one hardware processor to perform operations comprising:
generating pre-signed URLs to enable direct access to the hyperscaler object store for data retrieval.

9. A method comprising:
receiving, at a cloud-based data platform, a request to access data stored in a data lake implemented as a hyperscaler object store, the data being stored in a first table format;
providing, by the cloud-based data platform, a unified interface for data operations for the data stored in the data lake;
mapping the data stored in the data lake to one or more virtual representations in a cloud-based database management system;
enabling access to the data stored in the data lake via the one or more virtual representations using queries;
processing, by a processing engine, the queries over the data stored in the data lake, including generating a logical plan and a physical plan that support in-situ processing over files in the data lake; and
returning results of the queries to a user or application.

10. The method of claim 9, wherein the first table format comprises at least one of Apache Parquet, Delta Lake, or Apache Iceberg.

11. The method of claim 9, further comprising:
pushing down filter, projection, and aggregation operators to a file adapter for execution on column chunks of first table format files.

12. The method of claim 9, wherein the unified interface performs direct, in-situ query processing over files in the data lake without intermediate data movement.

13. The method of claim 9, wherein mapping the data stored in the data lake to the one or more virtual representations comprises:
creating virtual tables in the cloud-based database management system that reference first table format files via a remote source connection.

14. The method of claim 9, further comprising:
federating Structured Query Language (SQL) queries to an external analytics engine via a Spark adapter to perform large-scale data transformations on the data stored in the data lake.

15. The method of claim 9, further comprising:
authenticating the received request using X.509 certificates or web tokens before providing access to the data stored in the data lake.

16. The method of claim 9, further comprising:
generating pre-signed URLs to enable direct access to the hyperscaler object store for data retrieval.

17. A non-transitory machine-readable medium storing instructions which, when executed by one or more processors, cause the one or more processors to perform operations comprising:
receiving, at a cloud-based data platform, a request to access data stored in a data lake implemented as a hyperscaler object store, the data being stored in a first table format;
providing, by the cloud-based data platform, a unified interface for data operations for the data stored in the data lake;
mapping the data stored in the data lake to one or more virtual representations in a cloud-based database management system;
enabling access to the data stored in the data lake via the one or more virtual representations using queries;
processing, by a processing engine, the queries over the data stored in the data lake, including generating a logical plan and a physical plan that support in-situ processing over files in the data lake; and
returning results of the queries to a user or application.

18. The non-transitory machine-readable medium of claim 17, wherein the first table format comprises at least one of Apache Parquet, Delta Lake, or Apache Iceberg.

19. The non-transitory machine-readable medium of claim 17, further comprising:
pushing down filter, projection, and aggregation operators to a file adapter for execution on column chunks of first table format files.

20. The non-transitory machine-readable medium of claim 17, wherein the unified interface performs direct, in-situ query processing over files in the data lake without intermediate data movement.
